(19) United States
(12) Patent Application Publication
(10) Pub. No.: US 2026/0311331 A1
(43) Pub. Date: Oct. 8, 2026

(54) NEURAL NETWORK SYSTEM FOR SPINAL CORD STIMULATION THERAPY OPTIMIZATION

(71) Applicant: Wavegate Corporation, Lake Charles, LA (US)

(72) Inventors: Erich W. Wolf, II, Lake Charles, LA (US); George R. Schultz, Coppell, TX (US)

(73) Assignee: Wavegate Corporation, Lake Charles, LA (US)

(21) Appl. No.: 19/638,765

(22) Filed: Apr. 3, 2026

Related U.S. Application Data
(60) Provisional application No. 63/783,405, filed on Apr. 4, 2025.
(60) Provisional application No. 63/783,415, filed on Apr. 4, 2025.
(60) Provisional application No. 63/895,785, filed on Oct. 8, 2025.

(51) Int. Cl. G06T 7/00; G06N 3/048

(52) U.S. Cl. CPC G06T 7/0012; G06N 3/048; G06T 2207/10116; G06T 2207/20081; G06T 2207/20084; G06T 2207/30012

(57) ABSTRACT

A system for optimizing spinal cord stimulation therapy uses neural network models to predict sensation patterns from electrode geometry and stimulation parameters. The system captures patient-drawn sensation maps on a standardized physical doll or on a digital avatar rendered on a tablet computer, digitizes the markings, and associates them with X-ray-derived electrode positions and applied stimulation settings. Training data collected across multiple patients enables the neural network to learn stimulus-response relationships that generalize across patients. Given a target pain area, the trained network recommends stimulation settings predicted to produce therapeutic coverage. Technical improvements include predictive rather than reactive programming, cross-patient learning, reduced programming time from hours to seconds, and extended implanted battery life through reduced wireless transmissions. The trained neural network serves as a compressed repository encoding paresthesia data from training trials, such that effective stimulation patterns are retrievable for new patients.

### CROSS-REFERENCE TO RELATED APPLICATIONS

This application claims priority benefit from U.S. Provisional Application No. 63/895,785, filed on Oct. 8, 2025 and U.S. Provisional Application No. 63/783,405, filed on Apr. 4, 2025 and U.S. Provisional Application No. 63/783,415, filed on Apr. 4, 2025. Each patent application identified above is incorporated here by reference in its entirety to provide continuity of disclosure.

### FIELD OF THE INVENTION

The present invention relates to systems and methods for optimizing spinal cord stimulation therapy using neural network models to predict and personalize stimulation parameters based on patient-specific anatomy and desired sensory outcomes.

### BACKGROUND OF THE INVENTION

Spinal cord stimulation (SCS) is an established neuromodulation therapy used to manage chronic pain conditions that do not adequately respond to conservative treatment. In a typical SCS system, mild electrical pulses are delivered to targeted regions of the spinal cord to modulate pain signaling along the dorsal columns. These pulses are generated by an external or implantable pulse generator and delivered through one or more leads carrying multiple electrode contacts. The therapeutic effect depends on the spatial and temporal distribution of the electric field produced by the electrodes, which in turn depends on lead placement, tissue conductivity, stimulation parameters, and anatomical variation among patients.

Modern SCS systems generally include several core components. The first is the implantable stimulation lead, which may be a percutaneous cylindrical lead or a surgical paddle lead. Each lead contains an array of electrically isolated contacts arranged linearly or in multiple columns. These leads are positioned epidurally along the dorsal aspect of the spinal canal so that the electrodes lie adjacent to the dorsal columns of the spinal cord. The second component is the implantable pulse generator (IPG) or external pulse generator (EPG), which supplies electrical pulses to the electrodes according to programmed parameters including amplitude, pulse width, frequency, and electrode configuration. The IPG contains a battery that powers the pulse generator and wireless communication circuitry. Each time the IPG receives programming commands or delivers stimulation pulses, the battery is depleted. Because the IPG is surgically implanted, battery depletion eventually necessitates a surgical procedure to replace the device.

SCS therapy is commonly used to manage neuropathic pain originating from conditions such as failed back surgery syndrome, radiculopathy, complex regional pain syndrome, diabetic neuropathy, and other chronic pain disorders. Although the mechanism is multifactorial, stimulation of the dorsal columns can modulate afferent signaling and disrupt the transmission of pain information to the brain. Achieving and maintaining appropriate therapeutic coverage requires careful alignment between the electrode field and the patient's symptomatic regions.

Implantation of SCS leads is typically accomplished through a minimally invasive percutaneous approach under fluoroscopic guidance. A Tuohy needle is advanced into the epidural space, and the stimulation lead is threaded cranially until the distal contacts reach the target vertebral level. Paddle leads may be placed through a laminotomy when a broader or more stable contact array is desired. Following satisfactory intraoperative testing, the lead is anchored and connected to an IPG placed in a subcutaneous pocket. Lead placement is critical, as even small deviations in mediolateral or rostrocaudal position can significantly alter therapeutic outcomes.

Programming the SCS system involves setting stimulation parameters that generate an electric field producing paresthesia coverage—or, in newer systems, a paresthesia-free analgesic effect—over the patient's painful regions. Traditional programming is highly iterative and depends on patient feedback. Clinicians select active electrodes, assign anode/cathode configurations, set current or voltage amplitudes, specify pulse width and frequency, and evaluate the resulting sensory coverage. This process may be repeated across multiple configurations until a satisfactory program is identified. As patient anatomy, lead position, and clinical conditions change over time, programming adjustments may be required to maintain optimal therapy.

The stimulation waveforms used in SCS systems are typically charge-balanced biphasic pulses designed to maintain a net zero injected charge at the electrode-tissue interface, thereby reducing the risk of tissue damage from electrochemical reactions. A standard biphasic pulse comprises an active stimulation phase, which delivers therapeutic current to the neural tissue, followed by a charge recovery phase, which returns the accumulated charge. The charge recovery phase may be active, in which the recovery current is driven by a controlled rectangular pulse of opposite polarity, or passive, in which the recovery current follows an exponential decay as stored charge dissipates through the electrode impedance. In either case, the areas under the stimulation phase and the recovery phase are substantially equal so that the net charge delivered over one complete cycle is approximately zero.

Four waveform paradigms are in predominant clinical use and differ primarily in their temporal delivery pattern. In conventional tonic stimulation, a single charge-balanced biphasic rectangular pulse is delivered at each cycle. The stimulation phase is typically a cathodic rectangular pulse, and the charge recovery phase is an anodic rectangular pulse of equal charge magnitude and opposite polarity. Tonic stimulation is commonly delivered at frequencies of approximately 40 Hz to 120 Hz with pulse widths of approximately 150 μs to 400 μs, and produces paresthesia in the targeted dermatomes. In burst stimulation, a short train of charge-balanced biphasic rectangular pulses—for example, approximately five pulses—is delivered at a high intraburst frequency of approximately 500 Hz, followed by a quiescent interval. The bursts repeat at a lower interburst frequency of approximately 40 Hz. Each individual pulse within the train is itself a charge-balanced biphasic rectangular pulse.

Additional waveform variants are also in clinical use. In passive recharge stimulation, the active stimulation phase is a rectangular current pulse, but the charge recovery phase is not actively driven; instead, accumulated charge dissipates through the electrode-tissue impedance in an exponential decay. Passive recharge is widely used in commercial SCS systems. In asymmetric biphasic stimulation, the recovery phase is delivered at a lower amplitude over a longer duration than the stimulation phase, maintaining charge balance while altering fiber recruitment characteristics. Other paradigms, including subthreshold conditioning prepulses delivered before a suprathreshold stimulation pulse, have also been used.

The selection of waveform paradigm is an additional programming parameter that, together with amplitude, pulse width, frequency, and electrode configuration, defines the stimulation program for a given patient. The parameters available for programming thus include not only the amplitude, pulse width, frequency, and electrode configuration, but also the waveform type and, where applicable, the intraburst pulse count and intraburst frequency.

Recent systems incorporate more advanced features. However, programming remains a largely manual process, and it can be time-consuming for clinicians and burdensome for patients. Additionally, the spatial relationship between electrode position, spinal anatomy, and perceived paresthesia is complex. Factors such as individual anatomical variation, cerebrospinal fluid thickness, tissue conductivity, and postoperative lead migration can make conventional programming less predictable.

Because the therapeutic effect of SCS depends on accurate targeting of neural structures with precisely shaped electric fields, there is a continuing need for improved systems and methods that can assist with electrode localization, interpretation of patient feedback, and generation of optimized stimulation programs. Improved solutions can enhance consistency, reduce programming time, and help maintain effective therapy even as patient anatomy, electrode position, or clinical conditions change over time.

In addition to these longstanding challenges, clinicians continue to face difficulties arising from the highly manual and subjective nature of conventional programming techniques. Even with modern hardware, programming still depends on an iterative, trial-and-error process in which clinicians alternate between parameter adjustments and patient feedback until acceptable coverage is reached. This approach can prolong clinic visits, produce inconsistent outcomes among clinicians, and limit the scalability of neuromodulation therapy across diverse care settings.

Another persistent issue involves the accuracy and reliability of patient-drawn paresthesia maps. Although these maps provide valuable insight into how a patient perceives stimulation, they are often imprecise, incomplete, or inconsistent over time. Patients may struggle to depict complex sensations on flat interfaces or may inadvertently introduce noise or distortion, making it difficult for clinicians to determine stimulator settings from the drawings. As a result, programming may be based on incomplete or unreliable sensory information.

Lead migration further complicates long-term therapy maintenance. Even small positional shifts can significantly alter the electric field delivered to the dorsal columns, often leading to reduced efficacy. Because migration is typically recognized only after the patient reports diminished pain relief, corrective action is frequently delayed. Confirming and quantifying migration generally requires dedicated imaging and manual interpretation, and there is no integrated mechanism to translate observed migration into updated stimulation parameters.

The absence of tools capable of inferring electric field distributions directly from patient-provided sensory input also limits clinical efficiency. Although patient feedback is central to traditional programming, existing systems do not provide quantitative modeling that connects that feedback to the underlying physics of the electric field. Hence, clinicians must rely on subjective interpretation rather than objective reconstruction of the field that produced the reported sensation, making the programming process less predictable and more dependent on clinician experience and trial and error.

Electrode localization presents another challenge. Accurately determining the position of each contact typically requires manual review of fluoroscopic images, subjective anatomical interpretation, and ad hoc scaling corrections which can be time consuming and error prone.

A fundamental limitation of conventional SCS programming systems is that they are purely reactive. The clinician inputs a set of stimulation parameters, the IPG delivers the corresponding stimulation, and the patient reports the resulting sensation. The system has no capability to predict what sensation pattern a given set of parameters will produce before the stimulation is actually delivered. Although finite element analysis can in principle predict electric field behavior in heterogeneous spinal tissues, conventional FEA tools are computationally intensive and impractical for routine clinical use-running full-resolution models generally requires specialized training and significant processing time, which prevents real-time modeling during a clinical encounter. As a result, clinicians have no practical means to evaluate candidate parameter combinations computationally and must instead explore the parameter space through exhaustive trial and error, with each trial requiring wireless transmission of settings to the IPG, delivery of electrical pulses to the spinal cord, and consumption of battery power.

This reactive architecture directly impacts the longevity of the implanted pulse generator. Each programming trial consumes battery power for wireless communication and stimulation delivery. A typical programming session may involve multiple parameter adjustments over a period of approximately 15 to 30 minutes, each adjustment requiring wireless transmission and stimulation delivery. Because programming is not a one-time event—patients typically undergo an initial programming session, one or more follow-up sessions to refine coverage, and additional reprogramming sessions as clinical conditions change, leads migrate, or therapy requirements evolve—the cumulative battery drain from programming sessions over the life of the implant contributes to earlier battery depletion and, in the case of non-rechargeable devices, earlier need for surgical replacement of the IPG. Even in rechargeable devices, cumulative programming drain reduces the interval between recharging cycles. A system capable of predicting stimulation outcomes computationally could evaluate many candidate parameter sets without transmitting to the IPG or delivering stimulation, thereby reducing the number of physical trials required across all programming sessions and extending the operational life of the implanted battery.

Another limitation of conventional SCS systems is that programming knowledge is isolated to individual patients. When a clinician successfully identifies effective stimulation parameters for one patient, that knowledge remains locked in that patient's record. A new patient presenting with similar electrode placement and pain distribution does not benefit from the prior patient's programming history. Each patient's programming session begins from scratch, with no mechanism to leverage patterns learned from the broader population of treated patients. Clinicians may develop personal expertise over time, but this expertise is informal, difficult to transfer, and not systematically captured or applied by the programming system itself.

Accordingly, there remains a need for SCS programming systems that are predictive rather than purely reactive, that can evaluate candidate stimulation parameters computationally without requiring physical delivery, that learn from programming outcomes across patient populations rather than treating each patient in isolation, and that reduce battery consumption by minimizing the number of physical programming trials required to identify effective therapy parameters.

### SUMMARY OF THE INVENTION

The present disclosure provides an integrated system for the acquisition, standardization, analysis, and modeling of sensory response data in connection with spinal cord stimulation therapy, and for generating stimulation setting recommendations using a combination of image-based electrode localization, photo-derived patient sensation maps, structured data preparation, and compact neural-network models. The system receives patient sensation maps through an interactive interface and standardizes them. These standardized sensation maps are processed by a trained neural network that infers electric field characteristics from the reported sensations and recommends optimized stimulation parameters for clinician review.

The system disclosed provides several technical improvements over conventional SCS programming systems. First, the system is predictive rather than purely reactive—the trained neural network can evaluate candidate stimulation parameters and predict the resulting sensation pattern before any stimulation is delivered to the patient, so that when the clinician provides a target sensation map, the system recommends optimized settings directly rather than requiring iterative trial-and-error adjustment. Second, the neural network learns from stimulus-response data collected across multiple patients, so that effective programming patterns discovered in one patient improve recommendations for subsequent patients with similar electrode configurations, rather than treating each patient's programming session as an isolated problem. Third, by performing parameter optimization through the trained neural network, the system reduces the number of physical programming trials required to identify effective therapy settings, thereby reducing wireless telemetry and stimulation delivery events that consume battery power in the implanted pulse generator and extending the operational life of the implanted device. In this way, the trained neural network serves as a compressed repository of paresthesia data collected from the plurality of stimulation trials, encoding the relationship between electrode contact positions, stimulation settings, and paresthesia patterns in the network weights, such that effective stimulation patterns discovered across patients are retrievable for new patients.

In one embodiment of the disclosure, a physical doll is provided with standardized fiducial markers that can be reliably photographed under ordinary clinical conditions. A digitization method converts the doll into a three-dimensional mesh, an unwrapped two-dimensional surface map, and an indexed table linking every fiducial to consistent three-dimensional and two-dimensional coordinates. These allow patient-applied markings to be captured by a smartphone and accurately projected into a standard reference body map. Corresponding image processing detects fiducials, determines camera angle, segments the patient's markings, and maps them onto a normalized two-dimensional surface for use by the neural network.

In another embodiment, a three-dimensional digital body model is acquired from a pre-built mesh library rather than by photogrammetry of a physical doll. The digital body model is configured with standard units, orientation, and anatomical landmark fiducials, and is rendered on a touchscreen display of a tablet computer. The patient draws sensation markings directly on the rendered body model using a stylus, and the system maps each touch point to UV coordinates on the body model surface using a raycasting operation, producing the same standardized two-dimensional surface map used by the neural network without requiring a physical doll, smartphone camera, fiducial detection, or camera pose estimation.

The disclosure also provides a method for recommending stimulation settings based on patient-reported sensation maps. By receiving electrode geometry and the standardized two-dimensional surface-map heatmap for a visit, the system initializes a safe first-guess, evaluates a forward neural network model to produce a predicted sensation image, measures its difference from the patient's image, and iteratively adjusts amplitude, pulse width, frequency, and waveform paradigm to provide a recommended stimulation program for clinician review and application. In another embodiment, the system also adjusts contact polarity as part of the iterative optimization.

In another aspect of the disclosure, a data-collection technique is supplied in which stimulation trials are conducted while the patient marks perceived sensation on the physical doll. The system applies safety limits to stimulation amplitude and charge density, and captures a photograph of the marked doll after each trial. Each trial yields the exact stimulation settings delivered, the electrode geometry file for that visit, and a two-dimensional heatmap representing the patient's perceived coverage. Patient identifiers are removed before the trial data is used for neural network training.

In another embodiment, the patient marks perceived sensation on a digital avatar displayed on a tablet computer rather than on a physical doll. The system displays a color intensity legend on the tablet alongside the rendered avatar, and for each trial the patient selects an intensity level and draws on the avatar with a stylus. The system converts each touch point to a UV coordinate on the avatar mesh surface and records the selected intensity at that coordinate, producing a standardized 224×224 heatmap for each trial. The heatmap is transmitted to the server and processed identically to a heatmap derived from a photographed physical doll.

The disclosure provides methods for organizing this trial data for efficient use. Contact geometries are translated into uniform feature tables with contact relationships, stimulation settings, and patient heatmaps which are normalized. Trials are then split into training, validation, and test sets.

In one embodiment, the disclosure implements a compact one-hidden-layer neural network that transforms a trial vector into a predicted sensation image. The trial vector encodes the implant geometry and stimulation settings. The hidden layer applies weighted connections and a sigmoid activation function to produce hidden activations, which are then passed through a second set of weighted connections and another sigmoid activation to produce the predicted image.

In another embodiment, a five-layer architecture produces higher-resolution predictions by separately encoding the implant geometry and stimulation settings, combining them into a coarse seed image, enlarging the seed through bilinear interpolation and smoothing passes, and applying a shared mixing stage with sigmoid activation to generate a full-resolution output map. The five layers comprise an input layer, a contact-rows sublayer that summarizes the set of contacts into a fixed-length implant summary vector, a trial-settings sublayer that converts raw control settings into a compact settings vector using a two-layer perceptron with ReLU activation, a fusion layer that combines the implant summary and settings vector and projects them into a coarse seed image, an upsampling layer that increases spatial resolution through bilinear interpolation, and a prediction layer that converts the multi-channel feature map into a single-channel sensation image.

The disclosure also provides a method for recommending stimulation settings based on patient-reported sensation maps. By receiving electrode geometry and the standardized two-dimensional surface-map heatmap for a visit, the system initializes a safe first-guess, evaluates a forward neural network model to produce a predicted sensation image, measures its difference from the patient's image, and iteratively adjusts amplitude, pulse width, frequency, and waveform paradigm to provide a recommended stimulation program for clinician review and application. In another embodiment, the system also adjusts contact polarity as part of the iterative optimization.

### BRIEF DESCRIPTION OF THE DRAWINGS

In the detailed description of the preferred embodiments presented below, reference is made to the accompanying drawings.

FIG. 1A is an architecture drawing of a preferred embodiment of the system.

FIG. 1B is a schematic drawing of the components of a preferred system.

FIG. 2 is a drawing of a physical doll used in a preferred embodiment of the system.

FIG. 3A is a flow chart of a preferred method of digitization of a physical doll.

FIG. 3B is a flow chart of a preferred method of configuring a digital avatar body model.

FIG. 4 is a flow chart of a preferred method of recording marked doll images and creating a digital heat map.

FIG. 5A is a flow chart of a preferred method of X-ray acquisition and association with patient ID and electrode type for fluoroscopic intake.

FIG. 5B is a flow chart of a preferred method of X-ray acquisition and association with patient ID and electrode type for C-arm intake.

FIG. 6 is a flow chart of a preferred method of identifying electrode locations from radiographs.

FIG. 7A is a flow chart of a preferred method of patient data collection.

FIG. 7B is a drawing of a physical doll illustrating an example of pain markings made by a patient as used in a preferred embodiment of the system.

FIG. 7C is a flow chart of a preferred method of patient data collection using a digital avatar displayed on a tablet computer.

FIG. 8 is a flow chart of a preferred method of preparing training data.

FIG. 9 is a schematic diagram of a preferred single hidden layer neural network.

FIG. 10 is a flow chart of a preferred method for training a neural network having a single hidden layer.

FIGS. 11A-11D are examples of Python code to instantiate and train a preferred single hidden layer neural network.

FIG. 12A is a schematic diagram of a preferred five-layer neural network.

FIG. 12B is a schematic diagram of a preferred trial settings sublayer.

FIG. 12C is a schematic diagram of a preferred seed generation layer.

FIG. 12D is a schematic diagram of a preferred upsampling layer.

FIG. 12E is a schematic diagram of a preferred bilinear resizing method.

FIG. 12F is a schematic diagram of a preferred smoothing method.

FIG. 12G is a schematic diagram of a preferred prediction layer.

FIG. 13 is a flow chart of a preferred method of training a five-layer neural network.

FIGS. 14A-14G are examples of Python code which implements a five-layer neural network.

FIG. 15 is a flow chart of a preferred method of making a stimulation setting recommendation from a specified set of electrode geometry and doll target map.

FIGS. 16A-16E are examples of Python code implementing a preferred method of making a stimulation setting recommendation from a specified electrode geometry and a doll target map.

FIG. 17A is an illustration of a target sensation map showing a prophetic patient's pain pattern as drawn on a physical doll.

FIG. 17B is an illustration of an initial predicted sensation map produced by a neural network using conservative default stimulation settings.

FIG. 17C is an illustration of a final predicted sensation map produced by a neural network using optimized stimulation settings found by the solver of method 1800.

FIG. 18 is a flowchart of a preferred method of generating and applying neural network-based stimulation recommendations, including a data collection phase, a training phase, and an inference phase.

### DETAILED DESCRIPTION OF THE INVENTION

In the description that follows, like parts are marked throughout the specification and figures with the same numerals, respectively. The figures are not necessarily drawn to scale and may be shown in exaggerated or generalized form in the interest of clarity and conciseness. Unless otherwise specified, the terms “about” and “approximately” indicate a tolerance of plus or minus 10%.

### System Architecture

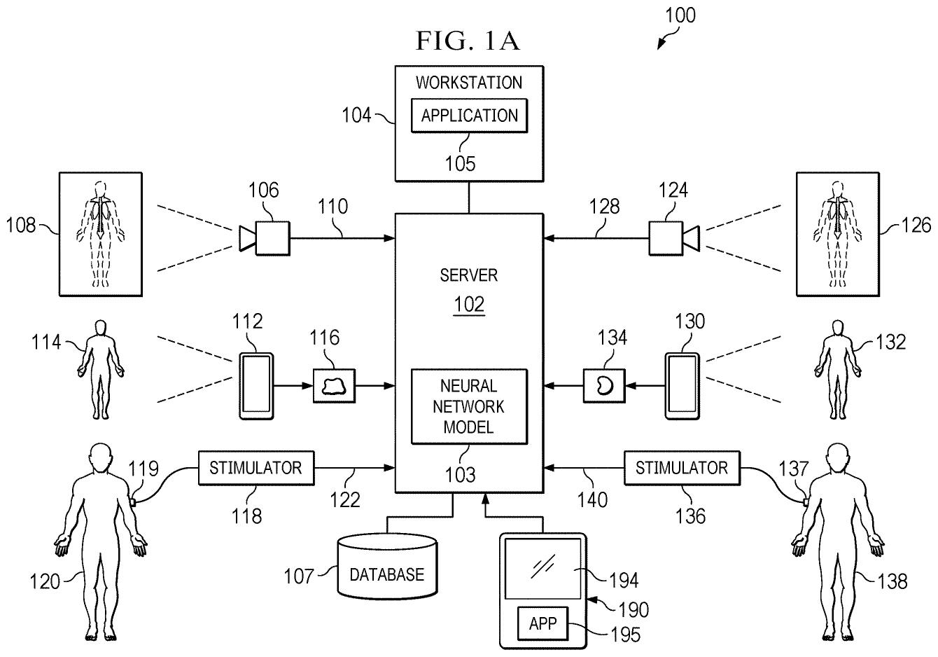

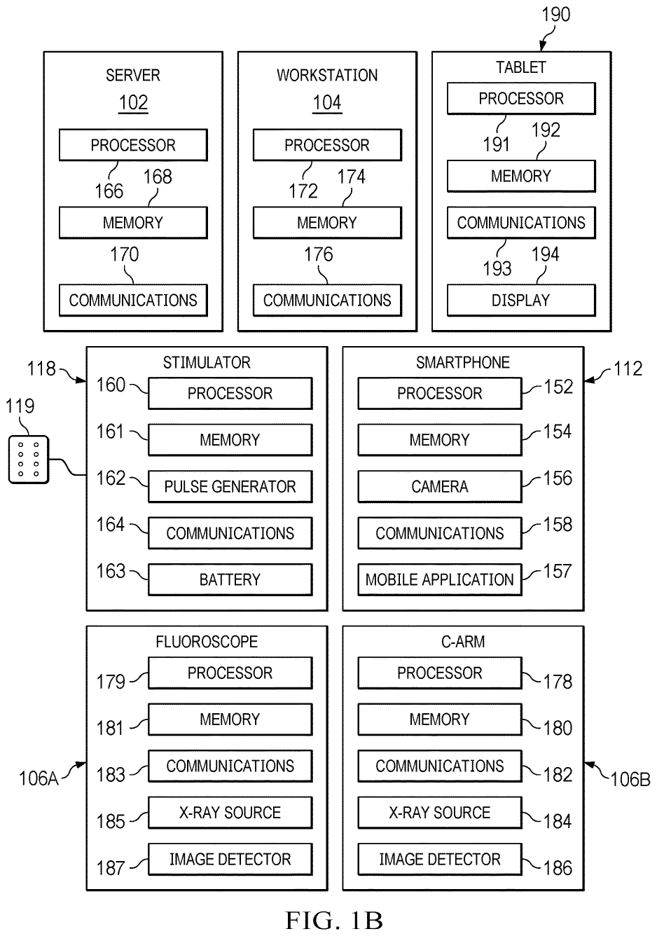

Referring to FIG. 1A, a preferred embodiment of architecture 100 of the system will be further described. Server 102 executes neural network model 103 as further described herein. Server 102 is operably connected to workstation 104. Administrative application 105 is resident in memory of the workstation and coordinates overall system functions as further described. Server 102 is operably connected to tablet computer 190. Avatar application 195 is resident in memory of tablet computer 190 and presents a digital body model on display 194 for patient interaction as further described.

Server 102 is operatively connected to X-ray machine 106. X-ray machine 106 captures X-ray image 108 and optionally transmits X-ray file 110 to server 102, either directly or via an attached imaging control unit (not shown), as further described. Server 102 is operatively connected to smartphone 112. Smartphone 112 captures an image of doll 114 and transmits stimulation map 116 to server 102 as further described; in some embodiments, smartphone 112 also captures or forwards a copy of X-ray image 108 (for example, by acquiring a photograph or exported file) and transmits that X-ray image to server 102. Server 102 is operatively connected to database 107 as will be further described.

Server 102 is further operatively connected to spinal cord stimulator 118. Spinal cord stimulator 118 includes electrode 119 implanted in patient 120. Stimulator 118 transmits stimulation settings 122 to server 102 as further described.

Server 102 is further operatively connected to spinal cord stimulator 136. Spinal cord stimulator 136 includes electrode 137 implanted in patient 138. Stimulator 136 transmits stimulation settings 140 to server 102 as further described.

Server 102 is also operatively connected to second X-ray machine 124. X-ray machine 124 captures X-ray image 126 and optionally transmits corresponding X-ray file 128 to server 102, either directly or via an attached imaging control unit (not shown), as further described. Server 102 is operatively connected to smartphone 130. Smartphone 130 captures an image of doll 132 and transmits pain map 134 to server 102 as further described; in some embodiments, smartphone 130 also captures or forwards a copy of X-ray image 126 and transmits that X-ray image to server 102. Server 102 is operatively connected to stimulator 136.

Server 102 communicates with each of X-ray machine 106, smartphone 112, stimulator 118, tablet computer 190, X-ray machine 124, smartphone 130, and stimulator 136 through network communications modules and network connections (not shown) as are known in the art. In a preferred embodiment, the network connections comprise secure wired Ethernet and/or WPA2/WPA3 Wi-Fi links using TCP/IP with transport-layer security. Imaging devices may send or receive studies using DICOM over IP either directly or through a hospital PACS or imaging control unit (not shown); mobile devices preferably communicate via HTTPS or gRPC; stimulators communicate via proprietary telemetry protocols or Bluetooth Low Energy bridges as supported by the device manufacturer. Server 102 communicates with workstation 104 via local area network using TCP/IP with transport-layer security. Server 102 communicates with database 107 via secure API calls over HTTPS.

### Preferred Machines

Referring to FIG. 1B, preferred embodiments of server 102, workstation 104, smartphone 112, tablet computer 190, X-ray machine 106, and stimulator 118 will be further described. Preferably, smartphone 112 and smartphone 130 are identical in the system, and so a description of smartphone 130 is omitted. Preferably, stimulator 118 and stimulator 136 are identical, and so a description of stimulator 136 is omitted. X-ray machine 106 and X-ray machine 124 are identical, and so a separate description of X-ray machine 124 is omitted.

Server 102 comprises processor 166 operatively connected to memory 168 and communications module 170. In a preferred embodiment, server 102 is a high-performance rack-mount machine including a multi-socket CPU configuration, at least 256 GB of system memory, one or more general-purpose GPUs for neural-network inference (not shown), redundant power, hardware RAID NVMe storage (not shown), and high-bandwidth networking. These capabilities enable real-time execution of neural network model 103 and concurrent ingestion of imaging and telemetry data. Other comparable GPU-accelerated servers may be used. Database 107 is preferably cloud memory storage such as Microsoft Azure, Amazon Web Services, or Google Cloud Platform, providing scalable and secure storage for patient records, electrode configurations, training data, and trained neural network weights.

Workstation 104 comprises processor 172 operatively connected to memory 174 and communications module 176. In a preferred embodiment, workstation 104 is a professional desktop workstation including a high-core-count CPU, at least 64 GB of memory, and a discrete GPU (not shown). The workstation executes administrative application 105 to manage study setup, guide data acquisition, review incoming images and maps, and coordinate device operations. Other professional workstations with comparable specifications may be used.

Tablet computer 190 comprises processor 191 operatively connected to memory 192, communications module 193, and touchscreen display 194. In a preferred embodiment, tablet computer 190 is a commercially available tablet device such as an Apple iPad Pro or Samsung Galaxy Tab S series, including a multi-core processor, at least 8 GB of memory, a high-resolution capacitive touchscreen display 194 supporting multi-touch and stylus input (for example, Apple Pencil or Samsung S Pen), and Wi-Fi or cellular connectivity. The device executes avatar application 195, which renders a three-dimensional digital body model on display 194 and captures patient-drawn pain or sensation markings directly on the rendered model as further described. Avatar application 195 transmits the captured markings to server 102 via communications module 193 for conversion to a standardized UV heatmap. In another embodiment, avatar application 195 is executed on workstation 104 or smartphone 112 rather than on a separate tablet computer, and the display of the workstation or smartphone serves as the touchscreen input surface. Other tablet computers with comparable touchscreen and connectivity capabilities may be used.

X-ray machine 106 is provided in two alternative embodiments. In a first embodiment, fluoroscope 106A comprises processor 179 operatively connected to memory 181 and communications module 183, together with an X-ray source 185 and an image detector 187. The fluoroscope is configured to resolve implanted electrodes and radiopaque markers and to acquire anterior-posterior and oblique views used for localization. The fluoroscope provides single-shot digital radiography and pulsed fluoroscopy with frame rates suitable for positioning, and mechanical motion adequate to obtain those views. In certain embodiments, a fluoroscope without native DICOM export capability may be used; in such cases, smartphone 112 captures a photograph of the fluoroscope display screen and transmits the photograph to server 102 for processing.

In another embodiment, the X-ray machine is a C-arm identified as X-ray machine 106B, comprising processor 178 operatively connected to memory 180 and communications module 182, together with an X-ray source 184 and a flat-panel digital detector 186 mounted on a C-shaped gantry (not shown). The C-arm provides a detector sufficient to resolve implanted electrodes and markers, single-shot digital radiography and pulsed fluoroscopy used to acquire anterior-posterior and oblique views, and mechanical motion including orbital angulation and vertical translation adequate to obtain those views. Processor 178 formats acquired images as DICOM objects and transmits them to server 102 via communications module 182.

Smartphone 112 comprises processor 152 operatively connected to memory 154, camera 156, and communications module 158. In a preferred embodiment, smartphone 112 is a commercially available device with a high-resolution multi-lens camera and 5G or Wi-Fi connectivity. The device executes mobile application 157 that guides standardized image capture of doll 114 and transmits stimulation and pain maps to server 102. Other smartphones with comparable capabilities may be used.

Stimulator 118 comprises processor 160 operatively connected to memory 161, communications module 164, pulse generator circuit 162, and battery 163. Pulse generator circuit 162 is operatively connected to electrode 119 implanted in patient 120. In a preferred embodiment, stimulator 118 is an implantable pulse generator with multi-channel outputs and wireless telemetry enabling receipt of stimulation settings from server 102 directly or via a clinician programmer or bridge (not shown). In one embodiment, battery 163 is a rechargeable lithium-ion battery having a capacity of approximately 125 to 440 mAh and an expected service life of approximately 10 to 12 years. Rechargeable batteries require periodic recharging using an external inductive coil held against the patient's skin over the implant site, with each recharging session lasting approximately 30 to 60 minutes. In another embodiment, battery 163 is a primary (non-rechargeable) lithium battery having a capacity of approximately 1 Ah and an expected service life of approximately five years under typical stimulation and programming conditions. The implantable pulse generator delivers programmed pulse trains with adjustable amplitude, pulse width, frequency, and electrode configuration to electrode 119.

Electrode 119 is preferably a paddle-type surgical lead configured for epidural placement. In one embodiment, the paddle provides either a 2×8 grid with sixteen contacts or a 4×8 grid with thirty-two contacts to permit flexible current steering across the dorsal columns. The contacts are formed of biocompatible conductive material such as platinum or platinum-iridium and are insulated with medical-grade silicone or polyurethane. Contact dimensions are on the order of 1 to 3 millimeters with approximately 1 millimeter longitudinal spacing, enabling fine-grained field shaping. Radiopaque markers or the contacts themselves provide fluoroscopic visibility for intraoperative positioning and postoperative localization.

### Physical Doll Specifications

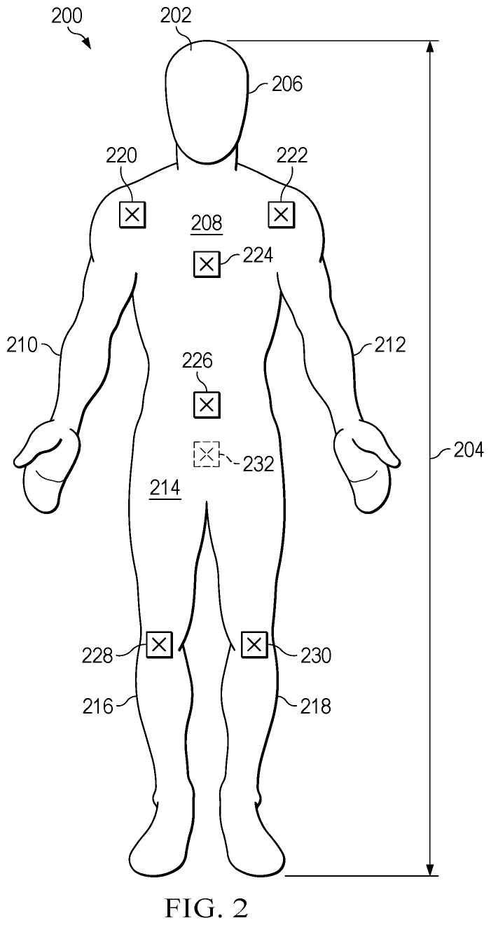

Referring to FIG. 2, physical doll 200 with labeled features and fiducial placements will be further described. Doll 114 and doll 132 described above are instances of physical doll 200. In one embodiment, physical doll 200 is a tangible training doll provided to serve as the physical substrate for subsequent digitization and patient marking. Physical doll 200 is fabricated from a durable, medical-grade polymer such as silicone or high-density polyethylene. The material is chosen to provide a matte, low-glare surface 202 that accepts ink markings without smearing and photographs cleanly under ordinary room lighting.

The overall body length 204 of physical doll 200 corresponds to a pediatric or adult human torso scaled to approximately 1:6 to 1:8 of real human dimensions, thereby allowing portability while maintaining proportional anatomical landmarks. Physical doll 200 exhibits simplified but recognizable human features including a head 206, torso 208, arms 210, 212, pelvis 214, and legs 216, 218. Surface curvature is anatomically approximate, providing sufficient geometric fidelity for digital mapping without unnecessary detail.

A fiducial marking system is applied to the surface of physical doll 200 in the form of machine-readable stickers placed at anatomical landmarks. Each fiducial is a square, high-contrast tag with a unique identifier code (for example, AprilTags or ArUco squares). AprilTags and ArUco squares are standardized visual fiducial markers that can be detected using OpenCV's aruco module, as known in the art. Placement is standardized at intuitive anatomical landmarks: left shoulder 220, right shoulder 222, sternum 224, pelvis center 226, left knee 228, right knee 230, and optionally posterior midline 232. Each fiducial includes an orientation mark to support both identification and local pose recovery. Fiducials are bonded securely to the matte surface and sized between 10 and 20 millimeters to ensure reliable detection at typical smartphone camera distances.

In another embodiment the fiducials are not used but instead the outline of physical doll 200 itself is used to register important patient markings.

### Digitization of the Physical Doll

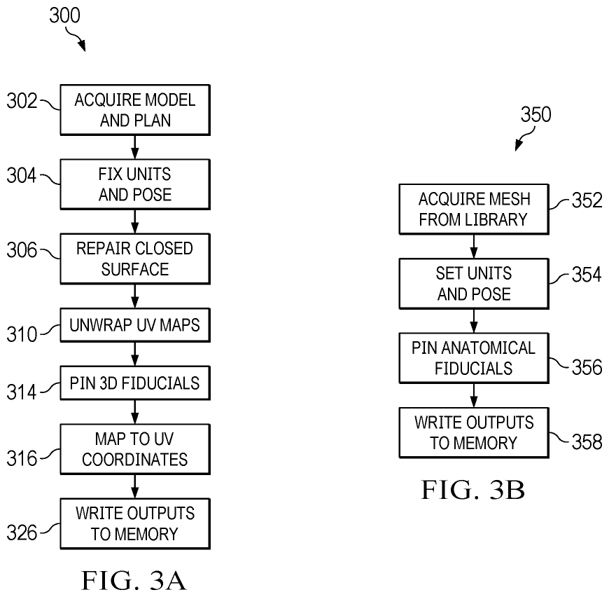

Referring to FIG. 3, method 300 uses physical doll 200 to create a digital model. The digital model in one preferred embodiment comprises three small files that are used by later steps.

First, doll_mesh.obj is a single three-dimensional surface of physical doll 200, measured in millimeters. It lists the surface points (x, y, z) and triangles that connect them in a mesh, as will be further described. It stores, for each point, a matching pair of UV numbers (u, v) that identify where that point lands on a flat body map. In this disclosure, OBJ means a plain-text three-dimensional mesh file of points and triangles, and UV means the two numbers used to locate a surface point on a two-dimensional unwrapped map.

Second, fiducials.json is a small table keyed by sticker ID. The fiducial sticker includes a printed code which is the sticker ID (e.g., A01 or B07). For each sticker, it records exactly where the sticker sits on the three-dimensional surface and the matching spot on the flat map, so a detected sticker in a photo can be tied to one place in three-dimensional space and one place in two-dimensional space.

Third, meta.json is a short file that fixes how to read the other two: it states the units (mm), the chosen up/right/forward directions for the model, the image size of the body map (for example 224×224), and any version tags. Taken together, these files give a clean three-dimensional shape, a one-to-one link from that shape to a flat picture, and a reliable lookup for the stickers, so later steps can place the patient's drawn marks on the flat map and still recover their exact three-dimensional locations when needed.

Method 300 begins with a single three-dimensional model of physical doll 200 and a plan listing fiducial sticker IDs and their landmarks. It produces: (i) a scaled and oriented three-dimensional model in millimeters, (ii) a flat, non-overlapping two-dimensional map of the surface, and (iii) a table linking each fiducial sticker to its exact location in both three-dimensional and two-dimensional space. These outputs allow later steps (photo capture, pose estimation, mapping of markings) to work reliably.

At step 302, the system acquires a single master three-dimensional model of physical doll 200 and a fiducial plan that lists sticker identifiers with intended landmark points. In a preferred embodiment, the model is a standard mesh file (e.g., OBJ/PLY/FBX) produced by photogrammetry and the fiducial plan is a small JSON/CSV file whose positions are given in millimeters. To do this, the system invokes Blender's mesh import operator, which is a built-in function of Blender, an open-source three-dimensional modeling and animation software available from the Blender Foundation at blender.org, that reads external mesh files and loads them into the application's data structure, as known in the art. The system also uses a standard JSON reader (e.g., json.load) to read the fiducial plan. Loading both objects at the start ensures the pipeline operates on consistent, versioned inputs.

At step 304, the system fixes the measurement units and the pose of the model so every run uses the same scale and orientation. In a preferred embodiment, the system uses Blender's scene unit settings, which is a configuration interface in Blender that specifies the real-world unit of measurement (such as millimeters, centimeters, or meters) for all objects in the scene, as known in the art. The current object scale is applied to bake those units onto the vertices. The pose is documented (for example, pelvis near the origin, head-to-toe axis up) so coordinates are interpreted consistently by all devices and later sessions. This step eliminates silent unit drift and orientation ambiguity.

At step 306, the system prepares the surface so it acts as one continuous, closed shell with outward-facing sides. In a preferred embodiment, the mesh is switched to edit mode and the system uses Blender's built-in mesh operators, which are functions within Blender that perform geometric operations such as recalculating surface normals and merging duplicate vertices, as known in the art. These operations remove common defects from capture/export pipelines and produce a watertight, outward-facing surface that behaves predictably in later unwrapping and sampling.

At step 310, the system flattens the three-dimensional surface into a single, non-overlapping two-dimensional map so that every surface point has exactly one place on the flat map. In a preferred embodiment, the system uses Blender's automatic unwrap function, which is a feature of Blender that projects a three-dimensional mesh surface onto a two-dimensional plane by computing UV texture coordinates for each vertex, as known in the art. This produces UV coordinates for every vertex and leaves small gaps between islands to avoid collisions on the texture atlas. A simple validation step then confirms that UVs are present on the exported mesh. This guarantees that downstream steps can map pixels to surface points without ambiguity.

At step 314, for each fiducial entry in the fiducial plan from step 302, the system pins the precise spot on the three-dimensional surface. In a preferred embodiment, the system uses a closest-point query function from the trimesh library, which is an open-source Python library for loading and manipulating triangular meshes that provides a function to find the nearest point on a mesh surface to a given query point, as known in the art. For each landmark position in millimeters, this function finds the nearest point on the mesh and the index of the triangle that contains that nearest point. From that triangle and the nearest point, the system computes the barycentric weights inside the triangle. Barycentric weights are three scalar values that express a point's position within a triangle as a weighted combination of the triangle's three vertices, where the weights sum to one, as known in the art. Storing the triangle index together with the in-triangle weights precisely identifies the surface location and is robust to small differences between the planned position and the actual mesh geometry.

At step 316, the system maps the same three-dimensional spot to its unique two-dimensional map coordinate. In a preferred embodiment, it retrieves the three UV coordinates associated with the identified triangle and blends them with the previously computed barycentric weights to produce a single pair (u, v) on the flat map. This creates, for each sticker identifier, a direct link from sticker in the real world to point on physical doll 200 in three-dimensional space to location on the flat two-dimensional map, which is what later photo-based capture and alignment steps require.

At step 326, the system writes the prepared outputs to disk so other modules can use them without repeating geometry work. In a preferred embodiment, Blender's OBJ exporter is used to save the millimeter-scaled, fixed-pose mesh with its UV coordinates, and two small JSON files are written: one fiducials table that records, for each sticker ID, the triangle index, the barycentric weights, and the resulting (u, v) coordinate; and one meta file that records the chosen units and pose. These saved artifacts are then referenced by later stages for photo capture, pose estimation, and heatmap generation.

### Digitization of an Avatar

Referring to FIG. 3B, method 350 alternatively configures a digital avatar body model for use with the system. Method 350 produces three output files—avatar_mesh.obj, fiducials.json, and meta.json—that are used by all downstream methods.

Method 350 begins with a pre-built three-dimensional human body mesh that is provided with clean topology, a closed surface volume, and pre-computed UV maps. Method 350 sets the mesh to a standard scale and orientation, pins anatomical landmark fiducials to the mesh surface, and writes the output files to memory.

At step 352, the system acquires a three-dimensional human body mesh from a mesh library. In a preferred embodiment, the mesh is selected from the Blender Human Base Meshes bundle, which is an asset library created by Blender Studio and distributed by the Blender Foundation under a Creative Commons CCO public domain license. The Blender Human Base Meshes bundle is distributed as a.blend file and includes multiple complete male and female human body meshes in both photorealistic and stylized variants, with clean quad topology, closed surface volumes, pre-computed UV maps with UDIM layout support, and multi-resolution detail levels. The system imports the selected mesh into Blender using Blender's asset library interface or, in another embodiment, imports the mesh from an exported file in OBJ, FBX, or USD format using Blender's mesh import operator. In other embodiments, the three-dimensional human body mesh is obtained from a different publicly available or commercially licensed mesh library, or is custom-modeled, provided the mesh is a closed-volume mesh with pre-computed UV coordinates.

At step 354, the system sets the mesh units to millimeters and confirms the mesh is oriented in a standard anatomical pose. In a preferred embodiment, the system reads or sets Blender's scene unit settings to millimeters and confirms the mesh is in a standard T-pose or A-pose with a consistent up/right/forward axis convention. If the mesh units are not in millimeters, the system applies a uniform scale factor to convert. If the mesh orientation does not match the system's chosen axis convention, the system applies a rotation to align the mesh.

At step 356, the system pins anatomical landmark fiducials to the mesh surface. In a preferred embodiment, a fiducial plan listing anatomical landmark identifiers and their intended three-dimensional positions is prepared, identifying landmarks such as the sternal notch, the iliac crests, the spinous processes, the acromion processes, and the greater trochanters. For each landmark in the fiducial plan, the system uses a closest-point query function from the trimesh library to find the nearest point on the mesh surface, identifies the triangle containing that point, and computes barycentric weights within that triangle. The system then maps each pinned three-dimensional point to its corresponding two-dimensional UV coordinate by blending the UV coordinates of the identified triangle using the barycentric weights. The resulting fiducial table associates each landmark identifier with a triangle index, barycentric weights, three-dimensional surface coordinates, and two-dimensional UV coordinates.

At step 358, the system writes the prepared outputs to memory. In a preferred embodiment, Blender's OBJ exporter is used to save the mesh with its UV coordinates as avatar_mesh.obj, a fiducials.json file is written recording the anatomical landmark table from step 356, and a meta.json file is written recording the units (mm), the axis convention, the target image size (for example, 224×224), and version tags.

### Capturing Marked Doll Images and Creating a Digital Heatmap

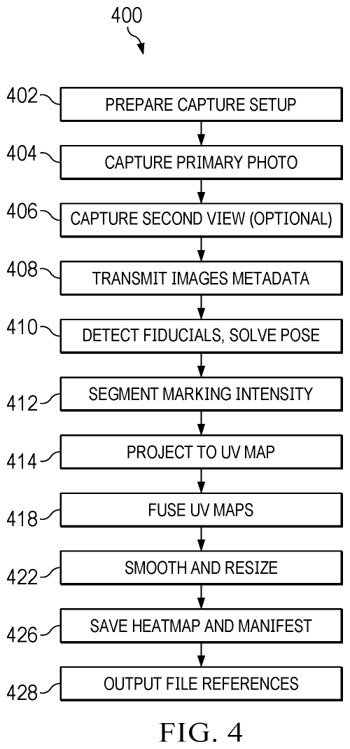

Referring to FIG. 4, method 400 uses smartphone 112 to capture marked-doll photographs and server 102 to process them into a fused UV heatmap tied to the standardized three-dimensional/UV model of physical doll 200. In another embodiment, smartphone 130 may be used. In certain embodiments, a calibration card may appear in the images for scale/color reference, and a manifest with a patient identifier is produced.

At step 402, smartphone 112 prepares capture by displaying a simple on-screen silhouette and optionally placing a printed calibration card near physical doll 200 so the card appears in the photographs for scale and color reference.

At step 404, smartphone 112 captures at least one photograph of the marked physical doll 200 with the calibration card optionally visible and with enough fiducial markers visible to solve camera pose (six or more preferred).

At step 406 (optional), smartphone 112 captures a second photograph from a different view (for example, back) under the same conditions.

At step 408, smartphone 112 transmits the captured image files and minimal capture metadata to server 102 over a network connection. The metadata includes a patient identifier, capture timestamps, and an indicator that the calibration card is present, if present.

At step 410, for each received photo, server 102 detects the fiducials and computes the camera's position and orientation relative to physical doll 200 using a pose-from-points procedure. A pose-from-points procedure is a computational method that determines the position and orientation of a camera in three-dimensional space by analyzing the known three-dimensional coordinates of reference points and their corresponding two-dimensional locations in the captured image; OpenCV, an open-source computer vision library available at opencv.org, provides functions such as solvePnP to perform this computation, as known in the art. The calibration card, if present, provides a per-image scale reference and may be used to normalize color/white balance.

At step 412, for each received photo, server 102 segments the colored markings into a single intensity image in the range [0 . . . 1], optionally using the calibration card to stabilize color response. In a preferred embodiment, segmentation is performed by converting the image to HSV color space and applying threshold filtering to isolate pixels matching the expected marker color range, using functions such as cv2.cvtColor and cv2.inRange available in OpenCV, as known in the art.

At step 414, for each received photo, server 102 projects the detected colored marking regions onto the non-overlapping UV map of physical doll 200 so that each marked pixel contributes to the correct UV coordinates.

At step 418, if two views are available, server 102 fuses the per-view UV maps by simple averaging where both provide values and by taking the single available value where only one view contributes; if only one view is available, this step is skipped.

At step 422 (optional), server 102 lightly smooths the fused UV heatmap and resizes it to a fixed resolution (for example, 224×224). Light smoothing applies a low-pass filter such as a Gaussian blur to reduce noise while preserving the overall shape of the marked regions, and resizing scales the image to a standard pixel dimension using interpolation methods such as bilinear or bicubic resampling, as known in the art.

At step 426, server 102 saves the resulting UV heatmap to database 107 and writes a manifest to memory that includes the patient identifier, the list of images used, the camera pose for each image, whether the calibration card was detected, the UV map size, and a method/version tag.

At step 428, server 102 outputs references to the saved UV heatmap and manifest, completing method 400.

Radiograph Acquisition and Association with Patient ID and Electrode Type

### Fluoroscopic Intake Embodiment

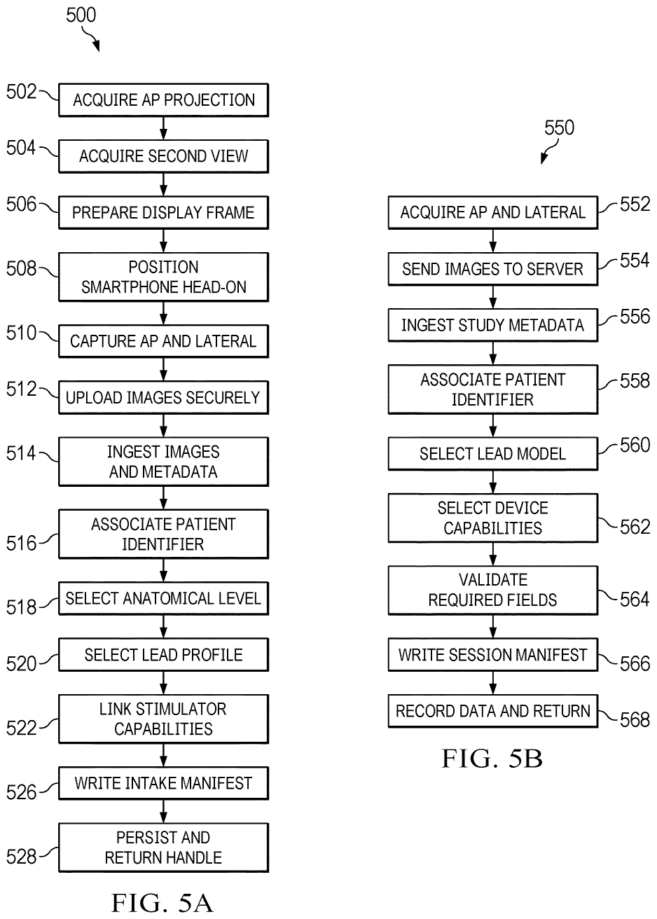

Referring to FIG. 5A, method 500 describes how radiographic images of an implanted spinal lead are obtained, delivered to server 102, and associated with patient identity and stimulator context at workstation 104 so that later processing proceeds without re-entry. Imaging hardware protocols and file formats are omitted; a smartphone 112 capture of the imaging display is supported.

At step 502, a true anteroposterior (AP) projection is acquired and centered on a selected anatomical level (one of C7, T4, T8, T12, or S1). At least one vertebral level above and below is included, rotation is minimized (spinous processes midline; pedicles symmetric), and the lead and contacts are maintained in view.

At step 504, a second projection at a distinct angle-either a true lateral or an ipsilateral oblique—may be acquired, centered on the same level.

At step 506, a sharp frame is frozen on the imaging display and prepared for capture by fitting the image to the screen, hiding PHI overlays, reducing glare/reflections, and ensuring the full image area is visible.

At step 508, smartphone 112 is positioned to view the display substantially head-on, focus is confirmed, and the image area is framed without clipping.

At step 510, smartphone 112 captures a single AP photograph of the display and, if obtained, a second photograph of the lateral or oblique display. Each photograph shows the selected level, both pedicles, and the lead contacts in focus.

At step 512, smartphone 112 uploads the photograph(s) with timestamps over a secure connection to server 102.

At step 514, the uploaded images are ingested by server 102 and basic identifiers and file references (including image URIs and received timestamps) are recorded for unambiguous retrieval.

At step 516, a workstation operator at workstation 104 associates the intake with a patient identifier so that downstream results are tied to the correct record.

At step 518, the workstation operator at workstation 104 selects the anatomical level (one of C7, T4, T8, T12, or S1) for the fiducial reference to be used in later processing.

At step 520, the implanted lead model is associated at workstation 104 by selecting a lead_profile_id (manufacturer/model/revision) from a catalog or lookup; the catalog version is recorded for traceability.

At step 522, the stimulator model and firmware are associated at workstation 104 and, when planning limits are desired, a device capabilities record is linked and its version recorded.

At step 526, a manifest is written by server 102 that binds the patient identifier, image references, selected anatomical level, lead profile and catalog version, and, when provided, device identifiers and capabilities version, together with minimal intake metadata.

At step 528, the manifest and image references are persisted by server 102 in durable storage and a session handle is returned so that later modules can retrieve the same inputs consistently.

### C-Arm Intake Embodiment

Referring to FIG. 5B, method 550 records X-ray images acquired on a C-arm system and binds them to patient identity, lead/electrode model, and stimulator capabilities, producing a manifest for later localization and planning.

At step 552, an anteroposterior (AP) projection is acquired on the C-arm and centered to include the implanted lead and adjacent vertebral levels, explicitly spanning a selected anatomical fiducial level (one of C7, T4, T8, T12, or S1). When available, a second view is obtained as a true lateral projection or an ipsilateral oblique projection at a distinct C-arm gantry angle (for example, approximately 20-35° from AP) to provide depth. Views are saved as DICOM with geometry fields (for example, pixel spacing and source-to-image distance). Exposure and centering follow routine clinical practice; no special C-arm control is required.

At step 554, the C-arm or PACS sends the acquired X-ray image(s) to server 102 using a standard mechanism (for example, DICOM C-STORE push). Alternatively, server 102 retrieves via DICOM C-FIND/C-MOVE, or a technologist imports files from removable media.

At step 556, server 102 ingests the received study and records basic image metadata (for example, study UID, series UID, pixel spacing if present, and timestamps) so that the files can be referenced unambiguously.

At step 558, a workstation operator at workstation 104 associates the study with a patient identifier. The operator selects or enters patient_id (for example, MRN or site ID) so that downstream results are tied to the correct record.

At step 560, the workstation operator at workstation 104 associates the study with the implanted electrode/lead model by selecting a lead_profile_id (for example, manufacturer/model/revision) from a catalog or lookup, or by scanning a label or UDI. The catalog version is recorded for traceability.

At step 562, the workstation operator at workstation 104 associates the study with the connected stimulator by selecting device_model and firmware (or retrieving them from a programmer interface). A capabilities record (for example, current, pulse-width, frequency ranges; maximum active contacts; waveform options; charge-density limit) is linked and its version recorded.

At step 564, server 102 validates that the association set is complete for later processing (for example, patient_id present, at least one X-ray URI present, and lead_profile_id present; if planning will be performed, device capabilities present). Any missing field is flagged for completion.

At step 566, server 102 writes a manifest that binds together patient_id, image references, lead_profile_id and catalog version, device identifiers and capabilities version, and minimal study metadata, so that later modules can operate without re-entry of this information.

At step 568, server 102 records the manifest and study references in database 107 and returns a session handle so that downstream localization/planning steps can retrieve the same inputs consistently.

Identifying Electrode Locations from Radiographs

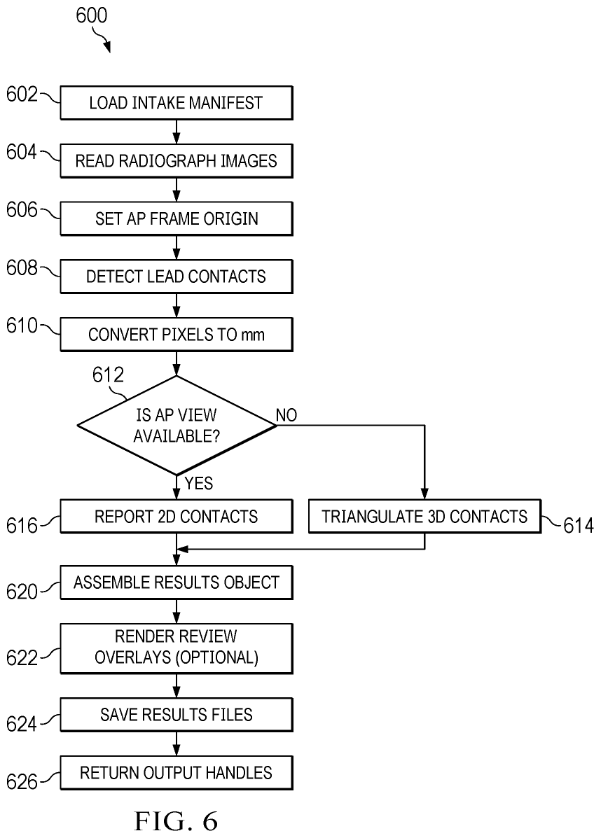

Referring to FIG. 6, method 600 describes a server-side pipeline that reads one or two radiographic images referenced by the intake manifest, locates lead contacts in the anteroposterior (AP) view, and outputs either two-dimensional contact coordinates (single-view) or three-dimensional contact coordinates (two-view), together with optional review overlays and a results file. All steps are performed on server 102. In a preferred embodiment, the function calls are implemented using the Python programming language.

At step 602, server 102 reads the intake manifest so it knows which images to open and what hardware to expect. A preferred implementation loads the JSON file using json.load, which is a function in the Python standard library that parses JSON-formatted data, as known in the art. Alternatively, if the images are DICOM, server 102 reads basic fields using pydicom.dcmread, which is a function in pydicom, an open-source Python library for reading DICOM medical imaging files available at pydicom.github.io, as known in the art. Server 102 retrieves patient_id, session_id, the lead profile identifier (which contains the known contact pitch and count), the selected vertebral level (for example, C7, T4, T8, T12, or S1), and a flag stating whether a second view is present.

At step 604, server 102 loads the radiographs. For ordinary image files, server 102 uses cv2.imread, which is a function in OpenCV, an open-source computer vision library available at opencv.org, that reads image files into memory as numerical arrays, as known in the art. For DICOM files, server 102 uses pydicom.dcmread to access the pixel_array and converts to 8-bit grayscale if needed using cv2.normalize, which is an OpenCV function that rescales pixel values to a specified range such as 0 to 255, as known in the art. To improve contrast before detection, server 102 may apply contrast-limited adaptive histogram equalization (CLAHE) using cv2.createCLAHE, which is an OpenCV function that enhances local contrast in images while limiting noise amplification, as known in the art. The result is one AP image and, if provided, a second image (lateral or oblique).

At step 606, server 102 establishes a stable patient frame in the AP plane by locating the left and right pedicles at the selected vertebral level and taking their midpoint. A preferred implementation detects the two pedicles by template matching using cv2.matchTemplate, which is an OpenCV function that searches an image for regions matching a provided template by sliding the template across the image and computing a similarity metric at each position, as known in the art. Server 102 uses a small circular or ovoid template, refines the two strongest symmetric responses near the chosen level, and computes the midpoint using numpy.mean. The left-right axis is the line through the two pedicles; the superior-inferior axis follows the vertebral column. Server 102 stores this origin and axes so all coordinates can be reported consistently.

At step 608, server 102 finds the lead contacts in the AP image and orders them along the lead. In a preferred embodiment, server 102 smooths the image using cv2.GaussianBlur, which is an OpenCV function that applies a Gaussian low-pass filter to reduce noise, as known in the art. Server 102 enhances small bright disks using cv2.morphologyEx with a top-hat transform, which is an OpenCV function that performs morphological operations; the top-hat transform extracts bright features smaller than a structuring element from the background, as known in the art. Server 102 then thresholds the image using cv2. threshold or cv2.adaptiveThreshold, which are OpenCV functions that convert grayscale images to binary images by setting pixels above a threshold to white and pixels below to black, as known in the art. Server 102 extracts round blobs using cv2.SimpleBlobDetector_create, which is an OpenCV function that detects and characterizes blob-like features in an image based on parameters such as size, circularity, and convexity, as known in the art. Server 102 fits a smooth path (the lead centerline) through those detections by sorting candidates top-to-bottom and fitting a low-order curve using numpy.polyfit, which is a function in NumPy, an open-source Python library for numerical computing available at numpy.org, that performs least-squares polynomial fitting, as known in the art. Alternatively, server 102 may use RANSACRegressor from sklearn.linear_model, which is a module in scikit-learn, an open-source Python library for machine learning available at scikit-learn.org, that performs robust regression by iteratively fitting models to random subsets of data and rejecting outliers, as known in the art. The candidates are ordered along this path by arc length. Outliers are removed by checking the sequence against the expected contact count and the expected neighbor spacing from a lead profile identifier, which is a stored record that specifies the manufacturer, model, and revision of the implanted lead along with its known physical dimensions such as contact pitch and contact count.

At step 610, server 102 converts AP-plane pixels to millimeters. If a reliable pixel size is present (for example, DICOM PixelSpacing), server 102 uses that value directly. Otherwise, server 102 derives the millimeters-per-pixel ratio from the known contact pitch in the lead profile identifier as follows: contact pitch is the center-to-center distance between adjacent electrode contacts on the lead, which is a fixed dimension specified by the lead manufacturer. Server 102 computes the median pixel distance between consecutive contacts along the fitted centerline using numpy.median, which is a NumPy function that returns the middle value of a sorted array, as known in the art. Server 102 then divides the known contact pitch in millimeters (obtained from the lead profile identifier) by this median pixel distance to obtain the millimeters-per-pixel ratio. Both the source of scale (DICOM metadata or lead profile) and the final millimeters-per-pixel value are recorded.

At step 612, server 102 chooses a branch. If only the AP view is available or two-dimensional mode is requested, server 102 continues at step 616. If a second view was provided and two-view mode is enabled, server 102 continues at step 614.

At step 614, for two-view processing, server 102 repeats the contact-finding steps on the second image and pairs the ordered contacts across views. Using the two image projection models, server 102 computes three-dimensional points by intersecting the back-projected rays. When camera geometry is known, server 102 forms two 3×4 projection matrices P1 and P2 and uses cv2.triangulatePoints, which is an OpenCV function that computes three-dimensional point coordinates from corresponding two-dimensional points in two images using the direct linear transformation method, as known in the art. If geometry must be estimated from image pairs, server 102 finds an essential or fundamental matrix using cv2.findEssentialMat or cv2.findFundamentalMat, which are OpenCV functions that compute the geometric relationship between two camera views from corresponding point pairs, as known in the art. Server 102 then recovers relative pose using cv2.recoverPose, which is an OpenCV function that extracts the rotation and translation between two camera positions from the essential matrix, as known in the art. Server 102 then triangulates to obtain three-dimensional coordinates. The resulting three-dimensional coordinates are converted from camera space into the patient frame defined at step 606 by applying a rigid transform, which is a mathematical operation that repositions points in three-dimensional space using rotation and translation without changing distances or angles, as known in the art. The rigid transform is constructed so that the origin lies at the pedicle midpoint and the axes align with the patient's left-right and cranial-caudal directions. The output for each contact is (x_mm, y_mm, z_mm).

At step 616, for single-view processing, server 102 reports two-dimensional contact coordinates in millimeters within the AP patient frame. For each detected contact at pixel coordinates (u, v), server 102 performs the following transformation: first, server 102 subtracts the pixel coordinates of the pedicle-midpoint origin established at step 606 from the contact's pixel coordinates (u, v) to obtain pixel offsets from the origin; second, server 102 multiplies these pixel offsets by the millimeters-per-pixel ratio computed at step 610 to convert to millimeters; third, server 102 assigns coordinate signs according to anatomical convention so that x_mm increases toward the patient's right side and y_mm increases toward the patient's head (cranially). Depth is not estimated in this branch, so z is omitted or set to null.

At step 620, server 102 assembles a results object that downstream code can use without re-entry. In Python this is a plain dictionary containing: a list of contacts with their coordinates (x_mm, y_mm, and optionally z_mm); the frame definition (the AP origin at the pedicle midpoint and axis directions, and, in the two-view case, the three-dimensional patient-frame transform); the selected anatomical level; the lead profile identifier used; geometry mode (indicating two-dimensional or three-dimensional); a flag indicating whether a second view was available; the millimeters-per-pixel value; and the scale source. No special libraries are required for this packaging beyond the standard json module.

At step 622 (optional), server 102 renders review overlays and displays them on workstation 104 so that an operator can visually verify that the automated detection is correct before proceeding. Server 102 draws the detected contact centers using cv2.circle, which is an OpenCV function that draws a circle on an image at specified coordinates with a specified radius and color, as known in the art. Server 102 draws the fitted centerline using cv2.polylines, which is an OpenCV function that draws connected line segments through a sequence of points, as known in the art. Server 102 draws the pedicle locations and their midpoint using cv2.circle and cv2.line, the latter being an OpenCV function that draws a straight line between two points, as known in the art. For two-view cases, server 102 may also draw a simple outline or markers on the second image. The images are saved using cv2.imwrite, which is an OpenCV function that writes an image array to a file in a specified format such as PNG or JPEG, as known in the art. If the operator identifies an error in the automated detection, the operator may manually correct the contact positions or repeat the acquisition.

At step 624, server 102 writes the structured outputs to database 107 and associates them to the session. A preferred implementation saves the coordinates and metadata to electrodes.json using json.dump, which is a function in the Python standard library that serializes a Python data structure into JSON-formatted text and writes it to a file, as known in the art. Server 102 writes any overlay PNG files using cv2.imwrite, which is an OpenCV function that writes an image array to a file in a specified format such as PNG or JPEG, as known in the art. File paths are recorded alongside the session_id from the manifest.

At step 626, server 102 returns a handle to the saved outputs so later modules can use the coordinates directly. In single-view cases, each contact is reported as (x_mm, y_mm) in the AP frame defined by the pedicles at the chosen vertebral level. In two-view cases, each contact is reported as (x_mm, y_mm, z_mm), where z_mm is the out-of-plane depth obtained by the two-view triangulation described above.

### Patient Data Collection

### Marking a Physical Doll

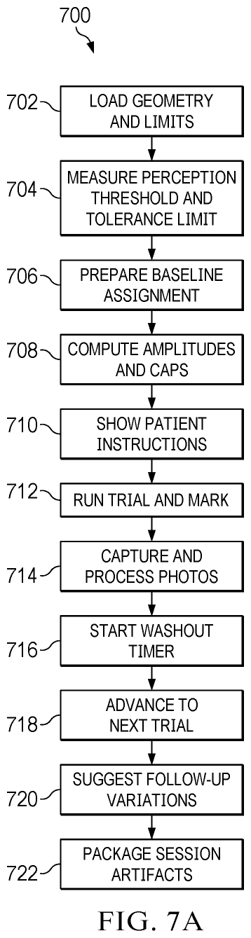

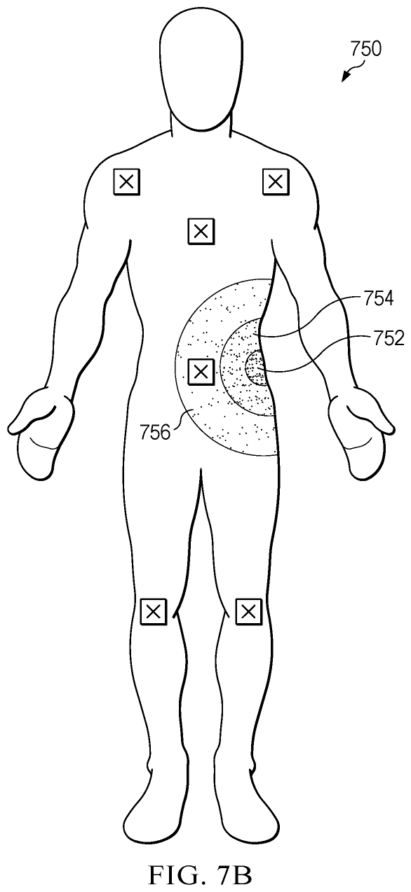

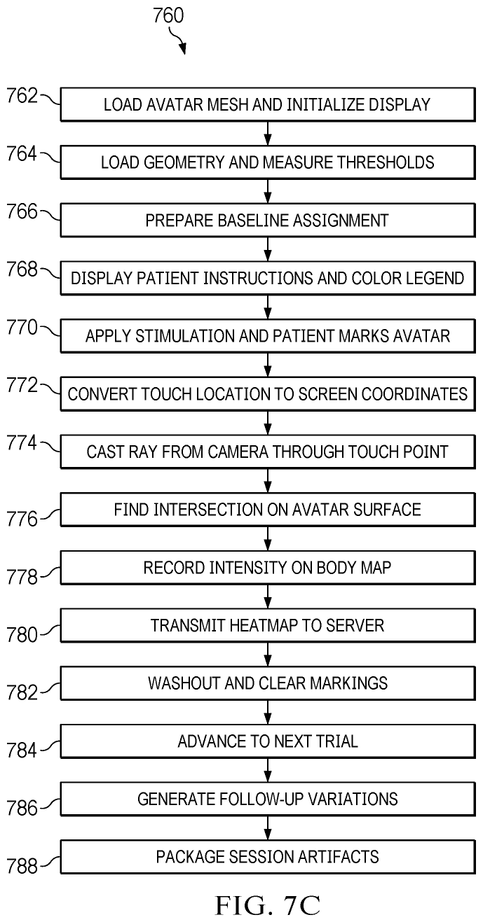

Referring to FIG. 7A, method 700 describes a streamlined routine in which workstation 104 guides a clinician through brief stimulation trials while the patient reports sensation by marking physical doll 200. Method 700 assumes an electrode geometry file from method 600 and uses simple, fixed rules for amplitudes and trial flow. Each step states what workstation 104 instructs, what the clinician does, and what the patient does.

At step 702, workstation 104 loads the electrode geometry file for the visit, presents the lead model and contact indices, and displays device capability limits including current, pulse width, frequency, maximum active contacts, and charge-density ceilings.

At step 704, workstation 104 prompts the clinician to determine perception threshold and tolerable limit for a representative contact using gentle ramps. The clinician operates the programmer to increase amplitude in small steps until the patient first perceives tingling, briefly reduces to confirm loss of perception, and then increases to identify the highest comfortable level during a short hold. The patient reports when tingling is first felt and when it becomes uncomfortable. Workstation 104 records the resulting thresholds for the session.

At step 706, workstation 104 prepares and displays a compact baseline assignment. Each assignment specifies a contact or pair, a pulse width, a frequency, and a waveform paradigm. Contacts are spaced axially in order to sample different segments. The waveform paradigm is encoded as an index in the input vector: index 0 for charge-balanced biphasic rectangular stimulation, index 1 for burst stimulation, index 2 for high-frequency stimulation. Workstation 104 or server 102 tracks the assignments for the study group.

In a preferred embodiment, the charge-balanced biphasic rectangular waveform paradigm (also referred to as conventional tonic stimulation) is a charge-balanced biphasic rectangular pulse comprising an active stimulation phase and a charge recovery phase, wherein the charge recovery phase is either active (rectangular) or passive (exponential), such that the net injected charge is approximately zero. Preferred ranges of frequencies for tonic stimulation are between about 40 Hz and about 120 Hz, and preferred ranges of pulse widths are between about 150 μs and about 400 μs. In this paradigm, the frequency specified in the assignment represents the pulse repetition frequency.

In another embodiment, burst waveforms are introduced in the assignment, wherein each burst comprises a train of approximately five charge-balanced biphasic pulses delivered at an intraburst frequency of approximately 500 Hz, with the bursts repeating at an interburst frequency of approximately 40 Hz. In the burst paradigm, the intraburst frequency and pulses per burst are fixed parameters of the paradigm, and the frequency specified in the assignment represents the interburst repetition frequency.

In yet another embodiment, high-frequency waveforms are introduced in the assignment, wherein charge-balanced biphasic pulses are delivered at frequencies in the range of approximately 1,000 Hz to 10,000 Hz at lower amplitudes than those used in tonic stimulation. In this paradigm, the frequency represents the pulse repetition frequency.

In still another embodiment, differential target multiplexed waveforms are introduced in the assignment, wherein multiple charge-balanced stimulation signals at different frequencies are multiplexed and delivered simultaneously through the electrode array. In this paradigm, the frequency specified in the assignment represents a base repetition rate and the multiplexing pattern is a fixed paradigm parameter.

In each of the foregoing embodiments, the assignment may additionally specify an alternative charge recovery method such as passive recharge or asymmetric biphasic stimulation. In any of the foregoing embodiments, the input vector may be expanded to include paradigm-specific parameters such as intraburst frequency, pulses per burst, quiescent interval duration, multiplexing pattern, or prepulse timing, with any paradigm-specific parameters that are not applicable to the selected waveform paradigm set to zero so that a single input vector format accommodates all waveform paradigms without requiring separate data structures.

### Example 1: Single Sixteen-Contact Surgical Lead

In one embodiment, a single sixteen-contact surgical paddle lead is implanted with contacts numbered 1 through 16 arranged in a 2×8 grid using charge-balanced biphasic rectangular stimulation (waveform index 0). A baseline assignment for this lead configuration includes the following trials: Trial 1 uses contact 4 as cathode and contact 3 as anode, with pulse width of 150 μs and frequency of 40 Hz. Trial 2 uses contact 4 as cathode and contact 3 as anode, with pulse width of 150 μs and frequency of 120 Hz. Trial 3 uses contact 4 as cathode and contact 3 as anode, with pulse width of 400 μs and frequency of 40 Hz. Trial 4 uses contact 4 as cathode and contact 3 as anode, with pulse width of 400 μs and frequency of 120 Hz. Trial 5 uses contact 8 as cathode and contact 7 as anode, with pulse width of 150 μs and frequency of 40 Hz. Trial 6 uses contact 8 as cathode and contact 7 as anode, with pulse width of 150 μs and frequency of 120 Hz. Trial 7 uses contact 8 as cathode and contact 7 as anode, with pulse width of 400 μs and frequency of 40 Hz. Trial 8 uses contact 8 as cathode and contact 7 as anode, with pulse width of 400 μs and frequency of 120 Hz. Trial 9 uses contact 12 as cathode and contact 11 as anode, with pulse width of 150 μs and frequency of 40 Hz. Trial 10 uses contact 12 as cathode and contact 11 as anode, with pulse width of 150 μs and frequency of 120 Hz. Trial 11 uses contact 12 as cathode and contact 11 as anode, with pulse width of 400 μs and frequency of 40 Hz. Trial 12 uses contact 12 as cathode and contact 11 as anode, with pulse width of 400 μs and frequency of 120 Hz. This assignment samples three axial positions along the lead (contacts 4, 8, and 12) and tests all four combinations of the preferred pulse width and frequency values at each position.

### Example 2: Dual Eight-Contact Percutaneous Leads

In another embodiment, two eight-contact percutaneous leads are implanted, with the left lead having contacts numbered L1 through L8 and the right lead having contacts numbered R1 through R8 using charge-balanced biphasic rectangular stimulation (waveform index 0). A baseline assignment for this lead configuration includes the following trials: Trial 1 uses contact L2 as cathode and contact L1 as anode, with pulse width of 150 μs and frequency of 40 Hz. Trial 2 uses contact L2 as cathode and contact L1 as anode, with pulse width of 400 μs and frequency of 120 Hz. Trial 3 uses contact L5 as cathode and contact L4 as anode, with pulse width of 150 μs and frequency of 40 Hz. Trial 4 uses contact L5 as cathode and contact L4 as anode, with pulse width of 400 μs and frequency of 120 Hz. Trial 5 uses contact L8 as cathode and contact L7 as anode, with pulse width of 150 μs and frequency of 40 Hz. Trial 6 uses contact L8 as cathode and contact L7 as anode, with pulse width of 400 μs and frequency of 120 Hz. Trial 7 uses contact R2 as cathode and contact R1 as anode, with pulse width of 150 μs and frequency of 40 Hz. Trial 8 uses contact R2 as cathode and contact R1 as anode, with pulse width of 400 μs and frequency of 120 Hz. Trial 9 uses contact R5 as cathode and contact R4 as anode, with pulse width of 150 μs and frequency of 40 Hz. Trial 10 uses contact R5 as cathode and contact R4 as anode, with pulse width of 400 μs and frequency of 120 Hz. Trial 11 uses contact R8 as cathode and contact R7 as anode, with pulse width of 150 μs and frequency of 40 Hz. Trial 12 uses contact R8 as cathode and contact R7 as anode, with pulse width of 400 μs and frequency of 120 Hz. This assignment samples three axial positions along each lead (contacts 2, 5, and 8) on both the left and right sides, and tests two combinations of pulse width and frequency at each position.

At step 708, workstation 104 computes two amplitude levels per assigned trial from the recorded thresholds and the configured safety limits and shows the intended values to the clinician. A first amplitude A1 is set to 0.9 times the perception threshold (PT), and a second amplitude A2 is set to 0.6 times the sum of PT and the tolerable limit (TL). PT is the perception threshold or the lowest amplitude where the patient first feels tingling, and TL is the tolerable limit or the highest amplitude the patient finds comfortable. When either value would exceed a device or safety limit such as per-contact current or charge density, workstation 104 clips the value to the highest allowed level, displays the adjustment, and records it in the trial manifest. For example, if PT is 0.90 mA and TL is 2.10 mA, then A1 is 0.81 mA and A2 is 1.80 mA; with a 1.50 mA limit, A2 becomes 1.50 mA and the cap is noted.

At step 710, workstation 104 displays brief patient instructions and the clinician verbally confirms them. The patient is instructed to color physical doll 200 immediately after each stimulation exactly where tingling is felt, to use the provided color key for intensity, to avoid over-drawing outside the perceived region, and to keep markings within the silhouette guides.

At step 712, workstation 104 displays on-screen instructions that guide the clinician through one trial, and the clinician operates the connected programmer accordingly. The clinician initiates the ramp-up to A1 or A2 over a preset time such as three seconds or longer, maintains a brief hold for the patient to judge location and quality, and initiates ramp-down to zero while monitoring the patient. Immediately after ramp-down, the patient marks physical doll 200 according to the instructions.

Referring to FIG. 7B, a representative marking doll 750 is shown. Marking doll 750 illustrates one example of prophetic markings made by a patient on a physical doll during a session; other marking locations are both possible and expected. In this example, marking doll 750 includes a high-pain region 752, a medium-pain region 754, and a low-pain region 756. In a preferred embodiment, regions 752, 754, and 756 are distinguished by different colors applied directly by the patient using a marker on physical doll 200.

Returning to FIG. 7A, at step 714, workstation 104 prompts the clinician to capture photos of the marked physical doll 200 using smartphone 112. Smartphone 112 displays an on-screen silhouette overlay that helps the clinician position and frame the doll consistently within the camera view. The clinician operates smartphone 112 and recaptures as needed until centering, coverage, and sharpness meet acceptable thresholds. Smartphone 112 transmits the accepted images to server 102. Server 102 processes the images using method 400 to produce a fused UV heatmap of the markings and writes a trial-level manifest that records the exact stimulation settings, a link to the electrode file, and timestamps.

At step 716, workstation 104 starts a timer for a washout interval with no stimulation so residual tingling fades and the next trial remains independent. Preferred washout duration is 60-120 seconds.

At step 718, workstation 104 advances to the next assigned trial and displays the next contact and parameters; the clinician performs the next trial and the patient again marks physical doll 200. Steps 712, 714 and 716 repeat until the baseline assignment is completed or a configured cap on trial count is reached.

At step 720, server 102 may generate a small number of follow-up variations based on the results of the baseline trials. In a preferred embodiment, server 102 generates follow-up variations by adjusting the amplitude, pulse width, or frequency of a baseline trial by a fixed percentage such as plus or minus ten percent. Workstation 104 presents the suggested follow-up variations for clinician acceptance. The suggested follow-up variations apply the same safety limits described at step 708. Suggestions end if improvement plateaus or the configured maximum number of trials is reached.

At step 722, server 102 packages the session artifacts into a single structured record and persists the record to database 107. In a preferred embodiment, the session record includes, for each completed trial: the stimulation settings (contact assignment, amplitude, pulse width, frequency, and waveform paradigm), the standardized doll heatmap produced by method 400, the electrode geometry produced by method 600, the perception threshold and tolerance limit measured at step 704, and the patient identifier. Server 102 also records session-level metadata including the date, the clinician identifier, the stimulator serial number, and the total number of trials completed. The packaged session record is stored in a format accessible to method 800 for subsequent training data preparation.

### Example 3: Multi-Site Patient Recruitment

In one embodiment, an initial wave of 20 patients across five clinics yields approximately 240 baseline trials (about 12 per patient) and 80 computer-suggested trials (about 4 per patient), totaling roughly 320 stimulus-response pairs. Two waves (40 patients) yield about 640 pairs; three waves (60 patients) yield about 960 pairs. For the neural network, between 1,000 and 2,000 pairs with balanced coverage across contacts and the preferred pulse-width/frequency pairings are sufficient for stable validation performance. Because the neural network is trained on stimulus-response data collected across multiple patients at multiple sites, effective programming patterns discovered in one patient become available to improve recommendations for subsequent patients with similar electrode configurations. This cross-patient learning distinguishes the disclosed system from conventional programming approaches in which each patient's session is treated as an isolated problem.

### Drawing on a Digital Avatar

Referring to FIG. 7C, method 760 describes a routine in which tablet computer 190 guides a clinician through brief stimulation trials while the patient reports sensation by drawing on a digital avatar displayed on display 194. Method 760 assumes an electrode geometry file from method 600 and a digital avatar body model configured by method 350. Method 760 produces the same trial records as method 700, each comprising stimulation settings and a standardized 224×224 UV heatmap.

At step 762, avatar application 195 loads the avatar mesh prepared by method 350 and initializes a three-dimensional rendering scene on display 194. In a preferred embodiment, avatar application 195 is written in JavaScript and is a browser-based application executing on tablet computer 190 using the Three.js library, which is an open-source JavaScript library for rendering three-dimensional graphics in a web browser using WebGL, available from threejs.org. Avatar application 195 loads the avatar mesh file (avatar_mesh.obj) using the OBJLoader class provided by Three.js, which parses a standard OBJ mesh file and returns a Three.js Mesh object with vertex positions, face indices, and UV texture coordinates preserved. Avatar application 195 creates a Three.js Scene, adds the loaded Mesh to the scene, positions a Three.js PerspectiveCamera at a default viewing angle, and creates a Three.js WebGLRenderer sized to display 194. Avatar application 195 registers touch event listeners on the rendered canvas so that stylus or finger contacts on display 194 are captured. Avatar application 195 also registers gesture listeners for pinch-to-zoom and swipe-to-rotate so the patient can rotate the avatar to expose any body surface for marking. Avatar application 195 initializes a blank UV texture image of size 224×224 pixels with all values set to zero, representing no markings.

At step 764, avatar application 195 loads the electrode geometry and device limits from the session file produced by method 600 and computes perception thresholds and tolerance limits as described with reference to step 704 of method 700.

At step 766, avatar application 195 prepares and displays a baseline assignment and computes amplitudes and safety caps as described with reference to steps 706 and 708 of method 700.

At step 768, avatar application 195 displays patient instructions on display 194. The instructions direct the patient to draw on the avatar immediately after each stimulation exactly where tingling is felt, using a color intensity legend displayed alongside the avatar on display 194. The color intensity legend presents the same intensity scale used with the physical doll, for example a graded series from light (low intensity) to dark (high intensity). The patient selects an intensity level from the legend and then draws on the avatar with a stylus. Avatar application 195 highlights the selected intensity level on display 194 so the patient can confirm the selection before drawing.

At step 770, the clinician initiates stimulation through stimulator 118 and the patient draws on the avatar rendered on display 194 using the stylus. For each touch or drag event registered on the canvas of display 194, avatar application 195 converts the touch coordinates to a UV coordinate on the avatar mesh and paints the patient's selected intensity value onto the UV texture image using the raycasting operation described in steps 772 through 778.

At step 772, avatar application 195 converts the raw touch coordinates from display 194 to normalized device coordinates in the range −1 to +1 using the formula:

$$pointer . x = ( \frac{touch . clientX}{canvas . width} ) \cdot 2 - 1$$

$$pointer . y = ( \frac{touch . clientY}{canvas . height} ) \cdot 2 + 1$$

Where:
touch.clientX and touch.clientY are the horizontal and vertical pixel positions of the stylus contact on the canvas of display 194; and
canvas.width and canvas.height are the pixel dimensions of the rendered canvas.

The normalization maps the upper-left corner of the canvas to (−1, +1) and the lower-right corner to (+1,−1), which is the coordinate convention expected by the Three.js Raycaster.

At step 774, avatar application 195 creates a Three.js Raycaster object and calls its setFromCamera method, passing the normalized pointer coordinates from step 772 and the current PerspectiveCamera. The setFromCamera method computes a ray originating at the camera position and passing through the screen point corresponding to the touch location. The ray is represented internally as an origin point and a direction vector in three-dimensional world coordinates.

At step 776, avatar application 195 calls the Raycaster's intersectObject method, passing the avatar Mesh. The intersectObject method tests the ray computed at step 774 against every triangle in the mesh and returns an array of intersection records sorted by distance from the camera. Each intersection record includes a UV property containing the interpolated two-dimensional UV texture coordinate at the intersection point, computed internally by Three.js from the barycentric coordinates of the intersection within the intersected triangle and the UV coordinates stored at the triangle's three vertices. In another embodiment, the raycasting is performed using Apple SceneKit on an iOS tablet or using OpenGL ES on an Android tablet, with equivalent raycast-to-UV computation.

At step 778, avatar application 195 reads the UV property from the nearest intersection record returned at step 776, scales the UV coordinates to pixel indices on the 224×224 UV texture image, and writes the patient's selected intensity value at that pixel location. As the patient drags the stylus across the avatar surface, avatar application 195 repeats steps 772 through 778 for each successive touch point, building up the marked region on the UV texture image in real time. Avatar application 195 renders the markings back onto the avatar mesh as a visual overlay on display 194 so the patient can see what has been drawn.

At step 780, after the patient has finished marking for the current trial, avatar application 195 transmits the completed 224×224 UV texture image to server 102 as the standardized heatmap for the trial. The transmitted heatmap is a single-channel image of size 224×224 pixels with each pixel value in the range 0 to 1, where 0 represents no sensation and 1 represents maximum intensity, mapped to the UV coordinate space of the avatar mesh prepared by method 350.

At step 782, avatar application 195 starts a washout timer and clears the avatar markings on display 194 so the avatar is blank for the next trial. A preferred washout duration is 60 to 120 seconds with no stimulation so that residual tingling fades and the next trial remains independent.

At step 784, avatar application 195 advances to the next assigned trial. Steps 770 through 782 repeat until the baseline assignment is completed.

At step 786, server 102 generates a small number of follow-up variations based on the results of the baseline trials by adjusting the amplitude, pulse width, or frequency of a baseline trial by a fixed percentage such as plus or minus ten percent. Avatar application 195 presents the suggested follow-up variations for clinician selection, and if the clinician selects one or more variations, the trial loop through steps 770 through 782 repeats for the selected variations.

At step 788, server 102 packages the session artifacts into a single structured record comprising, for each completed trial, the stimulation settings, the standardized 224×224 UV heatmap, the electrode geometry, the perception threshold and tolerance limit, and the patient identifier. Server 102 also records session-level metadata including the date, the clinician identifier, the stimulator serial number, and the total number of trials completed. Server 102 persists the structured record to database 107.

### Preparation of Neural Network Training Data

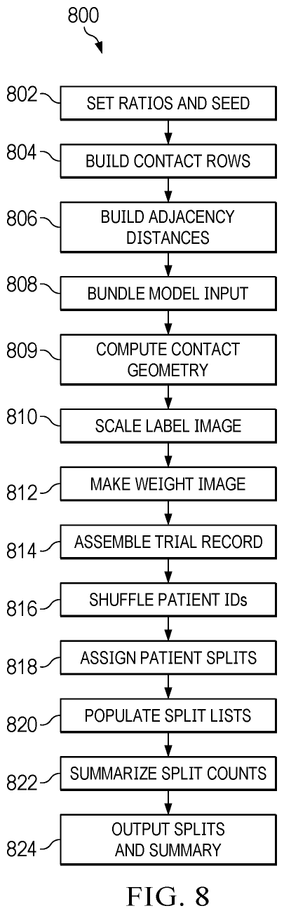

Referring to FIG. 8, method 800 prepares training data for neural network model 103. Method 800 builds a neural network input data structure x from the contact geometry, contact polarity assignments, and trial settings. Method 800 also builds two training outputs: a target image T, which is the doll heatmap showing where the patient reported sensation during the trial, and a weight image W, which indicates the relative importance of each pixel during training. Method 800 then splits patients into three subgroups: train, validation, and test. The inputs to method 800 are session files that contain contact coordinates in millimeters with information about which contacts are next to each other, the polarity designation for each contact, a 224×224 doll heatmap, and basic identifiers for patient and trial. The outputs of method 800 are three subgroups—train, validation, and test—each example carrying the neural network input x, the target image T, the weight image W, and the patient/trial identifiers.

At step 802, server 102 sets the split ratios (for example, 0.70 train, 0.15 validation, 0.15 test), chooses a fixed seed (for example, 42) so the split is repeatable, and prepares a simple list to collect trials under each patient identifier.

At step 804, for each trial, server 102 makes one row per contact. Each row holds the contact's position in millimeters (x, y, and optionally z), an is_tip flag indicating whether the contact is at the tip of the lead, and a polarity value indicating whether the contact is designated as a cathode (+1), anode (−1), or inactive (0) for this trial. Server 102 also records the trial-wide electrical settings (amplitude, pulse width, frequency, and waveform paradigm) so every trial carries both geometry and settings.

At step 806, server 102 builds a list of contact pairs that are next to each other on the lead and, for each pair, computes the straight-line distance between the two contacts using their millimeter positions. This produces two simple items for the model: a list of paired indices (which two contacts are connected) and a matching list of distances in millimeters.

At step 808, server 102 assembles the contact geometry as three pieces: the table of contact rows (each carrying x position, y position, is_tip flag, and polarity), the list of connected pairs, and the matching list of distances. Server 102 also keeps the patient identifier and trial identifier with the trial so it can be traced.

At step 809, server 102 computes a fixed-length summary of the contact geometry for the neural network input. Server 102 scans the contact rows from step 804 for contacts designated as cathodes (polarity=+1) and contacts designated as anodes (polarity=−1), skipping any contacts marked inactive (polarity=0). Server 102 computes cathode_x as the mean x-coordinate of all cathode contacts in millimeters, cathode_y as the mean y-coordinate of all cathode contacts in millimeters, anode_x as the mean x-coordinate of all anode contacts in millimeters, and anode_y as the mean y-coordinate of all anode contacts in millimeters. Server 102 then constructs a ten-element input vector x comprising: cathode_x, cathode_y, anode_x, anode_y, amplitude divided by 10, pulse width divided by 300, frequency divided by 200, and a three-element one-hot encoding of the waveform paradigm (charge-balanced biphasic rectangular, burst, or high-frequency). These unit scalings place all values into comparable numeric ranges. When the waveform paradigm is charge-balanced biphasic rectangular or high-frequency, the frequency element of the input vector represents the pulse repetition frequency. When the waveform paradigm is burst, the frequency element represents the interburst repetition frequency, and the intraburst frequency and pulses per burst are treated as fixed paradigm constants that are not included in the input vector. In another embodiment, the input vector is expanded to include additional paradigm-specific parameters such as intraburst frequency, pulses per burst, or quiescent interval duration, and the input vector length is increased accordingly. In another embodiment, the one-hot encoding is expanded to include additional waveform paradigms such as passive recharge, asymmetric biphasic, differential target multiplexed, and subthreshold conditioning prepulse stimulation, and the input vector length is increased accordingly.

At step 810, server 102 creates the target image T by scaling the trial's doll heatmap to the range 0-1 at the fixed 224×224 size, so pixel values are normalized consistently across trials. In a preferred embodiment, server 102 performs this scaling using cv2.resize, which is an OpenCV function that resizes an image to specified dimensions using interpolation, and then divides pixel values by 255 to normalize to the 0-1 range, as known in the art.

At step 812, server 102 creates the weight image W, which is used during neural network training to weight the loss function so that pixels with higher W values contribute more to the training loss. In a preferred embodiment, server 102 sets W to an all-ones image of size 224×224, indicating that all pixels are weighted equally during training. In another embodiment, server 102 may set W to a higher value (for example, 1.0) for pixels where the patient marked sensation and a lower value (for example, 0.5) for unmarked pixels, so the network focuses more on learning where sensation is present.

At step 814, server 102 forms one trial record as {x, T, W, patient identifier, trial identifier} and adds it to the list for that patient so all of a patient's trials stay together.

At step 816, after all trials are added, server 102 makes a repeatable ordering of the patient identifiers using the fixed seed so the same input will always produce the same split.

At step 818, server 102 calculates how many patients belong in train, validation, and test based on the chosen ratios and assigns each patient-never individual trials to exactly one subgroup.

At step 820, server 102 fills the three subgroups by copying all trials for each patient into that patient's assigned subgroup, producing three concrete lists named train, validation, and test, each holding examples of the form {x, T, W, patient identifier, trial identifier}.

At step 822, server 102 creates a short summary with the number of examples in each subgroup, along with the seed and the ratios used, so the split can be checked and reproduced.

At step 824, server 102 outputs the three subgroups-train, validation, and test—and the summary, ready for training and evaluation.

### Neural Network Model and Method of Training

### First Embodiment

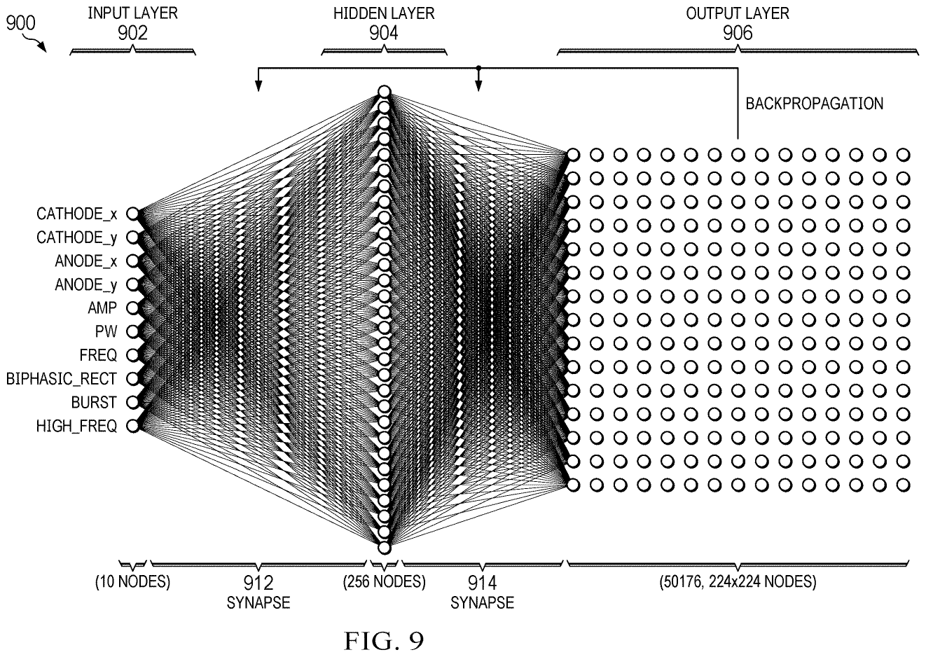

Referring to FIG. 9, a preferred embodiment of an artificial neural network for predicting a two-dimensional sensation map will be further described.

Neural network 900 includes input layer 902, hidden layer 904, and output layer 906. Other numbers of nodes and layers may be used.

Input layer 902 has one node for each element of a ten-value trial vector. In the depicted embodiment, input layer 902 consists of ten input nodes representative of: cathode_x (x-position of the active cathode contact), cathode_y (y-position of the active cathode contact), anode_x (x-position of the active anode contact), anode_y (y-position of the active anode contact), amplitude scaled by 10, pulse width scaled by 300, frequency scaled by 200, and a three-way waveform paradigm code carried as charge-balanced biphasic rectangular, burst, and high-frequency one-hot indicators. These unit scalings place the stimulation settings into comparable numeric ranges without loss of generality. In other embodiments, the input layer may have a greater or lesser number of nodes based on additional summary features, alternative waveform paradigm encodings including differential target multiplexed stimulation, passive recharge, asymmetric biphasic, and subthreshold conditioning prepulse stimulation, or per-contact polarity values indicating cathode, anode, or inactive status for each contact in the electrode array.

Each node of input layer 902 is connected to each node of hidden layer 904 by a set of weighted connections (synapses) 912. Each synapse is assigned a learnable weight. The weighted inputs are multiplied by the synapse weights and summed to determine a hidden pre-activation value for each node in hidden layer 904. In the preferred embodiment, hidden layer 904 includes weighted nodes (e.g., H=256). An activation function is applied to the summed input at each hidden node to produce its output value; in one embodiment, a logistic (sigmoid) function is used because it yields stable values bounded between 0 and 1 and supports efficient gradient computation.

Each node of hidden layer 904 is connected to each node of output layer 906 by a second set of weighted connections (synapses) 914. Each synapse is assigned a learnable weight. The outputs of hidden layer 904 are multiplied by the synapse weights and summed to determine a pre-activation value for each node of output layer 906. An output activation function is then applied to produce a pixel intensity prediction. In the preferred embodiment, output layer 906 contains N nodes, where N equals the number of pixels in the target image. For a 224×224 map, output layer 906 contains 50,176 output nodes. Each output node corresponds to a specific pixel location in the standardized body map; although shown schematically as a column for clarity, these outputs map one-to-one to the 224×224 grid.

In operation, for a single trial input vector x, hidden layer 904 computes a weighted sum plus bias for each hidden node, applies the activation function to produce hidden activations, and forwards those activations through the second set of synapses 914 to output layer 906. Output layer 906 likewise computes a weighted sum plus bias for each output node and applies the output activation to produce a predicted pixel value between 0 and 1. The collection of all output node values forms the predicted sensation image for that trial.

Bias terms may be included for hidden layer 904 and output layer 906 to shift the activation thresholds; in the schematic, bias sources may be omitted for clarity (not shown). During training, the synapse weights and biases are adjusted to minimize the difference between the predicted output image and the provided target image, as described with respect to method 1000. In other embodiments, alternative activation functions, alternative input encodings, or different hidden layer sizes may be used while remaining within the scope of the invention.

The single-hidden-layer architecture of neural network 900 is not a mere design choice. Rather, it is important because it provides robust learning when training data is limited. The mapping from stimulation parameters to sensation patterns is continuous and relatively smooth, which a single hidden layer can approximate without the additional complexity of deeper networks. When training data is limited to hundreds or thousands of patient examples, a network with fewer parameters is less likely to memorize specific training examples and more likely to learn the underlying relationship between inputs and outputs. The trained single-hidden-layer neural network encodes paresthesia data from the training trials into the weighted connections, serving as a compressed repository from which predicted sensation patterns are retrievable given new electrode contact positions and stimulation settings. A compressed repository is different from a common memory location because the network learns what values to place on each of the weights during training. The meaning of the weights emerges from the training process rather than being assigned by a programmer. Therefore, the compressed repository creates combinations and meanings that a human cannot track mentally, which is very different from assigning a value to a memory location as is done in common practice.

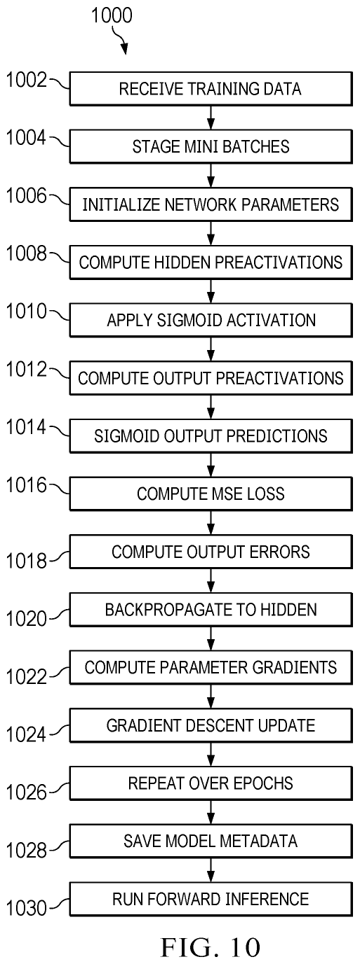

Referring to FIG. 10, a flow chart of method 1000 for training a one-hidden-layer neural network will be further described. Method 1000 learns four parameter sets that map a ten-element input vector to a two-dimensional image.

At step 1002, training data are received. Each example provides an input vector x comprising ten elements and a target image T of size 224×224. For computation, T is flattened to a vector t of length N, where N=224×224=50,176.

At step 1004, the input data is grouped in small batches, for example, a batch of inputs with shape (B×10), where B is the batch size, and a batch of flattened targets with shape (B×N).

At step 1006, parameters are initialized with small random weights and zero biases. The trainable parameters are: W₁ with shape (10×H), b₁ with shape (1×H), W₂ with shape (H×N), and b₂ with shape (1×N), where H is the hidden width (for example, 256) and N is the number of output pixels (50,176). In a preferred embodiment, each weight is initialized to a uniform random value between −0.05 and 0.05, and each bias is initialized to zero.

At step 1008, hidden pre-activations are computed according to the following equation:

$${Z}_{1} = X \cdot {W}_{1} + {b}_{1}$$

Where:
Z₁ represents the hidden pre-activations with shape (B×H);
X is the batch input matrix with shape (B×10);
W₁ is the input-to-hidden weight matrix with shape (10×H); and
b₁ is the hidden bias vector with shape (1×H) that is broadcast across all examples in the batch.

Element-wise, for each example q in the batch and each hidden unit j, the hidden pre-activation Z₁(q,j) is computed as the sum over all input indices i of the product of the i-th input feature x(q,i) and the weight W₁(i,j), plus the bias b₁(j).

At step 1010, hidden activations are computed by applying the logistic (sigmoid) function:

$${A}_{1} = σ ( {Z}_{1} )$$

Where:
A₁ represents the hidden activations with shape (B×H); and
σ enotes the element-wise sigmoid function defined as σ(z)=1/(1+e^{-z}).

The derivative of the sigmoid function is σ′(z)=σ(z)×(1−σ(z)), which will be used during backpropagation. This nonlinearity enables the network to model non-linear relationships while maintaining numerically stable, normalized activations bounded between 0 and 1.

At step 1012, output pre-activations are computed according to the following equation:

$${Z}_{2} = {A}_{1} \cdot {W}_{2} + {b}_{2}$$

Where:
Z₂ represents the output pre-activations (flattened image) with shape (B×N);
A₁ represents the hidden activations;
W₂ is the hidden-to-output weight matrix with shape (H×N); and
b₂ is the output bias vector with shape (1×N).

Elementwise, for each example q and each output index k, the output pre-activation Z₂(q,k) is computed as the sum over all hidden indices j of the product of the hidden activation A₁(q,j) and the weight W₂(j,k), plus the bias b₂(k).

At step 1014, each pixel's scalar is normalized to the open interval (0, 1) by applying the sigmoid function, producing a normalized image suitable for comparison to the target intensities:

$$\hat{Y} = σ ( {Z}_{2} )$$

Where:
Ŷ represents the predicted flattened images with shape (B×N); and
each element Ŷ(q,k) is the predicted value of pixel k for example q.

At step 1016, mean-squared-error loss is evaluated according to the following equation:

$$L = \frac{1}{( B \cdot N )} \cdot {Σ}_{q} {{Σ}_{k} ( \hat{y} ( q , k ) - t ( q , k ) )}^{2}$$

Where:
L is the batch loss (a scalar);
B is the batch size;
N is the number of pixels;
ŷ(q, k) is the predicted value of pixel k for example q; and
t(q,k) is the target value of pixel k for example q.

The summation is taken over all examples q in the batch and all pixels k. This mean-squared-error quantifies prediction deviation in a single number to be minimized during parameter updates.

At step 1018, output-layer error terms are computed using the sigmoid derivative:

$${Δ}_{2} = ( \frac{2}{B} ) \cdot ( \hat{Y} - T ) ⊙ \hat{Y} ( 1 - \hat{Y} )$$

Where:
Δ₂ represents the errors at output pre-activations with shape (B×N);
⊙ (denotes element-wise (Hadamard) multiplication;
T is the batch of flattened targets, and
(1/B) scales the error by the batch size.

The term Ý ⊙ (1−Ŷ) is the derivative of the sigmoid function evaluated at the predictions, that is, σ′(Z₂)=Ŷ·(1−Ŷ). This produces the error at the output pre-activations, which is used to compute parameter gradients and to propagate error to earlier layers.

At step 1020, hidden-layer error terms are computed:

$${Δ}_{1} = ( {Δ}_{2} \cdot {W}_{2}^{T} ) ⊙ {A}_{1} ⊙ ( 1 - {A}_{1} )$$

Where:
Δ₁ represents the errors at hidden pre-activations with shape (B×H);

$${W}_{2}^{T}$$

is the traspose or W₂ with shape (N×H); and
A₁ ⊙ (1−A₁) is the sigmoid derivative applied to the hidden activations, that is, σ′(Z₁)=A₁·(1−A₁).

This step backpropagates the output error to the hidden layer, yielding the error at the hidden pre-activations which is subsequently used to form gradients for W₁ and b₁.

At step 1022, parameter gradients are accumulated. The output-layer gradients are computed as:

$$\frac{\partial L}{\partial {W}_{2}} = {A}_{1}^{T} \cdot {Δ}_{2}$$

$$\frac{\partial L}{\partial {b}_{2}} = sum\_over \_q ( {Δ}_{2} )$$

Where:

$${A}_{1}^{T}$$

is the transpose of A₁ with shape (H×B); and
sum_over_q denotes summation over the batch dimension to form a bias gradient vector of shape (1×N).

The hidden-layer gradients are computed as:

$$\frac{\partial L}{\partial {W}_{1}} = {X}^{T} \cdot {Δ}_{1}$$

$$\frac{\partial L}{\partial {b}_{1}} = sum\_over \_q ( {Δ}_{1} )$$

Where:
X^{T} is the transpose of X with shape (10×B); and
sum_over_q denotes summation over the batch dimension to form a bias gradient vector of shape (1×H).

The output-layer gradients are obtained by multiplying the hidden activations by the output error term; the hidden-layer gradients are obtained by multiplying the inputs by the hidden error term.

At step 1024, parameters are updated by gradient descent. For each layer [symbol] in {1, 2}:

$${W}_{ℓ} ← {W}_{ℓ} - η \cdot \frac{\partial L}{\partial {W}_{ℓ}}$$

$${b}_{ℓ} ← {b}_{ℓ} - η \cdot \frac{\partial L}{\partial {b}_{ℓ}}$$

Where:
η is the learning rate (a positive scalar hyperparameter, for example 0.001 or 0.05);
[symbol] is the weight matrix for layer [symbol] ;
[symbol] is the bias vector for layer [symbol] , and

$$\frac{\partial L}{\partial {W}_{ℓ}} and \frac{\partial L}{\partial {b}_{ℓ}}$$

are the corresponding gradients computed at step 1022.

This step updates the learnable parameters by gradient descent, decreasing each weight and bias in proportion to its corresponding loss gradient, thereby reducing the training loss on subsequent iterations.

In a preferred embodiment, training examples are grouped into batches of size B (for example, B=32). Processing examples in batches rather than one at a time improves computational efficiency and stabilizes gradient estimates by averaging across multiple examples. If the training set contains 960 examples and the batch size is 32, this produces 30 batches. An epoch is one complete pass through all training examples, during which each batch is processed once and the weights are updated once per batch. Training typically continues for multiple epochs (for example, 50 to 200 epochs), allowing the network to see each example many times and make incremental improvements with each pass. For example, training for 100 epochs with 30 batches per epoch results in 3,000 total weight updates.

At step 1026, steps 1008 through 1024 are repeated over batches and epochs until a stopping criterion is met. In one embodiment, training stops after a maximum epoch count is reached (for example, 200 epochs). In another embodiment, training stops due to insufficient improvement, which occurs when the validation loss fails to decrease by more than a threshold amount (for example, 0.0001) for a specified number of consecutive epochs (for example, 10 epochs); this technique is known as early stopping and helps prevent overfitting, which is the condition where the network memorizes the training data rather than learning generalizable patterns.

At step 1028, the trained parameters (W₁, b₁, W₂, b₂), the output grid specification (224×224), and training metadata (learning rate n, random seed, epoch count) are stored in non-transitory computer-readable media.

At step 1030, the trained model is deployed. Given a new input vector x with ten elements, the forward relations of steps 1008 through 1014 produce a predicted output Ý with N elements, which is reshaped to a 224×224 image for downstream use.

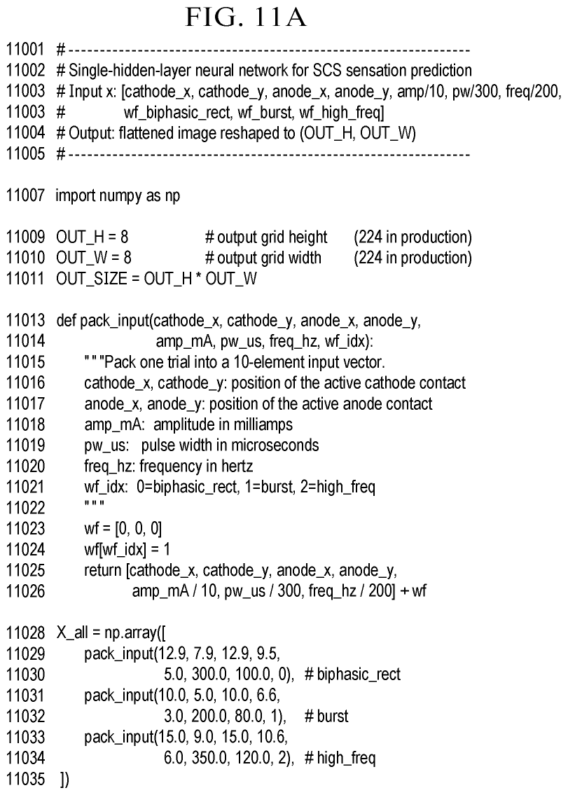

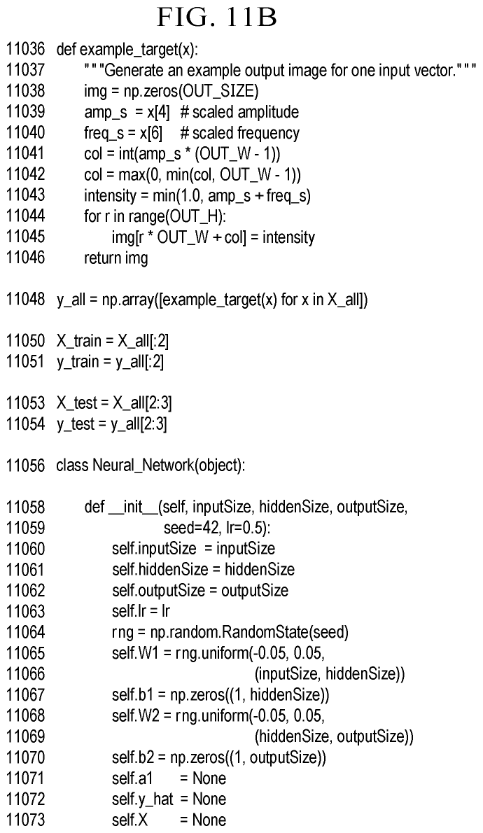

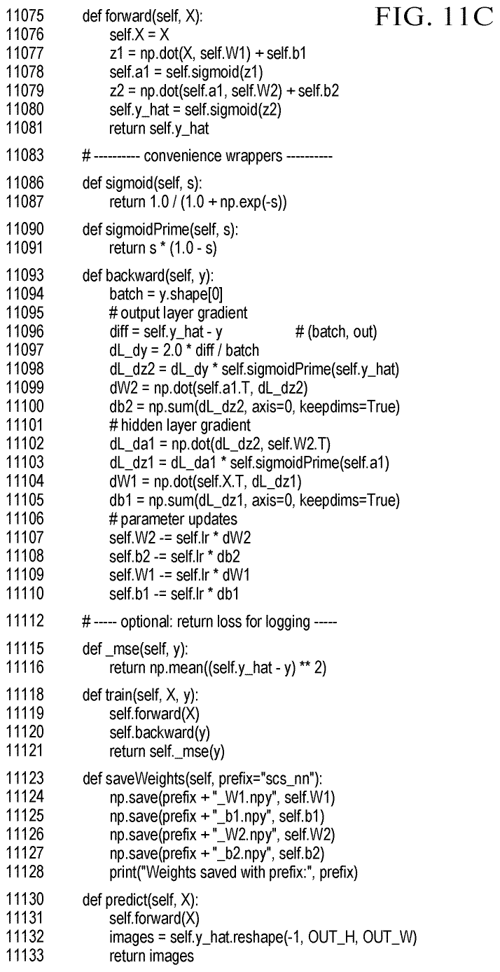

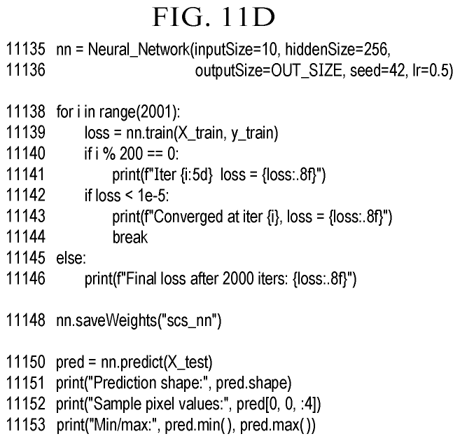

Referring to FIGS. 11A-11D, an example of Python code which instantiates and trains a preferred single-hidden-layer neural network of the system will be further described.

At lines 11001-11005, the code provides a heading that identifies the network's purpose, input composition, and output form. In particular, the comments specify that the input vector comprises ten elements (implant summary and scaled stimulation settings including a three-way waveform code) and that the code emits a flattened image later reshaped to an output grid.

At line 11007, the code imports the NumPy library to provide numerical array operations used throughout initialization, forward propagation, loss computation, and gradient updates.

At lines 11009-11011, the code declares constants defining the output grid size. OUT_H and OUT_W are set to exemplary values of 8 by 8 for demonstration, and OUT SIZE computes the total number of output pixels. In practice, these constants are set to 224 by 224 for the production embodiment.

At lines 11013-11026, the function pack_input is defined. This function receives trial-level numerical values (cathode_x, cathode_y, anode_x, anode_y, amplitude in milliamps, pulse width in microseconds, frequency in hertz, and a waveform index) and returns a ten-element input vector. The routine performs fixed, unit-normalizing scalings (amplitude/10, pulse width/300, frequency/200) and converts the waveform index to a one-hot three-element indicator to ensure a stable, dimensionally consistent representation.

At lines 11028-11034, the code constructs an example set of three input trials by stacking three calls to pack_input. This establishes representative training and test inputs without loss of generality and may be replaced with actual clinical trial vectors in deployment.

At lines 11036-11047, the function example_target is defined to generate an example output image for each input vector. The function creates a zero-initialized image of the declared output size and writes a vertical stripe whose intensity is a simple, bounded function of the scaled amplitude and frequency elements. In production use, this function is replaced by the standardized target images prepared elsewhere in the pipeline and flattened to OUT SIZE elements.

At line 11048, the code maps example_target over the input set to produce y_all, a two-dimensional array whose rows are flattened output images in the [0,1] interval.

At lines 11050-11054, the dataset is partitioned. The first two rows of X all and y_all form the training subset, while the final row is reserved as a held-out example to demonstrate prediction and loss calculation after training.

At lines 11056-11134, the class Neural Network is declared. This class encapsulates parameter initialization, forward propagation, backpropagation, weight updates, weight persistence, and prediction reshaping.

At lines 11058-11073, the constructor (init) establishes network dimensions and learning rate, seeds a pseudo-random number generator for reproducibility, and initializes the learnable parameters. Specifically, W1 is a matrix of shape (inputSize×hiddenSize) with small random entries drawn from a uniform distribution between −0.05 and 0.05, b1 is a row vector of zeros of length hiddenSize, W2 is a matrix of shape (hiddenSize×outputSize) with small random entries, and b2 is a row vector of zeros of length outputSize. These constitute the complete set of trainable weights and biases corresponding to the two affine transformations used by the network.

At lines 11075-11084, the forward method performs inference. First, an affine transformation followed by a sigmoid nonlinearity maps the batch of inputs to the hidden layer. Second, another affine transformation followed by a sigmoid maps the hidden activations to flattened outputs. The use of sigmoid at the output ensures values lie in the [0,1] interval, which matches the target image scale.

At lines 11086-11088, the sigmoid activation function is defined for reuse in both hidden and output layers.

At lines 11090-11092, the derivative of the sigmoid function, expressed in terms of an already-evaluated sigmoid output, is provided. This facilitates efficient gradient computation during backpropagation.

At lines 11093-11111, the backward method implements gradient-based learning via backpropagation. The routine first computes the gradient of the mean-squared-error loss with respect to the network outputs on a per-batch basis. It then propagates gradients through the output sigmoid, accumulates the corresponding parameter gradients for W₂ and b₂, and continues propagation into the hidden layer by multiplying with

$${W}_{2}^{T} .$$

After applying the hidden-layer sigmoid derivative, the routine accumulates gradients for W₁ and b₁. Finally, the parameters W₂, b₂, W₁, and b₁ are updated by subtracting learning-rate-scaled gradients, thereby completing one optimization step.

At lines 11117-11122, the train method composes the forward and backward procedures into a single training step and returns the mean-squared-error value for logging or early-stopping purposes.

At lines 11123-11129, the saveWeights method persists the learned parameters to NumPy binary files (.npy format). This enables later reuse, audit, or deployment without retraining.

At lines 11130-11134, the predict method performs a forward pass and reshapes the flattened outputs into images of size OUT_H by OUT_W for convenience in downstream processing or visualization.

At lines 11135-11146, an instance of Neural_Network is created with specified dimensions (inputSize=10, hiddenSize=256, outputSize=OUT_SIZE), seed, and learning rate. A simple training loop then iteratively invokes train on the small training subset, prints periodic loss summaries every 200 iterations, and provides an early-termination condition when the loss falls below a small threshold (for example, 1×10⁻⁵).

At lines 11147-11149, the learned weights and biases are saved to disk using the saveWeights method, thereby recording the trained state of the network.

At lines 11150-11153, the code performs prediction on the held-out example. The outputs are returned in reshaped image form, and representative pixel values are printed to confirm numeric range and behavior.

### Second Embodiment

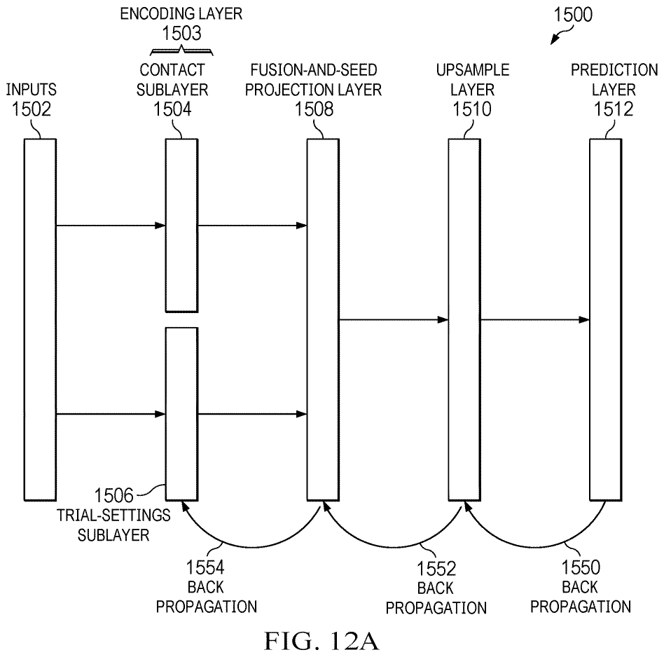

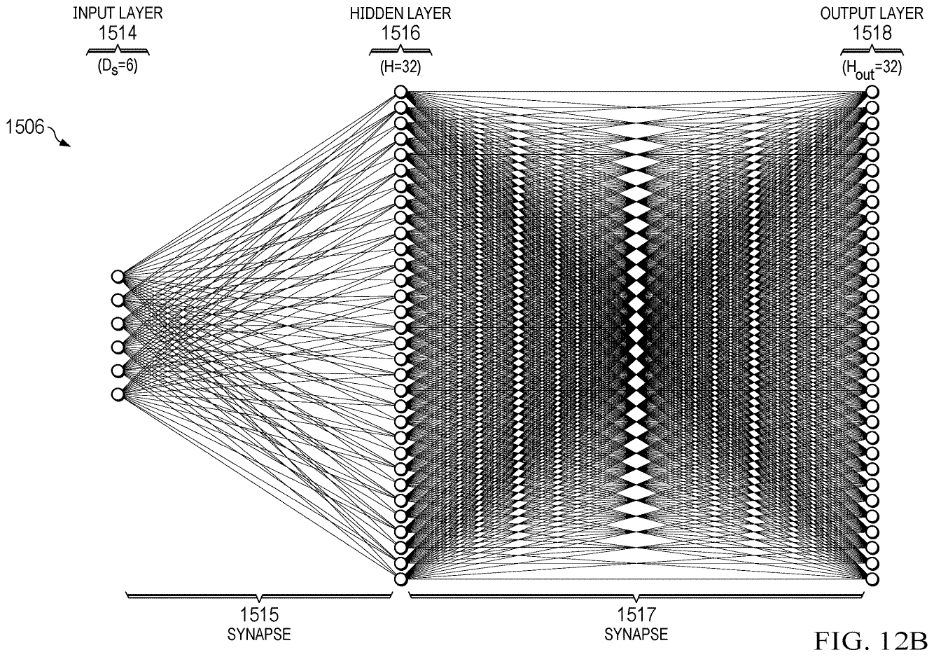

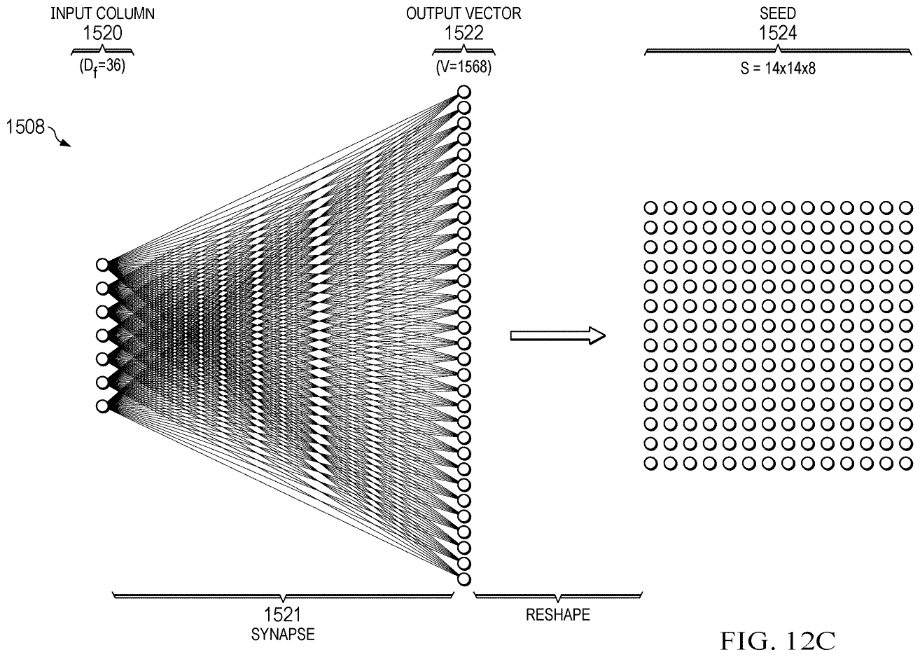

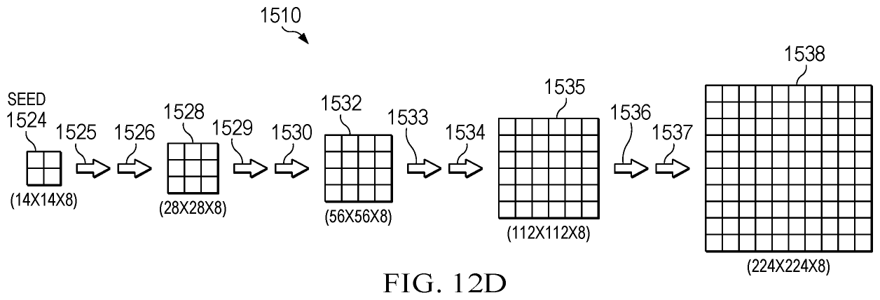

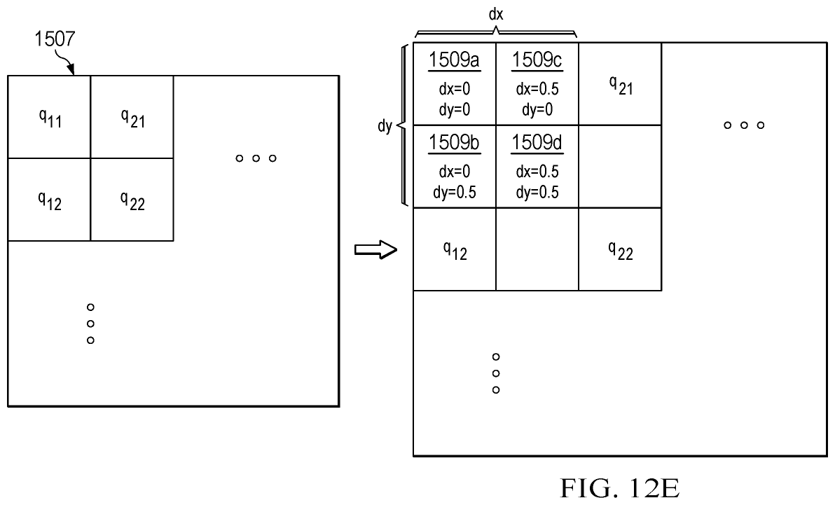

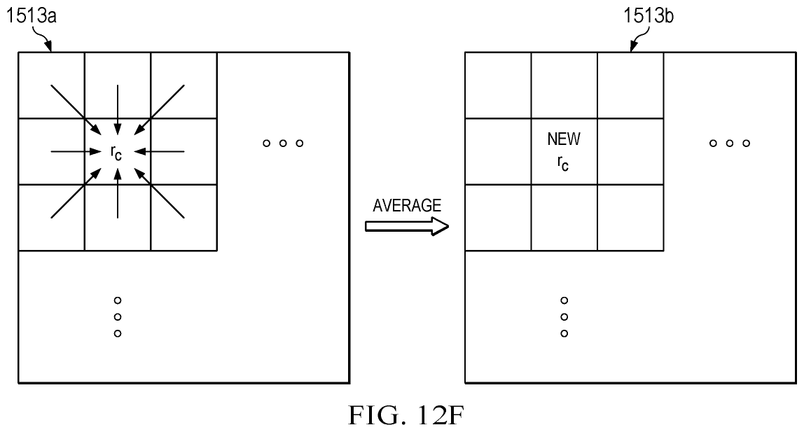

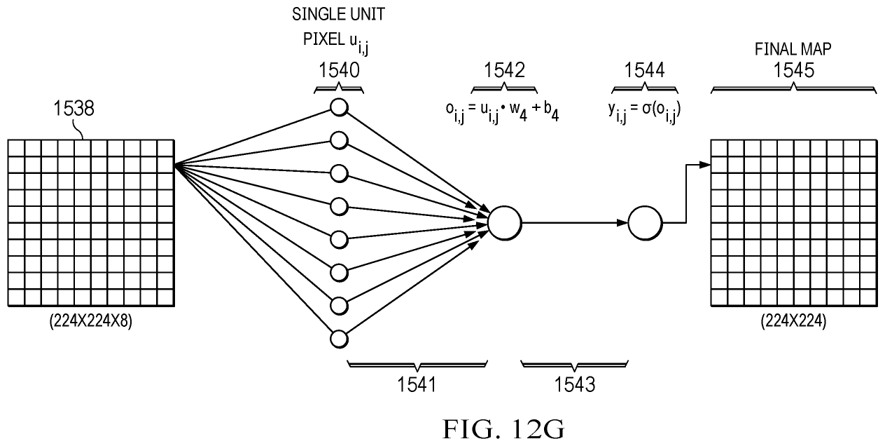

Referring to FIG. 12A, a preferred embodiment of a five-layer network 1500 for predicting a two-dimensional sensation map will be further described.

Network 1500 solves a practical problem: different patients have different electrode configurations with varying numbers of contacts in different positions, yet the system must always produce the same 224×224 pixel sensation map as output. Network 1500 accomplishes this by first condensing the variable-length contact information into a fixed-length summary, combining that summary with the stimulation settings, and then progressively building up the output image from a small starter grid.

Network 1500 is arranged as an input layer 1502, two parallel encoding sublayers, contract-rows sublayer 1504 and trial-settings sublayer 1506, a fusion-and-seed projection layer 1508, an upsampling layer 1510, and a prediction layer 1512. Other arrangements and sizes of layers may be used in other embodiments.

Input layer 1502 receives, for one trial, two streams of information and sends them to the downstream layers. A first stream comprises contact rows-per-contact descriptors (for example, two-dimensional contact positions, the is_tip flag indicating whether a contact is at the lead tip, and a polarity value indicating whether the contact is a cathode, anode, or inactive) taken from the standardized record for the trial. A second stream comprises the trial settings, including amplitude, pulse width, frequency, and a three-way waveform code carried as one-hot indicators, each optionally scaled to a compact numeric range. Input layer 1502 routes these two streams separately, one to contact-rows sublayer 1504 and the other to trial-settings sublayer 1506. No learnable parameters are required in this layer.

Encoding layer 1503 comprises contact-rows sublayer 1504 and trial-settings sublayer 1506.

Contact-rows sublayer 1504 reduces the set of contacts into a fixed-length implant summary vector. This reduction is necessary because different patients may have different numbers of electrode contacts (for example, 8, 16, or 32), but the downstream layers require a consistent input size. In one preferred embodiment, contact-rows sublayer 1504 scans the contact rows for all contacts marked as active cathodes (polarity +1) and all contacts marked as active anodes (polarity −1), skipping any contacts marked inactive (polarity 0). The function accumulates the x- and y-positions within each group and divides by the count to obtain the cathode centroid and the anode centroid; when only one cathode and one anode are present, the centroids reduce to the positions of those individual contacts. The output of contact-rows sublayer 1504 is therefore a short vector of length four (cathode_x, cathode_y, anode_x, anode_y) that captures where the driving contacts lie in the plane. Because the output is always four numbers regardless of how many contacts are present or what order they are listed in, the downstream layers receive a consistent input size. This output is forwarded directly to fusion-and-seed projection layer 1508. In another embodiment, the implant summary additionally includes the mean position of all contacts, the fraction of contacts located at the lead tip, or per-contact polarity values, and the vector length is increased accordingly.

Trial-settings sublayer 1506 converts the raw stimulation settings into a compact settings vector. This conversion allows the network to discover on its own which combinations of amplitude, pulse width, frequency, and waveform shape matter most for predicting sensation. In a preferred embodiment, trial-settings sublayer 1506 comprises two small fully connected stages with a Rectified Linear Unit (ReLU) activation function between them. The ReLU activation function is defined as ReLU (z)=max (0, z), which outputs the input value if positive and zero otherwise; this simple nonlinearity allows the network to model relationships that are not purely linear. The first stage maps the scaled settings to an intermediate width; the second stage maps the result to a fixed-length settings embedding. Bias terms are included in each stage, and the weights and biases of trial-settings sublayer 1506 are learned during training. The output of trial-settings sublayer 1506 is the settings embedding vector, which is forwarded to fusion-and-seed projection layer 1508.

Fusion-and-seed projection layer 1508 receives, as separate inputs, the implant summary vector from contact-rows sublayer 1504 and the settings embedding from trial-settings sublayer 1506. Layer 1508 joins these vectors end-to-end and then multiplies by a learned weight matrix to produce enough numbers to fill a small starter grid. In one preferred embodiment, the starter grid has dimensions 14×14, and each pixel (grid location) holds 8 numbers (called channels). Having multiple numbers per pixel allows the network to store richer information at each location than a single number would permit. During training, the network learns what values to place in each channel to produce accurate predictions; the meaning of each channel emerges from the training process rather than being assigned by a programmer. The total size is 14×14×8=1,568 values. This starter grid, called the seed image, is much smaller than the final 224×224 output but contains the essential information needed to grow the full prediction. This layer contains learnable weights and biases and combines the contact summary and settings into a small starter image that will be enlarged to make the final prediction.

Upsampling layer 1510 enlarges the seed image to the final output size (for example, 224×224) without adding learnable parameters. In a preferred embodiment, layer 1510 performs channel-wise bilinear interpolation in four doubling stages (14→28→56→112→224), filling in intermediate pixel values smoothly to preserve contours and avoid blocky artifacts. The result is a full-resolution feature map with the same 8 channels produced by layer 1508.

Prediction layer 1512 converts the multi-channel full-resolution feature map into a single-channel sensation image bounded between 0 and 1. In a preferred embodiment, layer 1512 applies a shared linear combination of channels at each pixel using a learned weight vector and bias, followed by a logistic (sigmoid) squashing function. The shared weight vector and bias are learned during training. The output of layer 1512 is the predicted sensation map for the trial, ready for display or further processing.

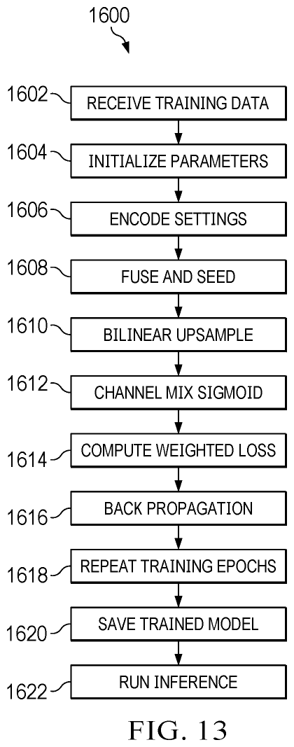

In operation, input layer 1502 presents contact rows and trial settings in parallel; contact-rows sublayer 1504 reduces the contact set to a four-number implant summary; trial-settings sublayer 1506 converts raw controls into a compact settings vector; fusion-and-seed projection layer 1508 combines both summaries and produces a small 14×14 starter image; upsampling layer 1510 enlarges the starter image to full 224×224 size; and prediction layer 1512 produces the bounded output image. Layers 1506, 1508, and 1512 contain learnable parameters; layers 1502, 1504, and 1510 do not. During training, error signals flow backward through the network as indicated by arrows 1550, 1552, and 1554. Arrow 1550 carries the prediction error from layer 1512 back through upsampling layer 1510. Arrow 1552 carries the error from layer 1510 back through fusion-and-seed projection layer 1508. Arrow 1554 carries the error from layer 1508 back through trial-settings sublayer 1506. These backward error signals are used to compute gradients for updating the learnable weights as described with reference to method 1600 (FIG. 13).

Referring to FIG. 12B, trial-settings sublayer 1506 will be further described. Trial-settings sublayer 1506 is a two-layer perceptron that converts raw trial settings into a fixed-length settings embedding. Trial-settings sublayer 1506 is arranged as input layer 1514, hidden layer 1516, and output layer 1518, with weighted interconnections identified as synapses 1515 (between layers 1514 and 1516) and synapses 1517 (between layers 1516 and 1518).

Input layer 1514 receives a settings vector s′ of length Ds. In a preferred embodiment, s′ contains the scaled stimulation controls for one trial, for example s′= [amplitude/10, pulse_width/300, frequency/200, wf_biphasic_rect, wf_burst, wf_high_freq], giving Dₛ=6. Input layer 1514 performs no computation and presents s′ to synapses 1515. In another embodiment, the settings vector is expanded to include additional waveform paradigm indicators such as differential target multiplexed stimulation, passive recharge, asymmetric biphasic, and subthreshold conditioning prepulse stimulation, and Dₛ is increased accordingly. In another embodiment, the settings vector is expanded to include per-contact polarity values indicating cathode, anode, or inactive status for each contact, and Dₛ is increased accordingly.

Synapses 1515 implement the first affine transform with bias, followed by a nonlinearity at hidden layer 1516. The hidden computation is:

$$tmp = ReLU ( {s}^{′} \cdot {W}_{s 1} + {b}_{s 1} )$$

Where:
Wₛₗ is the weight matrix from input layer 1514 to hidden layer 1516 with shape (Dₛ×H);
bₛₗ is the bias added at hidden layer 1516 with shape (1×H);
H is the hidden width (for example, H=32), and
ReLU is the Rectified Linear Unit function that outputs max (0, z) for each element.

Hidden layer 1516 therefore holds the length-H vector tmp, which combines the settings into useful features while zeroing out negative values. Hidden layer 1516 forwards tmp to synapses 1517.

Synapses 1517 implement the second affine transform with bias that maps the hidden vector to the final embedding at output layer 1518. The output computation is:

$$embed = tmp \cdot {W}_{s 2} + {b}_{s 2}$$

Where:
Wₛ₂ is the weight matrix from hidden layer 1516 to output layer 1518 with shape (H×Hₒᵤₜ);
bₛ₂ is the bias added at output layer 1518 with shape (1×Hₒᵤₜ); and
Hₒᵤₜ is the embedding length (for example, Hₒᵤₜ=32).

Output layer 1518 therefore emits a fixed-length vector embed that serves as the settings embedding for the trial. In network 1500, this embed vector is provided as one input to fusion-and-seed projection layer 1508, where it is concatenated with the implant summary produced by contact-rows sublayer 1504.

Parameter sizes in one preferred embodiment are: Dₛ=6, H=32, and Hₒᵤₜ=32. With these sizes, Wₛ₁ has shape (6×32), bₛ₁ has length 32, Wₛ₂ has shape (32×32), and bₛ₂ has length 32. Synapses 1515 correspond structurally to the entries of Wₛ₁ and bₛ₁; synapses 1517 correspond structurally to the entries of Wₛ₂ and bₛ₂. All four parameter sets are learned during training as described with reference to method 1600.

Referring to FIG. 12C, fusion-and-seed projection layer 1508 will be further described. Layer 1508 takes two short vectors—the four-number implant summary and the 32-number settings embedding—and produces a small 14×14 starter image with 8 values per pixel. Layer 1508 comprises concatenated input column 1520, fully connected synapses 1521, flattened output vector 1522, and reshaped seed image 1524.

Input column 1520 receives a fused vector f formed by joining the implant summary (from contact-rows sublayer 1504) with the settings embedding (from trial-settings sublayer 1506):

$$f = concat ( g , embed )$$

Where:
g is the implant summary vector with length D_{g} (for example, D_{g}=4 for cathode_x, cathode_y, anode_x, and anode_y);
embed is the settings embedding with length Hout (for example, Hₒᵤₜ=32), and
f has length D_{f}=D_{g}+Hₒᵤₜ (for example, D_{f}=36).

Synapses 1521 multiply the 36-number fused vector by a learned weight matrix to produce 1,568 numbers—enough to fill a 14×14 grid with 8 values per pixel:

$$v = f \cdot {W}_{f} + {b}_{f}$$

Where:
W_{f} is the weight matrix with shape (D_{f}×V);
b_{f} is the bias vector with length V;
C is the number of values per pixel (for example, C=8);
V=14×14×C=1,568 is the total number of values in the starter grid; and
v is the resulting flat list of 1,568 numbers.

Flattened output vector 1522 is the flat list of 1,568 values produced by the multiplication. It is a one-dimensional vector whose length equals V=14×14×C. In the preferred embodiment with C=8, vector 1522 has 1,568 elements.

Seed image 1524 is produced by reshaping the flat vector v into a three-dimensional tensor with height 14, width 14, and C channels:

$$S = reshape ( v , [ 14 , 14 , C ] )$$

Where:
S is the seed image.

In the preferred embodiment with C=8, seed image 1524 is a 14×14 grid in which each pixel (grid location) holds eight real-valued features. The ordering is deterministic in row-major form: the first C entries of v populate the top-left pixel, the next C entries populate the pixel to its right, continuing across the first row and then proceeding row by row. The eight values at each pixel do not have pre-assigned meanings; during training, the network learns what patterns to store in each channel based on what helps it make accurate predictions. This learned representation allows the network to adapt to different electrode configurations without requiring hand-coded rules for each lead type. The size of seed image 1524 is always 14×14×8 regardless of how many contacts the patient has, which provides a consistent input to upsampling layer 1510.

Referring to FIG. 12D, upsampling layer 1510 will be further described. Upsampling layer 1510 enlarges seed image 1524 from a 14×14×C tensor to a full-resolution feature map of size 224×224×C by a sequence of four factor-two bilinear resizes, each immediately followed by a per-channel smoothing pass. In operation, seed image 1524 is doubled at step 1525 and is then smoothed at step 1526, to produce seed map 1528 (28×28×C). Seed map 1528 is doubled again at step 1529 and is then smoothed at step 1530, to produce seed map 1532 (56×56×C). The result is doubled at step 1533, and is then smoothed as indicated by arrow 1534, to produce seed map 1535 (112×112×C). Seed map 1535 is doubled once more at step 1536 and is then smoothed at step 1537 to produce seed map 1538 (224×224×C). All resizes and smooths operate independently on each channel; in the preferred embodiment C=8. The output of the last smoothing pass is a full-resolution feature map that is forwarded to prediction layer 1512. No learnable parameters are introduced in this layer.

Referring to FIG. 12E, the bilinear resizing steps will be further described. FIG. 12E illustrates how a single resize is computed for one channel at one output location. When the image is doubled in size, new pixels must be created between the original pixels. Each new pixel's value is computed by blending the four nearest original pixels, with closer pixels contributing more to the blend. Four source neighbors within a cell 1507 are identified as q₁₁ (top-left), q₂₁ (top-right), q₁₂ (bottom-left), and q₂₂ (bottom-right). Target points 1509a, 1509b, 1509c, and 1509d lie inside that cell at fractional offsets dx from the left edge and dy from the top edge. The blended value is:

$$P = ( 1 - ds ) \cdot ( 1 - dy ) \cdot {q}_{11} + dx \cdot ( 1 - dy ) \cdot {q}_{21} + ( 1 - dx ) \cdot dy \cdot {q}_{12} + dx \cdot dy \cdot {q}_{22}$$

Where:
dx and dy are the fractional offsets (0-1) from the top-left corner of the source cell.

In the special case of 2× upscaling, the target pixel always lands either exactly on a source corner or at the midpoint between corners, so the fractional offsets dx and dy are either 0 (aligned) or 0.5 (mid-cell).

Referring to FIG. 12F, the smoothing steps will be further described. FIG. 12F illustrates the per-channel smoothing (averaging) that follows each resize step. A 3×3 window 1513a centered at a pixel replaces that pixel with the mean of the values in the window 1513b:

$${new}_{r} ( i , j ) = ( \frac{1}{9} ) \cdot {\sum }_{m} {\sum }_{n} r ( i + m , j + n )$$

Where:
m and n range from −1 to +1.

In each smoothing pass, the 3×3 window is applied independently to every pixel location of each channel moving left to right, top to bottom. In each case, the center pixel is replaced by the average of the values in its local 3×3 neighborhood. At the edges of the image where the window extends beyond the boundary, the out-of-bounds positions are handled by clamping to the nearest valid pixel (replicating the edge values). This smoothing reduces abrupt changes in value (visual blockiness) that can appear after interpolation.

Referring to FIG. 12G, prediction layer 1512 will be further described. A single pixel's inputs are depicted as input pixel column 1540. For each location (i, j) in the feature map produced by upsampling layer 1510, column 1540 holds the C-value vector u_{i,j} taken from the tensor. Synapses 1541 indicate that these C values are each multiplied by a corresponding learned weight and summed together with a learned bias inside linear mixing unit 1542. The pre-activation (logit) scalar for that pixel is therefore:

$${o}_{i , j} = {u}_{i , j} \cdot {w}_{4} + {b}_{4}$$

Where:
u_{i,j} is the C-channel vector at pixel (i, j) from the upsampled feature map;
w₄ is the learned per-channel weight vector with length C shared by all pixels;
b₄ is the learned bias shared by all pixels; and
O_{i,j} is the pre-activation value at pixel (i, j).

Arrow 1543 indicates application of a pointwise sigmoid to convert each pre-activation into a bounded prediction. The output at output pixel 1544 is:

$${y}_{i , j} = σ ( {o}_{i , j} ) = \frac{1}{1 + {e}^{- o ( i , j )}}$$

Where:
y_{i,j} is the final per-pixel value used as the predicted map intensity at location (i, j).

The same w₄ and b₄ are applied at every pixel across the field, so prediction layer 1512 introduces only C+1 learnable parameters in this embodiment (C weights and one bias, for example 9 parameters when C=8) and performs a per-pixel linear mix followed by a sigmoid. Applied across all pixels, a single-channel map of those values forms final map 1545.

The five-layer architecture of neural network 1500 is not a mere design choice. Rather, it is important because it enables the network to learn more complex spatial relationships while maintaining output quality at high resolution. The architecture takes advantage of the fact that sensation patterns are spatially smooth rather than sharp-edged. Rather than learning 50,176 independent pixel values, the network learns a coarse 14×14 pattern and enlarges it through interpolation, with smoothing at each stage to ensure the output resembles a natural sensation distribution. Encoding electrode geometry and stimulation settings through separate pathways before fusion allows each pathway to normalize its inputs independently, since contact positions measured in millimeters require different scaling than pulse widths measured in microseconds. The trained five-layer neural network encodes paresthesia data from the training trials into the linear transformations, serving as a compressed repository from which predicted sensation patterns are retrievable given new electrode contact positions and stimulation settings. In this embodiment, the compressed repository is formed by the learned weights of the linear transformations, including fusion layer 1508, where contact geometry and settings embeddings are mixed to create the seed. During this mixing step, the trained weights combine inputs in ways that a human cannot track mentally, and the meaning of each channel in the seed emerges from the training process rather than being assigned by a programmer.

Referring to FIG. 13, a flow chart of method 1600 for training the five-layer network 1500 will be further described.

At step 1602, training data are received. Each example provides: (i) a short implant summary (for example, cathode_x, cathode_y, anode_x, and anode_y) as described with reference to contact-rows sublayer 1504, (ii) a settings vector with scaled amplitude, pulse width, frequency, and a three-way waveform code, (iii) a target image on a fixed grid such as 224×224 with values between 0 and 1, and (iv) optionally, a same-size per-pixel weight image W indicating how much to rely on each pixel during training.

At step 1604, trainable parameters are initialized. In a preferred embodiment, each weight is initialized to a uniform random value between −0.05 and 0.05, and each bias is initialized to zero. Parameters are created for three components that learn: the two-layer settings encoder (Wₛ₁, bₛ₁, Wₛ₂, bₛ₂) as described with reference to trial-settings sublayer 1506 (FIG. 12B), the fusion projection (W_{f}, b_{f}) as described with reference to layer 1508 (FIG. 12C), and the final per-pixel mixing stage (w₄, b₄) as described with reference to layer 1512 (FIG. 12G). The upsampling layer has no learnable parameters.

At step 1606, the settings are encoded as described with reference to trial-settings sublayer 1506 (FIG. 12B). The scaled controls pass through two fully connected layers with a ReLU nonlinearity between them, producing the settings embedding vector.

At step 1608, the seed image is produced as described with reference to layer 1508 (FIG. 12C). The implant summary and settings embedding are concatenated and passed through a learned linear projection, then reshaped into the 14×14×C seed image.

At step 1610, the seed is enlarged as described with reference to layer 1510 (FIGS. 12D-12F). Four factor-two bilinear doublings with smoothing expand the seed to 224×224 per channel. No learnable parameters are introduced in this stage.

At step 1612, the prediction is produced as described with reference to layer 1512 (FIG. 12G). A shared linear combination of the C channels at each pixel, followed by a sigmoid, produces the bounded 224×224 sensation map.

At step 1614, a weighted loss is computed. The prediction Y is compared to the target image T on a per-pixel basis using weighted mean-squared error:

$$L = {\sum }_{i} {\sum }_{j} W ( i , j ) \cdot \frac{{( \hat{y} ( i , j ) - t ( i , j ) )}^{2}}{{\sum }_{i} {\sum }_{j} W ( i , j )}$$

Where:
W(i, j) is the weight at pixel (i,j);
ŷ(i, j) is the predicted value;
t(i, j) is the target value, and the summations are taken over all pixels.

If a weight image W is provided, pixels with higher W values contribute more to the loss. If no weight image is provided, all pixels are treated equally (W is all-ones, and the formula reduces to standard mean-squared error). This allows the network to learn mainly from reliable regions.

At step 1616, gradients are computed by backpropagation, proceeding from the output layer backward through each layer to accumulate parameter gradients. The derivative of the sigmoid function is σ′(o)=σ(0)·(1−(o))=y·(1−y), and the derivative of the ReLU function is ReLU′(z)=1 if z>0 and ReLU′(z)=0 otherwise.

The output error at prediction layer 1512 is computed as:

$${Δ}_{out} ( i , j ) = \frac{2 \cdot W ( i , j )}{\sum W} \cdot ( \hat{y} ( i , j ) - t ( i , j ) ) \cdot \hat{y} ( i , j ) \cdot ( 1 - \hat{y} ( i , j ) )$$

Where:
the first term

$$\frac{2 \cdot W ( i , j )}{\sum W}$$

is the derivative of the weighted MSE loss with respect to the prediction;
(ŷ(i,j)−t(i,j)) is the prediction error; and
ŷ(i,j)·(1−ŷ(i,j)) is the sigmoid derivative.

The gradients for the prediction layer parameters are:

$$\frac{\partial L}{\partial {w}_{4}} = {\sum }_{i} {\sum }_{j} {Δ}_{out} ( i , j ) \cdot u ( i , j )$$

$$\frac{\partial L}{\partial {b}_{4}} = {\sum }_{i} {\sum }_{j} {Δ}_{out} ( i , j )$$

Where:
u(i,j) is the C-channel feature vector at pixel (i,j) from the upsampled feature map.

The error is then propagated backward through prediction layer 1512 to the upsampled feature map:

$${Δ}_{up} ( i , j ) = {Δ}_{out} ( i , j ) \cdot {w}_{4}$$

Where:
Δᵤₚ(i, j) is a C-channel error vector at each pixel.

Upsampling layer 1510 has no learnable parameters, but gradients must flow through it to reach the seed. Because bilinear interpolation is a linear operation, the gradient with respect to each seed pixel is the weighted sum of the gradients from the output pixels that used it during interpolation, with the same bilinear weights used in the forward pass. The smoothing operation similarly propagates gradients by distributing each output gradient equally among the nine input pixels that contributed to it. The result is Δ_{seed}, a 14×14×C tensor of error values.

The error is propagated backward through fusion-and-seed projection layer 1508. The gradients for the fusion projection parameters are:

$$\frac{\partial L}{\partial {W}_{f}} = {f}^{T} \cdot flatten ( {Δ}_{seed} )$$

$$\frac{\partial L}{\partial {b}_{f}} = flatten ( {Δ}_{seed} )$$

Where:
f is the fused input vector; and
flatten(Δ_{seed}) converts the 14×14×C error tensor to a 1,568-element vector.

The error propagated to the fused vector f is:

$${Δ}_{f} = flatten ( {Δ}_{seed} ) \cdot {W}_{f}^{T}$$

This error vector Δ_{f} has length D_{f}=36. The first 4 elements correspond to the implant summary g (which has no learnable parameters and requires no further gradient computation), and the remaining 32 elements correspond to the settings embedding and are denoted Δ_{embed}.

The error is propagated backward through trial-settings sublayer 1506. The gradients for the second stage are:

$$\frac{\partial L}{\partial {W}_{s 2}} = {tmp}^{T} \cdot ( {Δ}_{embed} )$$

$$\frac{\partial L}{\partial {b}_{s 2}} = {Δ}_{embed}$$

Where:
tmp is the hidden layer activation from the forward pass.

The error propagated to the hidden layer is:

$${Δ}_{tmp} = {Δ}_{embed} \cdot {W}_{s 2}^{T}$$

The ReLU derivative is then applied element-wise:

$${Δ}_{hiddent} = {Δ}_{tmp} ⊙ Re {LU}^{′} ( {s}^{′} \cdot {W}_{s 1} + {b}_{s 1} )$$

Where:
ReLU′ returns 1 for positions where the pre-activation was positive during the forward pass and 0 otherwise; and
⊙ denotes element-wise multiplication.

The gradients for the first stage of the settings encoder are:

$$\frac{\partial L}{\partial {W}_{s 1}} = {s}^{′ T} \cdot {Δ}_{hidden}$$

$$\frac{\partial L}{\partial {b}_{s 1}} = {Δ}_{hidden}$$

Where:
s′ is the input settings vector.

After all gradients are computed, parameters are updated by gradient descent.

For each parameter set θ in {Wₛ₁, bₛ₁, Wₛ₂, bₛ₂, W_{f}, b_{f}, W₄, b₄}:

$$θ ← θ - η \cdot \frac{\partial L}{\partial θ}$$

Where:
η is the learning rate (for example, n=0.001).

The input layer 1502, contact-rows sublayer 1504, and upsampling layer 1510 have no learnable parameters and therefore receive no updates.

In a preferred embodiment, training examples are grouped into batches of size B (for example, B=32). Processing examples in batches rather than one at a time improves computational efficiency and stabilizes gradient estimates by averaging across multiple examples. If the training set contains 960 examples and the batch size is 32, this produces 30 batches. An epoch is one complete pass through all training examples, during which each batch is processed once and the weights are updated once per batch. Training typically continues for multiple epochs (for example, 50 to 200 epochs), allowing the network to see each example many times and make incremental improvements with each pass. For example, training for 100 epochs with 30 batches per epoch results in 3,000 total weight updates.

At step 1618, training repeats over multiple epochs. The data are processed in mini-batches for a fixed number of passes through the training set. Progress can be monitored with training and validation loss. In one embodiment, training stops after a maximum epoch count is reached (for example, 200 epochs). In another embodiment, training stops due to insufficient improvement, which occurs when the validation loss fails to decrease by more than a threshold amount (for example, 0.0001) for a specified number of consecutive epochs (for example, 10 epochs); this technique is known as early stopping and helps prevent overfitting, which is the condition where the network memorizes the training data rather than learning generalizable patterns.

At step 1620, the trained network is saved. The learned parameters (Wₛ₁, bₛ₁, Wₛ₂, bₛ₂, W_{f}, b_{f}, W₄, b₄), the seed and output grid specifications (14×14 seed, 224×224 output), and key training metadata (learning rate, random seed, epoch count) are stored in non-transitory computer-readable media.

At step 1622, inference is performed for new trials. Given a new implant summary g and settings vector s′, the forward path-encode settings, fuse and seed, bilinear upsample, and channel mix with sigmoid-produces a bounded 224×224 sensation map ready for downstream processing.

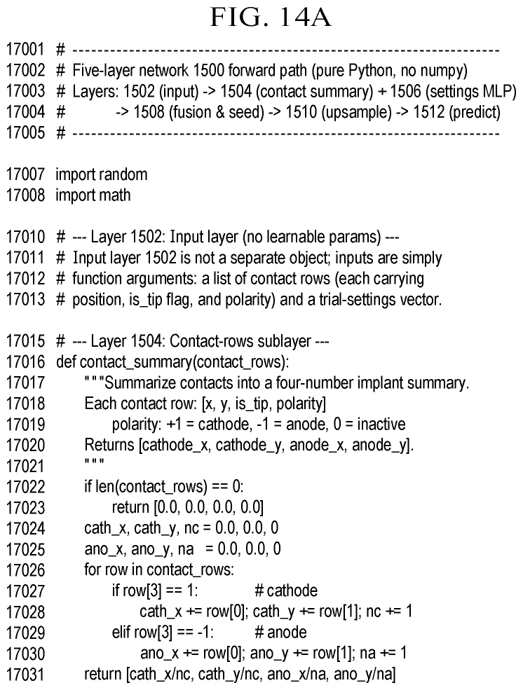

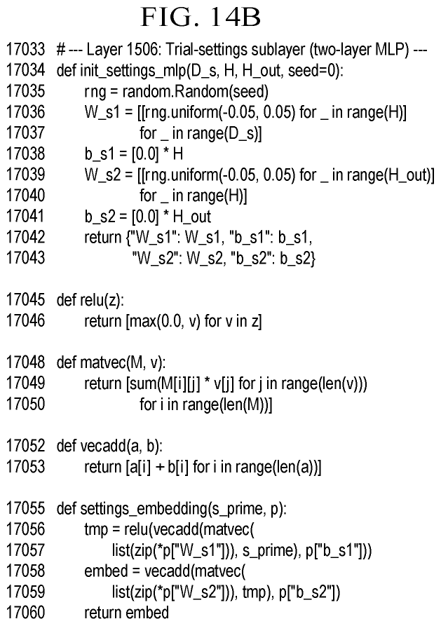

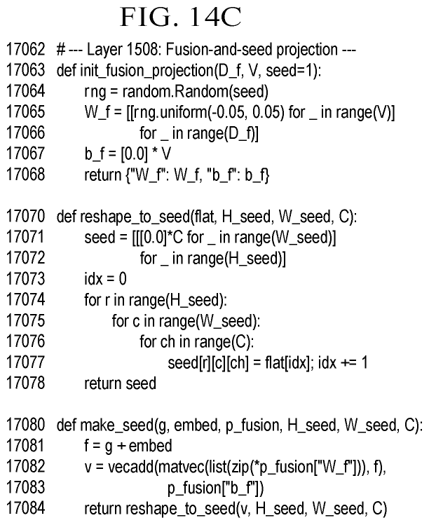

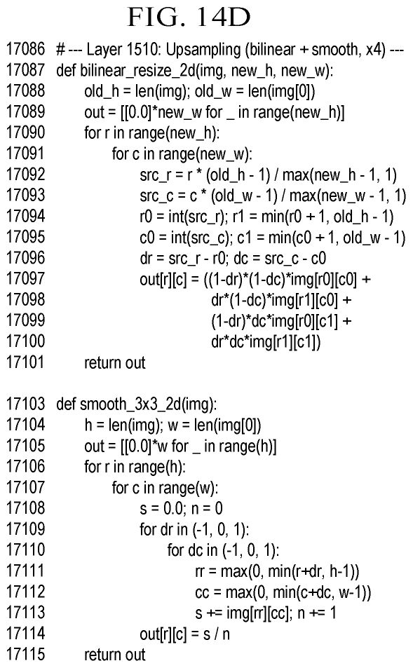

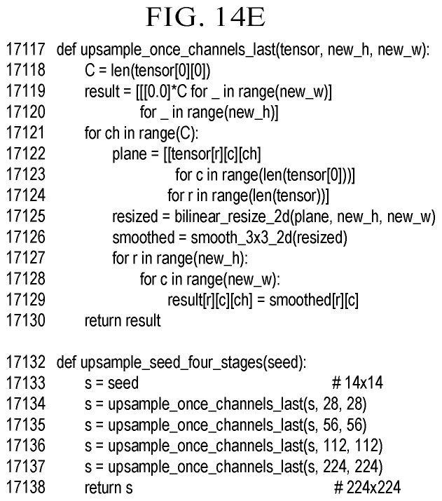

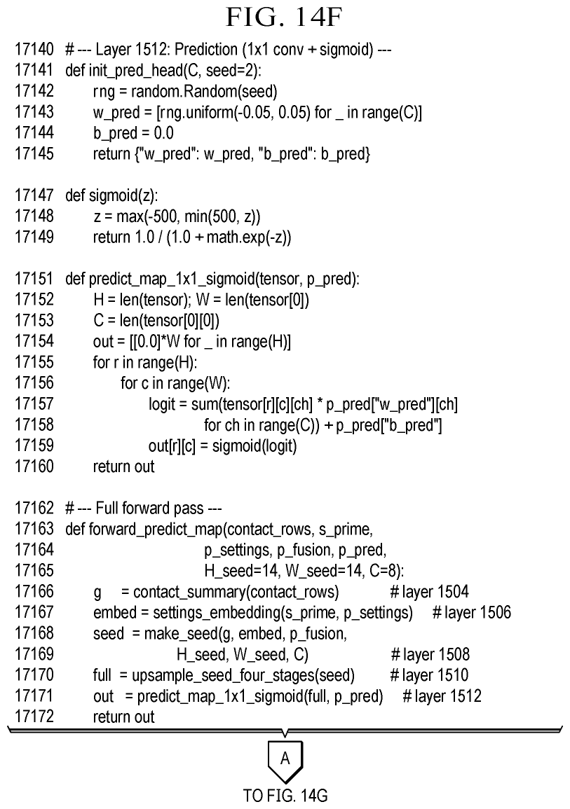

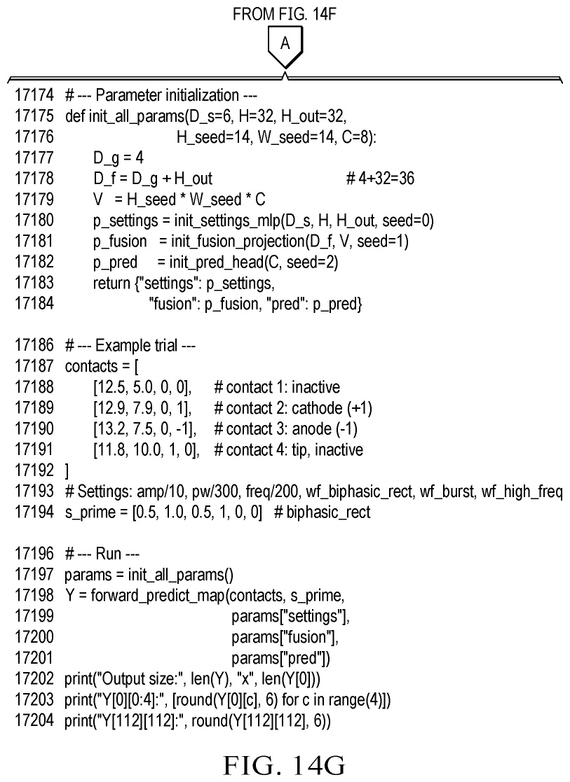

Referring to FIGS. 14A-14F, an example of Python code which implements the five-layer neural network 1500 will be further described. The code implements the forward pass (inference) for network 1500; training is performed using the backpropagation procedure described with reference to method 1600 (FIG. 13).

At lines 17001-17008, the code declares its purpose and imports two standard modules. The header comment states that the script implements a six-stage forward path, and the imports (random and math) provide small random initializations and basic math operations used later.

At lines 17010-17013, the script notes that input layer 1502 is not a separate object; instead, inputs are simply function arguments: a list of contact rows (each carrying position, is_tip flag, and polarity) and a single trial-settings vector.

At lines 17015-17031, the function contact_summary is defined, implementing contact-rows sublayer 1504 as described with reference to FIG. 12A. It checks for an empty list, then scans the contact rows for all contacts marked as active cathodes (polarity +1) and all contacts marked as active anodes (polarity −1), skipping any contacts marked inactive (polarity 0). The function accumulates the x- and y-positions of each group and divides by the count to obtain the cathode centroid and the anode centroid. This reduction is necessary because different patients may have different numbers of active contacts, but the downstream layers of neural network 1500 require a fixed-size input; by compressing the active contacts into a single cathode centroid and a single anode centroid, the function produces the same four-number vector regardless of whether one contact or several contacts share the same polarity designation. The centroid representation captures the spatial center of the current-source and current-sink regions of the electric field, which are the primary determinants of where the field concentrates in the spinal cord tissue; a network trained on centroid summaries from one lead configuration can therefore generalize to a different lead configuration—for example, from an eight-contact percutaneous lead to a sixteen-contact paddle lead—without retraining, because both configurations produce the same fixed-length summary describing where current enters and exits the tissue. When only one cathode and one anode are present, the centroids reduce to the positions of those individual contacts. The function returns the four-number implant summary [cathode_x, cathode_y, anode_x, anode_y].

At lines 17033-17060, the functions init_settings_mlp, relu, matvec, vecadd, and settings_embedding are defined, implementing trial-settings sublayer 1506 as described with reference to FIG. 12B. The settings_embedding function applies the first linear map and bias, passes the result through ReLU, and applies a second linear map and bias, producing a fixed-length settings embedding vector.

At lines 17062-17084, the functions init_fusion_projection, reshape_to_seed, and make_seed are defined, implementing fusion-and-seed projection layer 1508 as described with reference to FIG. 12C. The make_seed function concatenates the implant summary and settings embedding, applies the fusion projection, and reshapes the result into the 14×14×C seed.

At lines 17086-17115, the functions bilinear_resize_2d and smooth 3×3_2d are defined, implementing the resize and smoothing operations of upsampling layer 1510 as described with reference to FIGS. 12E-12F.

At lines 17117-17138, the functions upsample_once_channels_last and upsample_seed_four_stages are defined, implementing the four-stage upsampling of layer 1510 as described with reference to FIG. 12D. The upsample_seed_four_stages function repeats the resize-then-smooth sequence four times to grow the seed from 14×14 to 224×224.

At lines 17140-17160, the functions init_pred_head, sigmoid, and predict_map_1x1_sigmoid are defined, implementing prediction layer 1512 as described with reference to FIG. 12G. The predict_map_1x1_sigmoid function forms a dot product of the C channel values with the learned weights at each pixel, adds the bias, and applies the sigmoid to produce the final output.

At lines 17162-17172, forward_predict_map performs the full forward pass for one trial, calling layers 1504, 1506, 1508, 1510, and 1512 in sequence to produce a 224×224 prediction.

At lines 17174-17184, init_all_params centralizes parameter initialization for the learnable layers (1506, 1508, and 1512), returning all weights and biases as a single dictionary.

At lines 17186-17194, the script provides a tiny example trial with four contact entries carrying position, is_tip flag, and polarity values, and a six-element settings vector that includes scaled amplitude, pulse width, frequency, and a one-hot waveform paradigm code (charge-balanced biphasic rectangular, burst, or high-frequency).

Making a Stimulation Setting Recommendation from Electrode Geometry and Target Map

Referring to FIG. 14G, at lines 17196-17204, all parameters are initialized with fixed seeds and the script runs the forward path to produce the predicted 224×224 image.

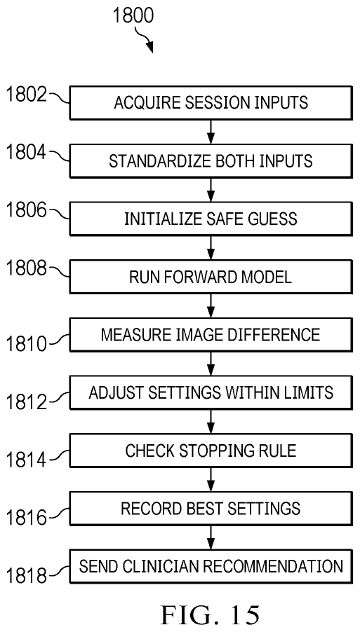

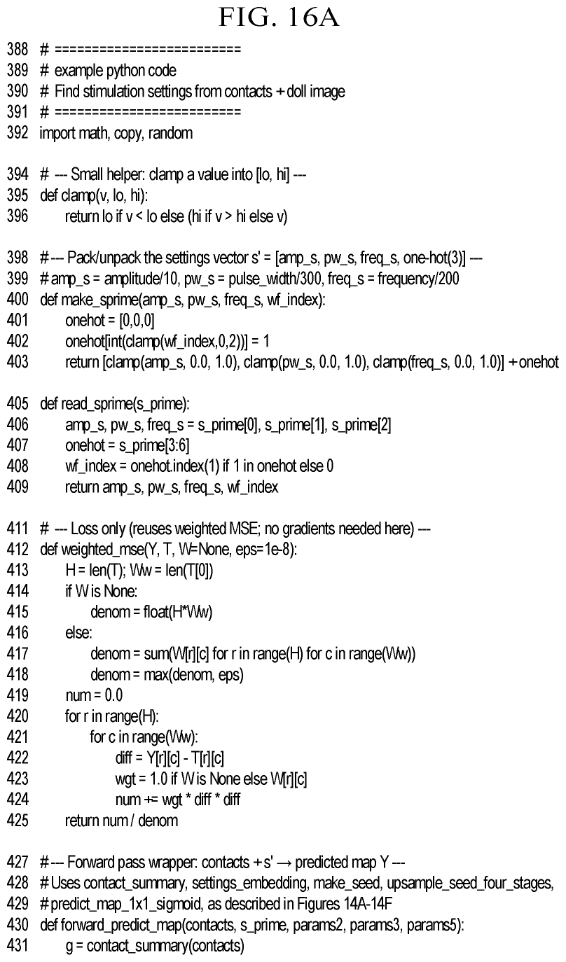

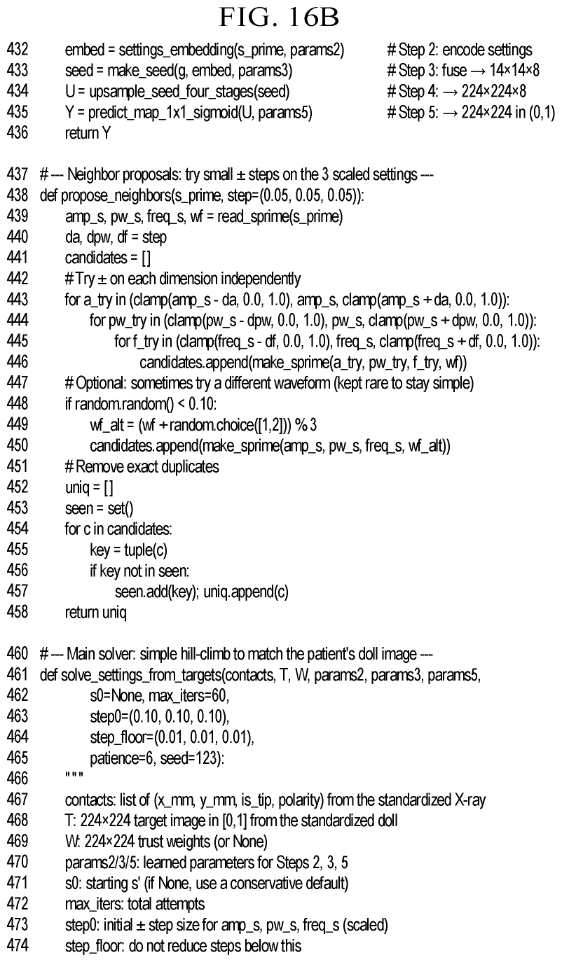

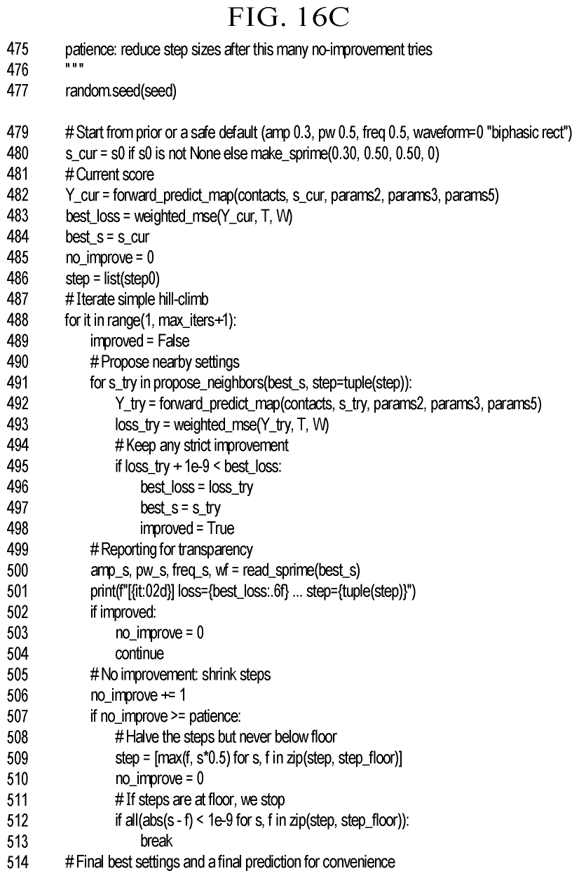

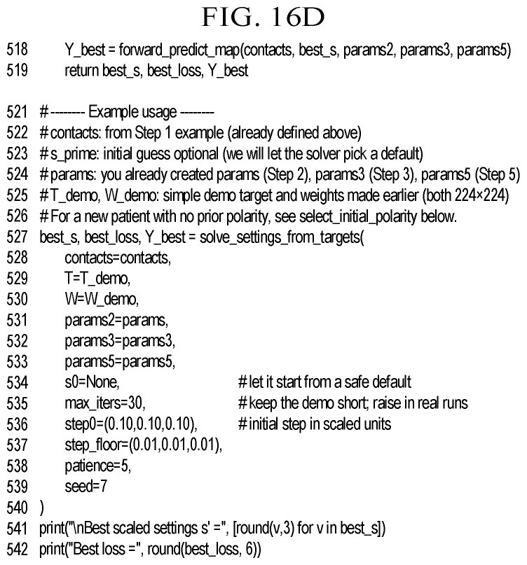

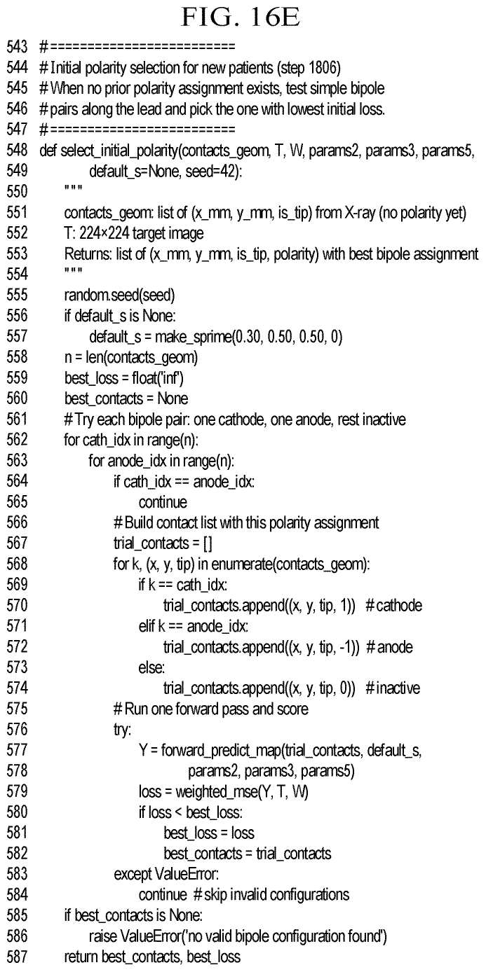

Referring to FIG. 15, a flowchart of method 1800 for making a stimulation setting recommendation will be further described. In overview, method 1800 makes a stimulation setting recommendation from a specified electrode geometry, target map, and current programming state of the stimulator. Unlike conventional programming systems that require physical delivery of stimulation to determine the resulting sensation pattern, method 1800 uses the trained neural network to predict what sensation pattern a given set of parameters would produce before any stimulation is delivered. In one embodiment, server 102 receives three inputs for a single session-electrode contact locations derived from the X-ray, the patient-marked doll image, and the current programming state of spinal cord stimulator 118—and standardizes the electrode locations and doll image to the same coordinate choices and fixed image size. If the programming state includes an active polarity configuration, server 102 uses that configuration as the starting point; if no active configuration exists, server 102 determines an initial polarity assignment as further described with reference to FIG. 16E. Server 102 then initializes a safe first guess of electrical settings and runs the trained forward model to produce a predicted doll image, measures how far that prediction is from the patient's image, and iteratively adjusts the settings within device limits to reduce the difference. The loop continues until a stop rule is met, after which server 102 records the best-matching polarity assignments and electrical settings and their score and provides a recommendation for clinician review and, if appropriate, wireless transmission to spinal cord stimulator 118 for programming. By retrieving predicted sensation patterns from the trained neural network, method 1800 accesses the compressed repository of paresthesia data encoded during training to identify effective stimulation settings for the new patient.

At step 1802, server 102 acquires three inputs for a single session. The first input is an X-ray image that shows the implanted electrode contacts. The second input is the patient-marked doll image that indicates where pain is felt. The third input is the current programming state of spinal cord stimulator 118, which server 102 retrieves via workstation 104 using the telemetry link described with reference to method 600. The programming state includes the contact polarity assignments (cathode, anode, or inactive for each contact) and the electrical settings (amplitude, pulse width, frequency, and waveform paradigm) currently programmed on the device. If spinal cord stimulator 118 has been newly implanted and has not yet been programmed, the telemetry query returns no active configuration, and server 102 proceeds without prior settings.

At step 1804, server 102 standardizes both inputs using method 800 as previously described so they share the same coordinate choices and fixed image size. The X-ray is turned into a simple list of contact positions in millimeters, preferably using method 600, with a left-right and head-foot orientation, and the doll image is aligned to the standard body map and resized to the fixed grid used by the model.

At step 1806, server 102 initializes a first guess for the stimulation settings within safe device limits. If step 1802 returned an active programming configuration from spinal cord stimulator 118, server 102 uses the retrieved contact polarity assignments and electrical settings as the starting point for the solver. If no active configuration was returned, for example, when the device has been newly implanted, server 102 calls the select_initial_polarity function of FIG. 16E to determine a starting polarity configuration by testing candidate bipole pairs against the target image, and uses conservative default electrical settings (for example, amplitude of 3.0 milliamps, pulse width of 150 microseconds, frequency of 100 hertz, and a charge-balanced biphasic rectangular waveform) as further described with reference to FIGS. 16A-16E.

At step 1808, the trained forward model from method 1600 runs once using the current guess and the standardized contact positions. The model produces a predicted doll image on the fixed grid that represents the sensation pattern expected from the current settings.

At step 1810, server 102 measures how different the predicted image is from the patient's doll image. The difference score is computed as mean squared error over corresponding pixels on the fixed grid, as further described with reference to FIGS. 16A-16E.

At step 1812, server 102 updates the stimulation settings to reduce the difference score while honoring device and safety limits. Server 102 generates candidate settings by trying small changes (for example, adding or subtracting 0.05 in scaled units) to amplitude, pulse width, and frequency, keeping only candidates that reduce the score, as further described with reference to FIGS. 16A-16E. In another embodiment, server 102 also adjusts contact polarity assignments as part of the candidate generation, varying which contacts are designated as cathode, anode, or inactive.

At step 1814, server 102 checks a stop rule to control the loop. The loop through steps 1808 to 1812 repeats until the difference score is small enough (for example, less than 0.001), or a maximum number of iterations is reached (for example, 60 iterations), or several consecutive iterations fail to produce a meaningful improvement (for example, 6 consecutive iterations with no improvement).

At step 1816, server 102 records the final stimulation settings and contact polarity assignments that produced the best match to the patient's doll image. The record includes the selected contact polarity designations (cathode, anode, or inactive for each contact), the selected electrical settings (amplitude, pulse width, frequency, and waveform paradigm), the final difference score, and the session identifiers so the result can be traced and audited.

At step 1818, server 102 prepares and sends a recommendation to the clinician via workstation 104. The report lists the selected contact polarity assignments and electrical settings and the match score, and may be transmitted wirelessly to spinal cord stimulator 118 for review and, if appropriate, programming.

Referring to FIGS. 16A-16E, a Python code example of method 1800 will be further described. In this example, server 102 receives standardized inputs for one session—contact positions derived from a fluoroscopic X-ray, a patient-marked doll image, and the current programming state of spinal cord stimulator 118 as described with reference to step 1802—and uses the previously defined five-layer forward model to predict a sensation image from candidate stimulation settings. If no active polarity configuration exists, the code calls the select_initial polarity function of FIG. 16E to determine a starting polarity assignment. The code initializes a safe default electrical settings vector when none is provided, evaluates the match between the model's prediction and the patient's doll image, and then iteratively adjusts the electrical settings within device limits to reduce the mismatch. An iterative loop proposes nearby settings, retains only those that improve the score, and stops when progress stalls or an iteration limit is reached. The example returns the best polarity assignments and electrical settings found together with the corresponding predicted image and match score, ready for clinician review or wireless transmission to spinal cord stimulator 118 for programming. By retrieving predicted sensation patterns from the trained neural network, method 1800 accesses the compressed repository of paresthesia data encoded during training to identify effective stimulation settings for the new patient.

At lines 388-392, the listing labels the code block and states that it finds stimulation settings from contacts and a doll image. At line 392 it imports standard modules used for math, object copying, and simple randomness.

At lines 394-396, the code defines a clamp helper that confines any numeric value to a chosen lower and upper bound so settings never drift outside safe ranges. For example, clamp (1.2, 0, 1) returns 1.0, and clamp (−0.1, 0, 1) returns 0.0.

At lines 398-409, the code defines functions for the settings vector s′, implementing the settings initialization of step 1806. The make_sprime function assembles three scaled scalars for amplitude (amplitude_mA/10), pulse width (pulse_width_us/300), and frequency (frequency_Hz/200) together with a three-entry one-hot code for the waveform paradigm (charge-balanced biphasic rectangular, burst, or high-frequency), and clamps each scalar to the 0-1 interval. For example, amplitude of 5.0 mA yields a scaled value of 0.50 and waveform index 0 produces the one-hot vector (1, 0, 0). The read_sprime function reverses this packing to recover the three scalars and the waveform index.

At lines 411-425, the code defines a mean-squared error function, implementing step 1810. The function compares a predicted doll image to the patient's doll image on a pixel-by-pixel basis using the formula:

$$score = ( \frac{1}{N} ) \cdot {\sum }_{i} {\sum }_{j} {( predicted ( i , j ) - target ( i , j ) )}^{2}$$

Where:
N is the total number of pixels (for example, N=224× 224=50,176).

The function sums the squared differences and divides by the pixel count to produce a single score between 0 (perfect match) and 1 (maximum mismatch).

At lines 427-436, the code defines a forward pass wrapper that calls the functions from FIGS. 14A-14F, implementing step 1808. The wrapper calls contact_summary (sublayer 1504) to produce the four-element implant summary, settings_embedding (sublayer 1506), make_seed (layer 1508), upsample_seed_four_stages (layer 1510), and predict_map_1x1_sigmoid (layer 1512) in sequence to produce a 224×224 prediction in the 0-1 range.

At lines 437-458, the code defines a proposer that generates nearby candidate settings around the current s′, implementing step 1812. For each of the three scaled parameters (amplitude, pulse width, frequency), the proposer considers three values: the current value minus a step size, the current value unchanged, and the current value plus a step size. The proposer generates all combinations of these values (up to 27 candidates), clamping each to the 0-1 range. The waveform is kept fixed most of the time, but with 10% probability one of the two alternative waveform paradigms is tried. The proposer removes duplicates so the search does not waste effort evaluating the same candidate twice. In another embodiment, the proposer changes only one parameter at a time, generating at most 7 candidates per iteration (one unchanged, plus two for each of the three parameters). In another embodiment, the proposer also varies contact polarity assignments, generating additional candidates in which the cathode, anode, or inactive designation of one or more contacts is changed.

At lines 460-476, the main solver is declared. It states the inputs (contacts as a list of tuples each carrying x position, y position, is_tip flag, and polarity; target image; model parameters), default limits (maximum 60 iterations), initial step sizes (0.10 for each parameter in scaled units), step size floors (0.01 below which the step size will not shrink), and a patience counter (6 iterations) used to shrink step sizes when progress stalls. It seeds the random generator so runs are repeatable.

At lines 477-485, the solver chooses a starting settings vector, implementing step 1806. If no prior settings are provided, it creates a conservative default: amplitude=0.30 in scaled units (3.0 mA), pulse width=0.50 in scaled units (150 μs), frequency=0.50 in scaled units (100 Hz), and waveform paradigm=charge-balanced biphasic rectangular, encoded as one-hot (1, 0, 0). It then runs one forward pass to get an initial prediction and computes the initial loss, which becomes the current best score.

At lines 487-499, the solver performs the iterative loop. For each iteration it calls the proposer to generate candidate settings, evaluates each candidate by running the forward model and computing the loss against the patient's image, and adopts any candidate that strictly improves (lowers) the best loss. It records the best settings found so far and marks whether the iteration produced an improvement.

At lines 499-504, the solver prints a short progress line showing the iteration number, the best loss so far, and the step sizes. When an improvement occurs it resets the no-improvement counter to zero.

At lines 507-515, the solver reacts to a lack of progress, implementing step 1814. When no improvement occurs, it increments a no-improvement counter. When the counter reaches the patience limit (6 iterations), the solver halves each step size while never letting any step size fall below its floor (0.01). If all three step sizes have reached their floors and no improvement has occurred for the patience count, the loop stops early because further progress is unlikely.

At lines 517-519, the solver runs a final forward pass using the best settings found and returns three values: the best settings vector, the best loss score, and the predicted image corresponding to those settings. These outputs implement steps 1816 and 1818 by providing the data needed for clinician review and stimulator programming.

At lines 521-542, a compact example is provided. The example assumes a returning patient whose spinal cord stimulator 118 already carries an active polarity configuration as retrieved at step 1802. The example uses the same four contacts from the FIGS. 14A-14F code example:
Contact 1: x=12.0 mm, y=5.0 mm, is_tip=0, polarity=−1
Contact 2: x=14.5 mm, y=9.0 mm, is_tip=1, polarity=+1
Contact 3: x=13.2 mm, y=7.5 mm, is_tip=0, polarity=0
Contact 4: x=11.8 mm, y=10.0 mm, is_tip=1, polarity=+1

The solver is called with the following parameters: contacts as listed above, a demonstration 224×224 target image T_demo, model parameters from the FIGS. 14A-14F initialization, no starting settings (s0=None), maximum 30 iterations, initial step sizes of 0.10 for each parameter, step size floors of 0.01, patience of 5 iterations, and random seed of 7. Because s0 is None, the solver uses its conservative default: s′= [0.30, 0.50, 0.50, 1, 0, 0], which represents amplitude of 3.0 mA (0.30×10), pulse width of 150 μs (0.50×300), frequency of 100 Hz (0.50×200), and charge-balanced biphasic rectangular waveform paradigm (one-hot index 0). The solver returns three values: best_s (the optimized settings vector), best_loss (the final mean squared error score), and Y_best (the 224×224 predicted sensation map corresponding to the best settings).

Referring to FIG. 16E, Python code implementing initial polarity selection for a new patient at step 1806 will be further described. When no prior polarity assignment exists for a patient—for example, when spinal cord stimulator 118 has just been implanted and no programming has yet been performed—server 102 must determine which electrode contacts to designate as cathodes, anodes, or inactive before the solver of FIGS. 16A-16D can optimize the electrical settings. The select_initial_polarity function receives the contact geometry extracted at step 1804 and identifies the bipole pair that best matches the patient's target sensation map.

At lines 548-554, the function is declared. It accepts contacts_geom, which is a list of three-element tuples (x_mm, y_mm, is_tip) produced by method 600 from the standardized X-ray—these tuples do not yet carry a polarity value. The number of contacts and their positions along the lead are determined entirely by the extraction performed at step 1804; the function operates on any electrode configuration, whether the lead carries 8 contacts, 16 contacts, or any other number. The function also accepts the 224×224 target image T, optional trust weights W, the learned model parameters (params2, params3, params5), an optional default electrical settings vector default_s, and a random seed. The function returns a list of four-element tuples (x_mm, y_mm, is_tip, polarity) representing the selected polarity configuration, together with the loss score achieved by that configuration.

At lines 555-560, the function initializes the random generator for reproducibility, sets the default electrical settings to the same conservative values used by the solver (amplitude 0.30, pulse width 0.50, frequency 0.50, charge-balanced biphasic rectangular waveform), reads the number of contacts n from the input list, and sets the best loss to infinity so that any valid configuration will improve upon it.

At lines 562-584, the function tests candidate bipole configurations by iterating over all ordered pairs of contacts. For each pair, one contact is designated as the cathode (polarity=+1) and the other as the anode (polarity=−1), while all remaining contacts are set to inactive (polarity=0). The function builds a trial contact list carrying these polarity assignments, calls forward_predict_map to run the five-layer neural network 1500 with the trial contacts and the default electrical settings, computes the mean squared error between the predicted sensation map and the patient's target image, and retains the configuration that achieves the lowest loss. A try-except block catches any configuration that fails validation in contact_summary—for example, a configuration that lacks a cathode or an anode—and skips it without interrupting the search. For an electrode lead with n contacts, the function evaluates at most n×(n−1) bipole pairs, each requiring a single forward pass.

At lines 585-587, the function checks that at least one valid configuration was found and raises an error if not. Otherwise it returns the best contact list, now carrying polarity assignments, together with the corresponding loss score. The returned contact list may then be passed directly to the solver of FIGS. 16A-16D, which holds the polarity assignments fixed while optimizing the electrical settings.

### Example 4: Solver Convergence

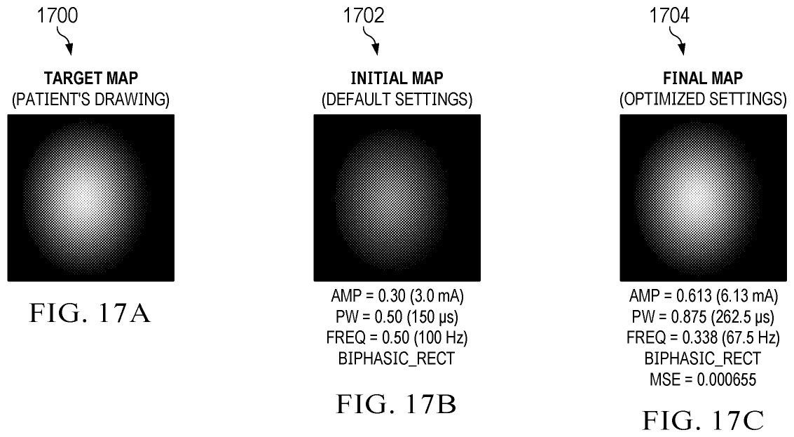

Referring to FIGS. 17A-17C, a prophetic example of method 1800 executed with a trained network will be further described. In this prophetic example, the neural network 1500 has been trained using method 1600 on historical patient data, and a new patient presents with no prior stimulator programming. Table 1 lists the electrode contact positions extracted from the patient's X-ray at step 1804. Because no prior polarity assignment exists, server 102 calls the select_initial_polarity function of FIG. 16E to determine which contacts to designate as cathode, anode, or inactive. The solver then iteratively adjusts the electrical settings to find a recommended configuration that produces a predicted sensation map matching the patient's target. Table 2 presents the complete recommendation, including the selected contact polarity assignments and the optimized stimulation settings. The complete solver implementation including iteration-by-iteration progress is shown in the example code at lines 521-542 of FIG. 16.

Table 1 lists prophetic electrode contact positions that would be derived from a patient's X-ray image using method 800. Each contact is identified by its x position (left-right in millimeters), y position (head-foot in millimeters), and a flag indicating whether the contact is a tip electrode. Because this prophetic example involves a new patient with no prior stimulator programming, no polarity assignments have yet been made.

TABLE 1
Input Contacts

| Contact | x (mm) | y (mm) | is_tip |
|---|---|---|---|
| 1 | 12.0 | 5.0 | 0 |
| 2 | 14.5 | 9.0 | 1 |
| 3 | 13.2 | 7.5 | 0 |
| 4 | 11.8 | 10.0 | 1 |

Server 102 calls the select_initial_polarity function of FIG. 16E, which tests all twelve single-bipole configurations for the four contacts listed in Table 1 using the conservative default electrical settings. The function designates one contact as cathode (polarity=+1), one as anode (polarity=−1), and the remaining contacts as inactive (polarity=0), runs one forward pass through neural network 1500 for each configuration, and scores each against the patient's target image. The winning configuration is contact 2 as cathode and contact 1 as anode, with contacts 3 and 4 inactive, achieving an initial loss of 0.001582. The contact_summary function of contact-rows sublayer 1504 then computes the four-element implant summary from the selected configuration: the cathode position is x=14.50 mm and y=9.00 mm (contact 2), and the anode position is x=12.00 mm and y=5.00 mm (contact 1), yielding g=[14.50, 9.00, 12.00, 5.00], which is concatenated with the settings vector s′ before being passed to the settings embedding trial-settings sublayer 1506.

With the polarity configuration selected, the solver begins optimizing the electrical settings. It uses conservative defaults of amplitude 0.30, pulse width 0.50, frequency 0.50, and charge-balanced biphasic rectangular waveform paradigm (1, 0, 0). Starting from these defaults with an initial loss of 0.001582, the solver uses an initial step size of 0.10 and iteratively adjusts each parameter, keeping any change that reduces the mean squared error between the predicted sensation map and the target. The loss decreases through intermediate values of 0.001119, 0.000832, 0.000686, and 0.000671 during the coarse search phase (step size 0.10), then to 0.000658 after the step size halves to 0.05, to 0.000656 at step size 0.025, and finally to 0.000655 at step size 0.013, at which point the solver converges at iteration 25.

TABLE 2
Recommended Stimulation Settings

| Parameter | Scaled Value | Physical Value | |
|---|---|---|---|
| Contact 1 | −1 | Anode | |
| Contact 2 | +1 | Cathode | |
| Contact 3 | 0 | Inactive | |
| Contact 4 | 0 | Inactive | |
| Amplitude | 0.613 | 6.13 | mA |
| Pulse Width | 0.875 | 262.5 | μs |
| Frequency | 0.338 | 67.5 | Hz |

| | | |
|---|---|---|
| Waveform | (1, 0, 0) | Biphasic Rect. |
| Final MSE | 0.000655 | — |

Table 2 presents the complete recommendation produced by the system for the new patient. The upper portion of the table shows the polarity assignments selected by the select_initial_polarity function of FIG. 16E: contact 2 is designated as the cathode, contact 1 as the anode, and contacts 3 and 4 as inactive. The lower portion shows the optimized electrical settings produced by the solver of FIGS. 16A-16D. Converting from scaled units, the recommended amplitude is 0.613×10=6.13 mA, the recommended pulse width is 0.875×300=262.5 μs, and the recommended frequency is 0.338×200=67.5 Hz, with the waveform remaining charge-balanced biphasic rectangular throughout the search. The final mean squared error of 0.000655 indicates a close match between the predicted sensation map and the patient's target.

Referring to FIG. 17A, a prophetic target sensation map 1700 is shown. Target map 1700 represents a prophetic patient's pain pattern as would be drawn on the doll image and standardized using method 800. As can be seen in FIG. 17A, the patient's drawing shows variable intensity radiating from the center outward in a roughly oval shape. The brightest region at the center represents the area where the patient feels the strongest pain, and the intensity gradually decreases toward the edges, fading to zero at the boundary. Method 1800 uses target map 1700 as the reference against which predicted sensation maps are compared.

Referring to FIG. 17B, an initial predicted sensation map 1702 is shown. Initial map 1702 represents the output of neural network 1500 when given the conservative default settings from step 1806: amplitude of 3.0 mA (scaled 0.30), pulse width of 150 μs (scaled 0.50), frequency of 100 Hz (scaled 0.50), and charge-balanced biphasic rectangular waveform paradigm, together with the polarity configuration selected by the select_initial_polarity function of FIG. 16E. As can be seen in FIG. 17B, initial map 1702 shows a sensation region that is noticeably smaller and dimmer than target map 1700 (FIG. 17A). The center of initial map 1702 is less bright because the default amplitude of 3.0 mA is lower than the amplitude that would produce the patient's desired intensity. The overall diameter of the sensation region is also reduced because the lower amplitude produces a more localized effect. Despite these differences, initial map 1702 provides a reasonable starting point centered in approximately the correct location. The mean squared error between initial map 1702 and target map 1700 is 0.001582, indicating a mismatch that the solver will attempt to reduce.

Referring to FIG. 17C, a final predicted sensation map 1704 is shown. Final map 1704 represents the output of neural network 1500 when given the optimized settings found by the solver: amplitude of 6.13 mA (scaled 0.613), pulse width of 262.5 μs (scaled 0.875), frequency of 67.5 Hz (scaled 0.338), and charge-balanced biphasic rectangular waveform paradigm, together with the polarity configuration selected by the select_initial_polarity function of FIG. 16E (contact 2 as cathode, contact 1 as anode, contacts 3 and 4 inactive). As can be seen in FIG. 17C, final map 1704 closely matches target map 1700 (FIG. 17A) in size, shape, and intensity. The bright central region of final map 1704 now matches the patient's desired intensity, and the gradual falloff toward the edges mirrors the target pattern. The oval shape and overall coverage area align with what the patient drew. The mean squared error between final map 1704 and target map 1700 is 0.000655, indicating a close match. The optimized settings and polarity assignments that produced final map 1704 are returned as the recommendation to the clinician at step 1818 for review and, if appropriate, programming into spinal cord stimulator 118.

In the prophetic example, the solver converged in 25 iterations, and the initial polarity selection of FIG. 16E required only 12 forward passes to evaluate all candidate bipole pairs. Unlike conventional trial-and-error programming, in which each candidate setting must be physically delivered to the patient and subjectively evaluated before the next adjustment can be made, method 1800 uses the trained neural network 1500 to predict the sensation outcome for each candidate setting without requiring stimulation delivery or patient feedback. This enables the solver to evaluate parameter combinations that span the full setting space—including combinations a clinician would not intuitively select—by leveraging patterns learned from the historical data of multiple prior patients during training of method 1600. The resulting recommendation, including both contact polarity assignments and electrical parameters, provides the clinician with a starting configuration informed by cross-patient data that would not otherwise be available during an individual programming session.

Method 1800 reduces programming-related battery consumption in the implanted pulse generator. A conventional programming session consumes battery power through two mechanisms: wireless telemetry to receive each new set of stimulation parameters, and delivery of stimulation pulses to the electrodes while the patient assesses the resulting sensation. Assuming wireless telemetry draws approximately 5 to 10 mA and each adjustment includes approximately 30 to 60 seconds of stimulation delivery, a conventional programming session with 12 trial-and-error adjustments over approximately 20 minutes would consume approximately 1 to 3 mAh. For rechargeable IPG batteries, the per-session savings from performing parameter optimization computationally through neural network 1500 reduce cumulative battery drain from programming events, extending the interval between recharging sessions and reducing the number of recharging events over the life of the device, thereby increasing patient comfort by reducing the frequency of recharging sessions in which an external inductive coil is held against the patient's skin. For non-rechargeable IPG batteries having a capacity of approximately 1 Ah, assuming 10 to 15 programming sessions during a five-year battery life, conventional programming would consume approximately 10 to 45 mAh, representing approximately 1 to 4.5 percent of total battery capacity. By performing parameter optimization computationally through neural network 1500, method 1800 reduces each programming session to a single verification transmission and brief stimulation confirmation, reducing per-session consumption to approximately 0.1 to 0.3 mAh. The cumulative reduction over the battery life extends IPG longevity and delays surgical replacement.

### Generating and Applying Neural Network-Based Stimulation Recommendations

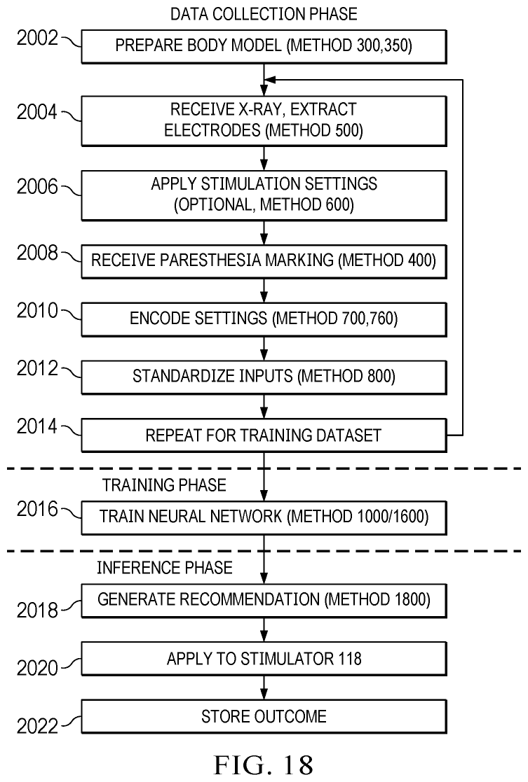

Referring to FIG. 18, a flowchart of method 2000 for generating and applying neural network-based stimulation recommendations will be further described. Method 2000 provides an overall workflow that combines the previously described methods into a complete pipeline. Method 2000 comprises three phases: a data collection phase (steps 2002 through 2014) in which stimulation trials are conducted on multiple patients and the patients mark where they feel paresthesia in response to each trial; a training phase (step 2016) in which a neural network learns to predict sensation patterns from electrode geometry and stimulation settings; and an inference phase (steps 2018 through 2022) in which a new patient marks where they feel pain and the trained network recommends stimulation settings predicted to produce paresthesia covering that pain area.

### Data Collection Phase

At step 2002, server 102 prepares a body model for patient marking as described with reference to method 300 (FIG. 3A). In another embodiment, server 102 prepares a digital avatar body model as described with reference to method 350 (FIG. 3B).

At step 2004, server 102 receives and processes an X-ray image showing implanted electrodes as described with reference to method 500 (FIG. 5).

At step 2006, workstation 104 applies stimulation settings to spinal cord stimulator 118 as described with reference to method 600 (FIG. 6).

Optionally, at step 2008, server 102 receives a doll image showing where the patient feels paresthesia in response to the stimulation applied at step 2006, as described with reference to method 400 (FIG. 4). In another embodiment in which the digital avatar is used, a separate image capture and processing step is not required because the standardized heatmap is produced directly by tablet computer 190.

At step 2010, server 102 encodes the stimulation settings into a standardized format as described with reference to method 700 (FIG. 7A). In another embodiment, server 102 receives the stimulation settings and the standardized heatmap from tablet computer 190 as described with reference to method 760 (FIG. 7C).

At step 2012, server 102 standardizes the inputs into training data format as described with reference to method 800 (FIG. 8).

At step 2014, server 102 repeats steps 2004 through 2012 for multiple patients and programming sessions to accumulate a training dataset. Server 102 stores all training examples in database 107 for retrieval during the training phase. This completes the data collection phase.

### Training Phase

At step 2016, server 102 trains a neural network on the accumulated training data. In one embodiment, server 102 trains a one-hidden-layer neural network 900 as described with reference to method 1000 (FIG. 10). In another embodiment, server 102 trains a five-layer neural network 1500 as described with reference to method 1600 (FIG. 13). The neural network learns to predict sensation patterns from electrode geometry and stimulation settings by minimizing the mean squared error between predicted and actual paresthesia heatmaps across the training examples. Because the training data includes trials from multiple patients as described with reference to step 2012, the trained network captures stimulus-response relationships that generalize across patients rather than being limited to any single patient's history. The trained neural network thus encodes paresthesia data from the plurality of training trials into the network weights, serving as a compressed repository from which effective stimulation patterns are retrievable during inference. Training continues until a stopping criterion is met (for example, validation loss has not improved for 20 consecutive epochs). Server 102 saves the trained network weights to database 107. This completes the training phase.

### Inference Phase

At step 2018, server 102 generates a stimulation setting recommendation for a new patient as described with reference to method 1800 (FIG. 15).

At step 2020, the clinician applies the recommended settings to the patient's spinal cord stimulator 118. Because the neural network evaluates candidate parameter combinations computationally during method 1800 rather than transmitting each candidate to stimulator 118 for physical delivery, the number of wireless telemetry events required during programming is substantially reduced and battery life of the stimulator is likewise extended.

At step 2022, server 102 stores the session outcome in database 107. This completes the inference phase.

Method 2000 thus provides a system in which data from programming sessions in the data collection phase is used to train a neural network in the training phase, and the trained network generates recommendations for new patients in the inference phase. Technical improvements provided by method 2000 include predictive rather than reactive programming, cross-patient learning in which effective programming patterns discovered in one patient improve recommendations for subsequent patients, reduced programming time from hours of trial-and-error to seconds of computation, and extended implanted battery life through reduced wireless transmissions. The trained neural network serves as a compressed repository of paresthesia data collected across the set of patients, such that effective stimulation patterns are encoded in the network weights and retrievable for new patients.

1. A collective paresthesia data storage system comprising:
a server operatively connected to a patient image capture device, an X-ray image capture device, and to a spinal cord stimulator;
the server having a first memory;
the spinal cord stimulator having a second memory;
the patient image capture device having a third memory;
the X-ray image capture device having a fourth memory;
a trained neural network stored in the first memory, wherein the trained neural network encodes paresthesia data collected from a plurality of stimulation trials across a plurality of patients, and wherein the trained neural network has been trained to learn a relationship between a set of electrode contact positions, a set of stimulation settings, and a set of paresthesia patterns from the plurality of stimulation trials; and
a set of instructions stored in the first memory, the second memory, the third memory, and the fourth memory that when executed, cause the system to:
receive, via the X-ray image capture device, an X-ray image showing implanted electrode contacts of the spinal cord stimulator;
receive, via the patient image capture device, a doll image showing a target pain area marked by a new patient;
derive the set of electrode contact positions from the X-ray image;
derive a set of proposed stimulation settings;
retrieve, using the trained neural network, a predicted paresthesia pattern corresponding to the set of proposed stimulation settings and the set of electrode contact positions;
compare the predicted paresthesia pattern to the target pain area;
iteratively adjust, using the trained neural network, the set of proposed stimulation settings until the predicted paresthesia pattern corresponds to the target pain area, thereby producing a recommended set of stimulation settings; and
output the recommended set of stimulation settings to the spinal cord stimulator;
wherein the trained neural network serves as a compressed repository of the paresthesia data collected from the plurality of stimulation trials, such that effective stimulation patterns discovered across the plurality of patients are retrievable for the new patient.

2. The collective paresthesia data storage system of claim 1, wherein:
the spinal cord stimulator comprises a battery having a charge lifetime; and
the charge lifetime is conserved by producing the recommended set of stimulation settings computationally rather than by wireless transmission of candidate stimulation parameters to the spinal cord stimulator and physical delivery of stimulation signals.

3. The collective paresthesia data storage system of claim 1, wherein the trained neural network further comprises:
an input layer receiving a trial vector encoding the set of electrode contact positions and the set of proposed stimulation settings;
a hidden layer having a plurality of hidden nodes, each hidden node connected to the input layer by a first set of weighted connections, each hidden node computing a weighted sum of inputs plus a first bias and applying a first sigmoid activation function to produce a hidden activation; and
an output layer having a plurality of output nodes corresponding to pixels of the predicted paresthesia pattern, each output node connected to the hidden layer by a second set of weighted connections, each output node computing a weighted sum of hidden activations plus a second bias and applying a second sigmoid activation function to produce a predicted pixel value;
wherein the set of paresthesia patterns from the plurality of stimulation trials is encoded in the first set of weighted connections and the second set of weighted connections.

4. The collective paresthesia data storage system of claim 1, wherein:
the patient image capture device comprises a camera; and
the doll image comprises a photograph of a physical doll on which the new patient has drawn markings indicating the target pain area.

5. The collective paresthesia data storage system of claim 4, wherein the set of instructions further cause the system to:
capture, via the camera, at least one photograph of the physical doll marked by the new patient to indicate the target pain area;
detect a set of fiducial markers on the physical doll;
compute a camera pose relative to the physical doll using the set of fiducial markers;
extract intensity markings corresponding to the target pain area from the at least one photograph; and
project the intensity markings onto a two-dimensional UV map at a fixed resolution to produce the doll image.

6. The collective paresthesia data storage system of claim 1, wherein:
the patient image capture device comprises a tablet computer operatively connected to the server, the tablet computer having a touchscreen display; and
the doll image comprises a digital representation of an avatar displayed on the touchscreen display of the tablet computer, on which the new patient has electronically indicated the target pain area.

7. The collective paresthesia data storage system of claim 6, wherein the set of instructions further cause the system to:
render the avatar as a three-dimensional body model on the touchscreen display;
receive, via the touchscreen display, a set of touch inputs drawn on the three-dimensional body model indicating the target pain area;
initialize a UV texture image mapped to UV coordinates of the three-dimensional body model;
convert each touch input of the set of touch inputs to a UV coordinate on the three-dimensional body model by performing a raycasting operation through a touch input on the touchscreen display to an intersection point on the three-dimensional body model;
record a pain intensity value at the UV coordinate on the UV texture image for each touch input of the set of touch inputs; and
transmit the UV texture image from the tablet computer to the server as a standardized heatmap to produce the doll image.

8. The collective paresthesia data storage system of claim 1, wherein the trained neural network further comprises:
an input layer receiving the set of electrode contact positions and the set of proposed stimulation settings;
one or more intermediate layers having a plurality of learnable parameters; and
an output layer producing the predicted paresthesia pattern;
wherein the set of paresthesia patterns from the plurality of stimulation trials is encoded in the plurality of learnable parameters.

9. The collective paresthesia data storage system of claim 1, wherein each of the plurality of stimulation trials includes a stimulation trial manifest, wherein the stimulation trial manifest includes:
a set of trial stimulation settings applied to the spinal cord stimulator;
a paresthesia heatmap derived from the doll image; and
the set of electrode contact positions.

10. A predictive stimulation programming system comprising:
a server operatively connected to a camera and to a spinal cord stimulator;
the server having a first memory containing a trained neural network;
the spinal cord stimulator having a second memory;
the camera having a third memory; and
a set of instructions stored in the first memory, the second memory, and the third memory, that when executed, cause the system to:
receive, via the camera, an X-ray image showing implanted electrode contacts of the spinal cord stimulator;
receive, via the camera, a doll image showing a target pain area marked by a patient;
derive electrode contact positions from the X-ray image;
standardize the electrode contact positions and the doll image to a common coordinate system and a fixed image size;
derive a set of proposed stimulation settings;
execute the trained neural network to produce a predicted sensation image from the set of proposed stimulation settings and the electrode contact positions;
compute a difference score between the predicted sensation image and the doll image;
iteratively adjust the set of proposed stimulation settings to reduce the difference score; and
output a recommended set of stimulation settings to the spinal cord stimulator;
wherein the recommended set of stimulation settings is predicted to produce a paresthesia pattern corresponding to the target pain area prior to delivery of stimulation.

11. The predictive stimulation programming system of claim 10, wherein the trained neural network comprises:
an input layer receiving a trial vector encoding the electrode contact positions and the set of proposed stimulation settings;
a hidden layer having a plurality of hidden nodes, each hidden node connected to the input layer by a first set of weighted connections, each hidden node computing a first weighted sum of inputs plus a first bias and applying a first sigmoid activation function to produce a hidden activation; and
an output layer having a plurality of output nodes corresponding to pixels of the predicted sensation image, each output node connected to the hidden layer by a second set of weighted connections, each output node computing a second weighted sum of hidden activations plus a second bias and applying a second sigmoid activation function to produce a predicted pixel value;
wherein the predicted sensation image is formed from the predicted pixel value of the plurality of output nodes.

12. The predictive stimulation programming system of claim 10, wherein the trained neural network comprises:
an input layer receiving the electrode contact positions and the set of proposed stimulation settings;
a contact-rows sublayer that summarizes the electrode contact positions into a first fixed-length vector;
a settings sublayer that converts the set of proposed stimulation settings into a second fixed-length vector using a first linear transformation, a ReLU activation function, and a second linear transformation;
a fusion layer that concatenates the first fixed-length vector and the second fixed-length vector and projects them through a third linear transformation into a coarse seed image;
an upsampling layer that enlarges the coarse seed image through bilinear interpolation and smoothing to produce an upsampled feature map; and
a prediction layer that applies a fourth linear transformation and a sigmoid activation function to the upsampled feature map to produce the predicted sensation image.

13. The predictive stimulation programming system of claim 10, wherein deriving electrode contact positions from the X-ray image comprises:
loading the X-ray image;
establishing a patient reference frame by locating left and right pedicles at a selected vertebral level and computing a midpoint between the left and right pedicles;
detecting the implanted electrode contacts in the X-ray image; and
computing contact positions in millimeters relative to the patient reference frame.

14. The predictive stimulation programming system of claim 10, wherein:
the spinal cord stimulator comprises a battery having a charge lifetime;
the trained neural network evaluates candidate stimulation parameters computationally to produce the recommended set of stimulation settings; and
the charge lifetime is conserved relative to a system requiring wireless transmission of the candidate stimulation parameters to the spinal cord stimulator for physical delivery.

15. The predictive stimulation programming system of claim 10, wherein standardizing the doll image comprises:
capturing, via the camera, at least one photograph of a physical doll marked by the patient to indicate the target pain area;
detecting a set of fiducial markers on the physical doll;
computing a camera pose relative to the physical doll using the set of fiducial markers;
extracting intensity markings corresponding to the target pain area from the at least one photograph; and
projecting the intensity markings onto a two-dimensional UV map at a fixed resolution.

16. The predictive stimulation programming system of claim 10, wherein computing the difference score comprises:
computing a mean squared error between corresponding pixels of the predicted sensation image and the doll image.

17. The predictive stimulation programming system of claim 10, wherein the trained neural network has been trained on stimulus-response data collected from a first set of patients, such that programming patterns learned from one patient, of the first set of patients, change the recommended set of stimulation settings for a second set of patients.

18. The predictive stimulation programming system of claim 10, wherein iteratively adjusting the set of proposed stimulation settings occurs computationally in less than one second.

19. The predictive stimulation programming system of claim 10, wherein the set of proposed stimulation settings is constrained within a set of device safety limits comprising at least one of amplitude limits, pulse width limits, frequency limits, and charge density limits.

20. A predictive stimulation programming system comprising:
a server operatively connected to a set of image intake devices and a set of spinal cord stimulators;
a set of X-ray machines;
the server having a first set of memories;
the set of image intake devices having a second set of memories;
the set of spinal cord stimulators having a third set of memories; and
a set of instructions stored in the first set of memories, the second set of memories, and the third set of memories, that when executed, cause the system to perform:
a data collection phase comprising:
displaying, on the set of X-ray machines, a set of X-ray images showing implanted electrode contacts of the set of spinal cord stimulators;
receiving, from the set of image intake devices, a set of photographs of the set of X-ray images;
deriving a set of electrode contact positions from the set of X-ray images;
applying, to the set of spinal cord stimulators, a set of stimulation settings during a set of programming sessions with a set of patients;
receiving, from the set of image intake devices, a set of doll images showing paresthesia markings made by the set of patients in response to the set of stimulation settings; and
standardizing the set of electrode contact positions, the set of stimulation settings, and the set of doll images into a set of training examples;
a training phase comprising:
training a neural network on the set of training examples to learn a relationship between the set of electrode contact positions, the set of stimulation settings, and a set of paresthesia patterns; and
an inference phase comprising:
receiving a target pain area marked by a new patient;
executing a trained neural network to generate a recommended set of stimulation settings predicted to produce paresthesia covering the target pain area; and
outputting the recommended set of stimulation settings to one of the set of spinal cord stimulators;
wherein the relationship between the set of electrode contact positions, the set of stimulation settings, and the set of paresthesia patterns learned from the set of patients changes the recommended set of stimulation settings.

21. The predictive stimulation programming system of claim 20, wherein receiving the set of X-ray images comprises:
displaying each X-ray image of the set of X-ray images on a display screen of one of the set of X-ray machines; and
capturing, via one of the set of image intake devices, a photograph of the display screen.

22. The predictive stimulation programming system of claim 20, wherein:
the set of X-ray machines comprises a set of C-arm fluoroscopy machines, each C-arm fluoroscopy machine having a fourth memory; and
receiving the set of X-ray images comprises retrieving each X-ray image of the set of X-ray images from the fourth memory of one of the set of C-arm fluoroscopy machines.

23. The predictive stimulation programming system of claim 20, wherein the system further comprises:
the neural network having an input layer, a single hidden layer, and an output layer;
the input layer receiving a trial vector encoding electrode contact positions and the set of stimulation settings;
the single hidden layer having a plurality of hidden nodes, each hidden node connected to the input layer by a first set of weighted connections and applying a first sigmoid activation function to produce a hidden activation;
the output layer having a plurality of output nodes corresponding to pixels of a predicted paresthesia image, each output node connected to the single hidden layer by a second set of weighted connections and applying a second sigmoid activation function to produce a predicted pixel value;
wherein the set of instructions further comprises:
computing a loss between the predicted paresthesia image and a corresponding doll image from the set of doll images;
adjusting the first set of weighted connections and the second set of weighted connections to reduce the loss; and
repeating the step of computing and the step of adjusting until the loss falls below a threshold value.

24. The predictive stimulation programming system of claim 20, wherein the system further comprises:
the neural network having an input layer, a contact-rows sublayer, a settings sublayer, a fusion layer, an upsampling layer, and a prediction layer;
the input layer receiving the set of electrode contact positions and the set of stimulation settings;
the contact-rows sublayer summarizing the set of electrode contact positions into a first fixed-length vector;
the settings sublayer converting the set of stimulation settings into a second fixed-length vector using a first linear transformation, a ReLU activation function, and a second linear transformation;
the fusion layer concatenating the first fixed-length vector and the second fixed-length vector and projecting them through a third linear transformation into a coarse seed image;
the upsampling layer enlarging the coarse seed image through bilinear interpolation and smoothing to produce an upsampled feature map; and
the prediction layer applying a fourth linear transformation and a sigmoid activation function to the upsampled feature map to produce a predicted paresthesia image;
wherein the set of instructions further comprises:
computing a loss between the predicted paresthesia image and a corresponding doll image from the set of doll images;
adjusting the first linear transformation, the second linear transformation, the third linear transformation, and the fourth linear transformation to reduce the loss; and
repeating the step of computing and the step of adjusting until the loss falls below a threshold value.

25. The predictive stimulation programming system of claim 24, wherein the contact-rows sublayer summarizing the set of electrode contact positions into the first fixed-length vector comprises:
identifying first set of contacts designated as cathodes and second set of contacts designated as anodes from the set of electrode contact positions;
computing a cathode centroid x position and a cathode centroid y position from the first set of contacts;
computing an anode centroid x position and an anode centroid y position from the second set of contacts; and
concatenating the cathode centroid x position, the cathode centroid y position, the anode centroid x position, and the anode centroid y position into the first fixed-length vector.

26. The predictive stimulation programming system of claim 24, wherein the settings sublayer converting the set of stimulation settings into the second fixed-length vector comprises:
receiving amplitude, pulse width, frequency, and waveform type from the set of stimulation settings;
applying the first linear transformation to produce an intermediate vector;
applying the ReLU activation function to the intermediate vector to set negative values to zero; and
applying the second linear transformation to produce the second fixed-length vector.

27. The predictive stimulation programming system of claim 24, wherein the fusion layer concatenating the first fixed-length vector and the second fixed-length vector and projecting them through the third linear transformation into the coarse seed image comprises:
concatenating the first fixed-length vector and the second fixed-length vector into a combined vector;
applying the third linear transformation to the combined vector to produce a set of pixel values; and
reshaping the set of pixel values into the coarse seed image.

28. The predictive stimulation programming system of claim 24, wherein the upsampling layer enlarges the coarse seed image by:
applying a bilinear interpolation to the coarse seed image to produce an enlarged image;
applying a smoothing filter to the enlarged image; and
outputting the upsampled feature map.

29. The predictive stimulation programming system of claim 24, wherein adjusting the first linear transformation, the second linear transformation, the third linear transformation, and the fourth linear transformation to reduce the loss comprises:
deriving a gradient of the loss with respect to each of the first linear transformation, the second linear transformation, the third linear transformation, and the fourth linear transformation using backpropagation; and
updating each of the first linear transformation, the second linear transformation, the third linear transformation, and the fourth linear transformation in a direction opposite to the gradient of the loss.

30. The predictive stimulation programming system of claim 20, wherein each spinal cord stimulator of the set of spinal cord stimulators comprises a battery having a charge lifetime, and wherein a first charge lifetime of a first spinal cord stimulator of the set of spinal cord stimulators is conserved by generating the recommended set of stimulation settings computationally rather than by wireless transmission of candidate stimulation parameters to the first spinal cord stimulator.

31. The predictive stimulation programming system of claim 20, wherein receiving, from the set of image intake devices, the set of doll images comprises:
receiving, from a camera, at least one photograph of a physical doll marked by one of the set of patients to indicate the target pain area;
detecting a set of fiducial markers on the physical doll;
computing a camera pose relative to the physical doll using the set of fiducial markers;
extracting intensity markings corresponding to the target pain area from the at least one photograph; and
projecting the intensity markings onto a two-dimensional UV map at a fixed resolution to produce one of the set of doll images.

32. The predictive stimulation programming system of claim 20, wherein receiving, from the set of image intake devices, the set of doll images comprises:
rendering an avatar as a three-dimensional body model on a touchscreen display of a tablet computer operatively connected to the server;
receiving, via the touchscreen display, a set of touch inputs drawn on the three-dimensional body model by one of the set of patients indicating the target pain area;
initializing a UV texture image mapped to UV coordinates of the three-dimensional body model;
converting each touch input of the set of touch inputs to a UV coordinate on the three-dimensional body model by performing a raycasting operation through a touch input of the set of touch inputs to an intersection point on the three-dimensional body model;
recording a pain intensity value at the UV coordinate on the UV texture image for each touch input of the set of touch inputs; and
transmitting the UV texture image from the tablet computer to the server as a standardized heatmap to produce one of the set of doll images.
